(19) United States
(12) Patent Application Publication
(10) Pub. No.: US 2002/0158212 A1
(43) Pub. Date: Oct. 31, 2002

(54) Apparatus and methods for time-resolved optical spectroscopy

(76) Inventors: Todd E. French, Mountain View, CA (US); John C. Owicki, Palo Alto, CA (US); Douglas N. Modlin, Palo Alto, CA (US)

Correspondence Address: KOLISCH HARTWELL DICKINSON MCCORMACK &, HEUSER, 520 S.W. YAMHILL STREET, SUITE 200, PORTLAND, OR, 97204, US

(21) Appl. No.: 10/012,255

(22) Filed: Nov. 12, 2001

Related U.S. Application Data
(63) Continuation-in-part of application No. 09/626,208, filed on Jul. 26, 2000.
(63) Continuation-in-part of application No. 09/766,131, filed on Jan. 19, 2001.
(63) Continuation-in-part of application No. 09/765,874, filed on Jan. 19, 2001.
(63) Continuation-in-part of application No. 09/767,316, filed on Jan. 22, 2001.
(63) Continuation-in-part of application No. 09/767,579, filed on Jan. 22, 2001, now Pat. No. 6,317,207.
(63) Continuation-in-part of application No. 09/770,720, filed on Jan. 25, 2001.
(63) Continuation-in-part of application No. 09/722,247, filed on Nov. 24, 2000.
Application No. PCT/US99/01656 is a continuation-in-part of application No. 09/062,472, filed on Apr. 17, 1998, now Pat. No. 6,071,748.
Application No. PCT/US99/01656 is a continuation-in-part of application No. 09/160,533, filed on Sep. 24, 1998, now Pat. No. 6,097,025.
(60) Provisional application No. 60/094,306, filed on Jul. 27, 1998.
(60) Provisional application No. 60/094,276, filed on Jul. 27, 1998.
(60) Provisional application No. 60/116,113, filed on Jan. 15, 1999.
(60) Provisional application No. 60/135,284, filed on May 21, 1999.
(60) Provisional application No. 60/167,463, filed on Nov. 24, 1999.
(60) Provisional application No. 60/121,229, filed on Feb. 23, 1999.

(30) Foreign Application Priority Data
Oct. 30, 1998 (US) PCT/US98/23095
Jan. 25, 1999 (US) PCT/US99/01656
Apr. 16, 1999 (US) PCT/US99/08410
Apr. 16, 1999 (US) PCT/US99/08410
Jan. 14, 2000 (US) PCT/US00/00895

(51) Int. Cl. G01N 21/64

(52) U.S. Cl. 250/459.1; 252/301.16

(57) ABSTRACT

Frequency-domain light detection systems and components and uses thereof for performing time-resolved luminescence assays. The systems may include methods for identifying and/or correcting for background and/or quenching, among others. The systems also may include apparatus for increasing duty cycle and/or sensitivity, among others.

### CROSS-REFERENCES TO PRIORITY APPLICATIONS

The patents and patent applications listed below are incorporated herein by reference in their entirety for all purposes.

This application is a continuation-in-part of the following U.S. patent applications: Ser. No. 09/626,208, filed Jul. 26, 2000; Ser. No. 09/766,131, filed Jan. 19, 2001; Ser. No. 09/765,874, filed Jan. 19, 2001; Ser. No. 09/767,316, filed Jan. 22, 2001; Ser. No. 09/767,579, filed Jan. 22, 2001; Ser. No. 09/770,720, filed Jan. 25, 2001; and Ser. No. 09/722,247, filed Nov. 24, 2000.

U.S. patent application No. 09/626,208 is a continuation of PCT Patent Application Ser. No. PCT/US99/01656, filed Jan. 25, 1999. The '01656 application is a continuation-in-part of the following patent applications: U.S. patent application Ser. No. 09/062,472, filed Apr. 17, 1998; U.S. patent application Ser. No. 09/160,533, filed Sep. 24, 1998; and PCT Application Serail No. PCT/US98/23095, filed Oct. 30, 1998. These applications, in turn, claim priority from additional applications, as identified therein. This '01656 application also claims priority directly from the following U.S. provisional patent applications: Serial No. 60/072,499, filed Jan. 26, 1998; Ser. No. 60/072,780, filed Jan. 27, 1998; Ser. No. 60/075,806, filed Feb. 24, 1998; and Ser. No. 60/084,167, filed May 4, 1998.

U.S. patent application Ser. No. 09/766,131 is a continuation of PCT Patent Application Serial No. PCT/US99/16286, filed Jul. 26, 1999, which claims priority from U.S. Provisional Patent Application Ser. No. 60/094,306, filed Jul. 27, 1998.

U.S. patent application Ser. No. 09/765,874 is a continuation of PCT Patent Application Ser. No. PCT/US99/16287, filed Jul. 26, 1999, which claims priority from U.S. Provisional patent application Serial No. 60/094,276, filed Jul. 27, 1998.

U.S. patent application Ser. No. 09/767,316 is a continuation of PCT Patent Application Serial No. PCT/US00/00895, filed Jan. 14, 2000, which claims priority from the following U.S. provisional patent applications: Serial No. 60/116,113, filed Jan. 15, 1999; Ser. No. 60/135,284, filed May 21, 1999; and Ser. No. 60/167,463, filed Nov. 24, 1999.

U.S. patent application Ser. No. 09/767,579 is a continuation of PCT Patent Application Serial No. PCT/US00/04543, filed Feb. 22, 2000, which claims priority from U.S. Provisional Patent Application Serial No. 60/121,229, filed Feb. 23, 1999.

U.S. patent application Ser. No. 09/770,720 is a continuation of PCT Patent Application Serial No. PCT/US00/06841, filed Mar. 15, 2000. The '06841 application is a continuation-in-part of the following patent applications: PCT Patent Application Serial No. PCT/US99/08410, filed Apr. 16, 1999; U.S. patent application Ser. No. 09/349,733, filed Jul. 8, 1999; PCT Patent Application Serial No. PCT/US00/00895, filed Jan. 14, 2000; and U.S. patent application Ser. No. 09/494,401, filed Jan. 28, 2000. These applications, in turn, claim priority from additional applications, as identified therein. The '06841 application also claims priority directly from the following U.S. provisional patent applications: Serial No. 60/124,686, filed Mar. 16, 1999; Serial No. 60/125,346, filed Mar. 19, 1999; Serial No. 60/135,284, filed May 21, 1999; Serial No. 60/184,719, filed Feb. 24, 2000; and Serial No. 60/184,924, filed Feb. 25, 2000.

U.S. patent application Ser. No. 09/722,247 is a continuation-in-part of U.S. patent application Ser. No. 09/626,208, filed Jul. 26, 2000, which claims priority from additional applications, as indicated above. U.S. patent application Ser. No. 09/722,247 also claims priority directly from the following U.S. provisional patent applications: Serial No. 60/167,463, filed Nov. 24, 1999; and Serial No. 60/182,419, filed Feb. 14, 2000.

### CROSS-REFERENCES TO ADDITIONAL MATERIALS

The following U.S. patents are incorporated herein by reference in their entirety for all purposes: U.S Pat. No. 5,355,215, issued Oct. 11, 1994; and U.S. Pat. No. 6,097,025, issued Aug. 1,2000.

The following U.S. patent applications are incorporated herein by reference in their entirety for all purposes: Ser. No. 09/337,623, filed Jun. 21, 1999; Ser. No. 09/478,819, filed Jan. 5, 2000; Ser. No. 09/596,444, filed Jun. 19, 2000; Ser. No. 09/710,061, filed Nov. 10, 2000; Ser. No. 09/759,711, filed Jan. 12, 2001; Ser. No. 09/765,869, filed Jan. 19, 2001; Ser. No. 09/767,434, filed Jan. 22, 2001; Ser. No. 09/767,583, filed Jan. 22, 2001; Ser. No. 09/768,661, filed Jan. 23, 2001; Ser. No. 09/768,765, filed Jan. 23, 2001; Ser. No. 09/770,724, filed Jan. 25, 2001; Ser. No. 09/777,343, filed Feb. 5, 2001; Ser. No. 09/813,107, filed Mar. 19, 2001; Ser. No. 09/815,932, filed Mar. 23, 2001; and Ser. No. 09/836,575, filed Apr. 16, 2001; and Ser. No. 09/934,348, filed Aug. 20, 2001; Ser. No. 09/957,116, filed Sep. 19, 2001; and Ser. No.______ , filed Oct. 29, 2001, titled LIGHT DETECTION DEVICE, and naming Joseph H. Jackson III, Dean G. Hafeman, and Todd E. French as inventors.

The following U.S. provisional patent applications are incorporated herein by reference in their entirety for all purposes: Serial No. 60/223,642, filed Aug. 8, 2000; Serial No. 60/244,012, filed Oct. 27, 2000; Serial No. 60/267,639, filed Feb. 10, 2001; Serial No. 60/287,697, filed Apr. 30, 2001; Ser. No. 60/309,800, filed Aug. 2, 2001; and Serial No. 60/316,704, filed Aug. 31, 2001.

This following publications are incorporated herein by reference in their entirety for all purposes: Joseph R. Lakowicz, Principles of Fluorescence Spectroscopy (1983); Richard P. Haugland, Handbook of Fluorescent Probes and Research Chemicals (6^{th} ed. 1996); and Joseph R. Lakowicz, Principles of Fluorescence Spectroscopy (2^{nd} ed. 1999).

### FIELD OF THE INVENTION

The invention relates to luminescence assays. More particularly, the invention relates to frequency-domain light detection systems for performing time-resolved luminescence assays.

### BACKGROUND OF THE INVENTION

Luminescence is the emission of light from excited electronic states of luminescent atoms or molecules (i.e., “luminophores”). Luminescence generally refers to all emission of light, except incandescence, and may include photohliminescence, chemiluminescence, and electrochemiluminescence, among others. In photoluminescence, which includes fluorescence and phosphorescence, the excited electronic state is created by the absorption of electromagnetic radiation. In particular, the excited electronic state is created by the absorption of radiation having an energy sufficient to excite an electron from a low-energy ground state into a higher-energy excited state. The energy associated with the excited state subsequently may be lost through one or more of several mechanisms, including production of a photon through fluorescence, phosphorescence, or other mechanisms. Here, except where noted, the terms luminescence and photoluminescence are used interchangeably, such that a reference to luminescence or luminophore should be understood to imply a reference to photoluminescence and photoluminophore, respectively.

Luminescence assays are assays that use luminescence emissions from luminescent analytes to study the properties and environment of an analyte, as well as binding reactions and enzymatic activities involving the analyte, among others. In this sense, the analyte may act as a reporter to provide information about another material or target substance that may be the true focus of the assay. Luminescence assays may use various aspects of the luminescence, including its intensity, polarization, energy transfer, lifetime, excitation spectrum, emission spectrum, and/or quantum yield, among others. Luminescence assays also may use time-independent (steady-state) and/or time-dependent (time-resolved) properties of the luminescence. Time-resolved assays generally are more complicated and more informative than steady-state assays. Exemplary luminescence assays include fluorescence intensity (FLINT), fluorescence polarization (FP). fluorescence resonance energy transfer (FRET), fluorescence lifetime (FLT), total internal reflection fluorescence (TIRF), fluorescence correlation spectroscopy (FCS), and fluorescence recovery after photobleaching (FRAP), among others, and their analogs based on phosphorescence and alternative transitions.

Time-resolved luminescence assays may be used to study the temporal properties of a sample. These temporal properties generally include any properties describing the time evolution of the sample or components of the sample. These properties include the time-dependent luminescence emission and time-dependent luminescence polarization (or, equivalently, anisotropy), among others. These properties also include coefficients for for describing such properties, such as the luminescence lifetime and the rotational (or more generally the reorientational) correlation time. The luminescence lifetime is the average time that a luminophore spends in the excited state prior to returning to the ground state.

Time-resolved luminescence may be measured using “time-domain” and/or “frequency-domain” techniques, which involve monitoring the time course of luminescence emission in time space and frequency space, respectively.

In a time-domain measurement, the time course of luminescence is monitored directly, in time space. Typically, a sample containing a luminescent analyte is illuminated using a narrow pulse of light, and the time dependence of the intensity of the resulting luminescence emission is observed. For a simple luminophore, the luminescence commonly follows a single-exponential decay, so that the luminescence lifetime can (in principle) be determined from the time required for the intensity to fall to 1/e of its initial value.

In a frequency-domain measurement, the time course of luminescence is monitored indirectly, in frequency space. Typically, the sample is illuminated using intensity-modulated incident light, where the modulation may be characterized by a characteristic time, such as a period. Frequency-domain analysis may use almost any modulation profile. However, because virtually any modulation profile can be expressed as a sum of sinusoidal components using Fourier analysis, frequency-domain analysis may be understood by studying the relationship between excitation and emission for sinusoidal modulation.

FIG. 1 shows the relationship between excitation and emission in a frequency-domain experiment, where the excitation light is modulated sinusoidally at a single modulation frequency f. The resulting luminescence emission is modulated at the same frequency as the excitation light. However, the intensity of the emission will lag the intensity of the excitation by a phase angle (phase) φ and will be demodulated by a demodulation factor (modulation) M. Specifically, the phase φ is the phase difference between the excitation and emission, and the modulation M is the ratio of the AC amplitude to the DC offset for the emission, relative to the ratio of the AC amplitude to the DC offset for the excitation. The phase and modulation are related to the luminescence lifetime τ by the following equations:

ωτ=tan(φ) (1)

$$ωτ = \sqrt{\frac{1}{{M}^{2}} - 1} \qquad ( 2 )$$

Here, ω is the angular modulation frequency, which equals 2π times the modulation frequency. Significantly, unlike in time-domain measurements, the measured quantities (phase and modulation) are directly related to the luminescence lifetime. For maximum sensitivity, the angular modulation frequency should be roughly the inverse of the luminescence lifetime. Typical luminescence lifetimes vary from less than about 1 nanosecond to greater than about 10 milliseconds. Therefore, instruments for measuring luminescence lifetimes should be able to cover modulation frequencies from less than about 20 Hz to greater than about 200 MHz.

A similar approach may be used to study other temporal properties of a luminescent sample, such as time-resolved luminescence polarization, which may be characterized by a rotational (or more generally a reorientational) correlation time. The use of standard frequency-domain techniques to study such properties is described in detail in Joseph R. Lakowicz, Principles of Fluorescence Spectroscopy (2^{nd} ed. 1999). This publication is hereby incorporated by reference herein in its entirety for all purposes

Unfortunately, despite their utility, luminescence assays suffer from a number of shortcomings. These shortcomings include artifacts that alter the apparent luminescence and luminescence properties of the analyte and thus the accuracy, repeatability, and reliability of the assay. These artifacts may increase the apparent luminescence of the analyte, causing intensity-based assays to overreport the amount of light emitted by the analyte. Such artifacts include background. These artifacts also may decrease the apparent luminescence of the analyte, causing intensity-based assays to underreport the amount of light emitted by the analyte. Such artifacts include quenching. These artifacts, also may decrease detection duty cycle and/or sensitivity, particularly in frequency-domain assays, causing a decrease in detected luminescence and an increase in reagent requirements and analysis times, respectively. Thus, there is a need for improved light detection systems that may address these and/or other shortcomings.

### SUMMARY OF THE INVENTION

The invention provides frequency-domain light detection systems and components and uses thereof for performing time-resolved luminescence assays. The systems may include methods for identifying and/or correcting for background and/or quenching, among others. The systems also may include apparatus for increasing duty cycle and/or sensitivity, among others.

### BRIEF DESCRIPTION OF THE DRAWINGS

FIG. 1 is a schematic view of a frequency-domain time-resolved measurement, showing the definitions of phase angle (phase:,) φ and demodulation factor (modulation) M.

FIG. 2 is a schematic view of an apparatus for detecting polarized light.

FIG. 3 is a schematic view of luminescently labeled molecules, showing how molecular reorientation affects luminescence polarization.

FIG. 4 is a partially exploded perspective view of an apparatus for detecting light in accordance with aspects of the invention.

FIG. 5 is a schematic view of portions of the apparatus of FIG. 4, showing the photoluminescence and chemiluminescence optical systems.

FIG. 6 is a partially perspective schematic perspective view of the photohliminescence and chemiluminescence optical systems of FIG. 5.

FIG. 7 is an alternative schematic view of the photoluminescence optical system of FIG. 5.

FIG. 8 is a schematic view of portions of the apparatus of FIG. 4, showing the frequency-domain detection system.

FIG. 9 is a graph of experimental results showing that short-lifetime background with low polarization does not significantly affect performance of FLAMe methods

FIG. 10 is a phasor diagram showing phase and modulation phasors for a system having an analyte and background.

FIG. 11 is a graph of simulation results showing how the invention discriminates between an analyte and background for three zeroth-order embodiments of the invention, as described in Equations 13 (LDI, Mₓ-based), 15 (LDI, φ-based), and 16 (LRI).

FIG. 12 is a graph of experimental results showing how the invention discriminates between a long-lifetime ruthenium-complex analyte and a short-lifetime R-phycoerythrin background, for a constant concentration of analyte and an increasing concentration of background. Results are shown for embodiments described under FIG. 11.

FIG. 13 is a graph of experimental results showing how the invention discriminates between a long-lifetime ruthenium-complex analyte and a short-lifetime R-phycoerythrin background, for a constant concentration of background and an increasing concentration of analyte. Results are shown for embodiments described under FIG. 11.

FIG. 14 is a graph of simulation results showing how binding affects differential phase (Panel A) and modulated anisotropy (Panel B) in the presence of 0% background in a frequency-domain binding experiment, for 0-100% binding as shown.

FIG. 15 is a graph of simulation results showing how binding affects differential phase (Panel A) and modulated anisotropy (Panel B) in the presence of 50% background in the frequency-domain binding experiments shown in FIG. 14.

FIG. 16 is a graph of simulation results showing how binding affects Ψ_{ω} in the presence of 0% (solid lines) and 50% (dashed lines) background in the frequency-domain experiments of FIG. 14, for 0-100% binding as shown. Ψ₁₀₇ is defined and evaluated in accordance with the invention.

FIG. 17 is a graph of simulation results showing how binding affects K_{ω} in the presence of 0% (solid lines) and 90% (dashed lines) background in the frequency-domain binding experiments of FIG. 14. K_{ω} is defined and evaluated in accordance with the invention.

FIG. 18 is a graph of computed lifetime versus signal-to-background fluorescence intensities for simulated parameters, showing how the FLDL method improves the accuracy of lifetime measurement with strong backgrounds.

FIG. 19 is a graph of donor and acceptor intensity versus time in a time-resolved resonance energy transfer assay, showing how time and energy transfer affect intensity.

FIG. 20 is a graph of donor and acceptor intensity versus time in a time-resolved resonance energy transfer assay, showing how time, energy transfer, and static quenching affect intensity.

FIG. 21 is a graph of donor and acceptor intensity versus time in a time-resolved resonance energy transfer assay, showing how time, energy transfer, and dynamic quenching affect intensity.

FIG. 22 is a schematic view of an apparatus for detecting light in accordance with aspects of the invention.

FIG. 23 is a schematic view of a four phase-bin counter system for use in the apparatus of FIG. 22.

FIG. 24 is a circuit schematic of a count distributor for use in the apparatus of FIG. 22.

FIG. 25 is a circuit schematic of a preamplifier from a photon discriminator for use in the apparatus of FIG. 22.

FIG. 26 is a circuit schematic of a constant-level discriminator from a photon discriminator for use in the apparatus of FIG. 22.

FIG. 27 is a circuit schematic of a constant-fraction discriminator from a photon discriminator for use in the apparatus of FIG. 22.

FIG. 28 is a graph of the relative phases of signals associated with a photon discriminator for use in the apparatus of FIG. 22.

FIG. 29 is a schematic view of time-domain and frequency-domain measurements, showing how detector dead time affects lost photon pulses in the two techniques.

FIG. 30 shows a portion of an apparatus for producing time-modulated excitation light in accordance with aspects of the invention.

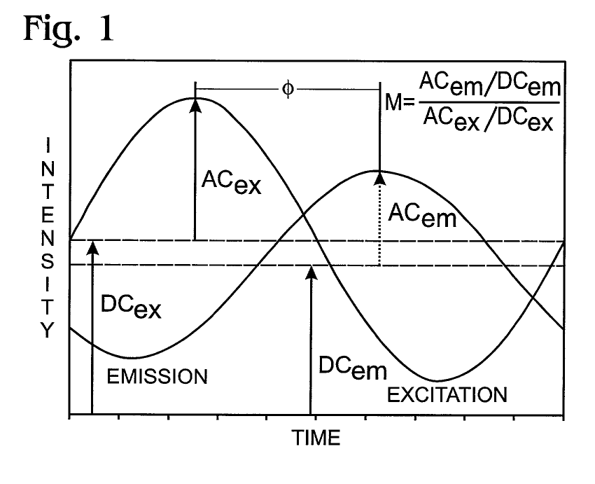

### DETAILED DESCRIPTION

The invention provides frequency-domain light detection systems and components and uses thereof for performing time-resolved luminescence assays. The systems may include methods for identifying and/or correcting for background and/or quenching, among others. The systems also may include apparatus for increasing duty cycle and/or sensitivity, among others.

These and other aspects of the invention are described in the following sections, including (I) overview of luminescence assays, (II) overview of luminescence apparatus, (III) improvements in signal resolution, (IV) identification and/or correction of quenching, (V) photon-counting methods, (VI) frequency-modulation methods, and (VII) conclusions, among others.

### I. Overview of Exemplary Luminescence Assays

This section describes exemplary luminescence assays, including (A) intensity assays, (B) polarization assays, and (C) energy transfer assays, among others. This disclosure is supplemented by the patents, patent applications, and publications identified above under Cross-References, particularly Richard P. Haugland, Handbook of Fluorescent Probes and Research Chemicals (6^{th} ed. 1996), and Joseph R. Lakowicz, Principles of Fluorescence Spectroscopy (2^{nd} ed. 1999). These supplemental materials are incorporated herein by reference in their entirety for all purposes.

A. Intensity Assays

Luminescence intensity assays involve monitoring the intensity (or amount) of light emitted from a composition. The intensity of emitted light will depend on the extinction coefficient, quantum yield, and number of the luminescent analytes in the composition, among others. These quantities, in turn, will depend on the environment of the analyte, among others, including the proximity and efficacy of quenchers and energy transfer partners. Thus, luminescence intensity assays may be used to study binding reactions, among other applications.

B. Polarization Assays

Luminescence polarization assays involve the absorption and emission of polarized light, and typically are used to study molecular rotation. (Polarization describes the direction of light's electric field, which generally is perpendicular to the direction of light's propagation.)

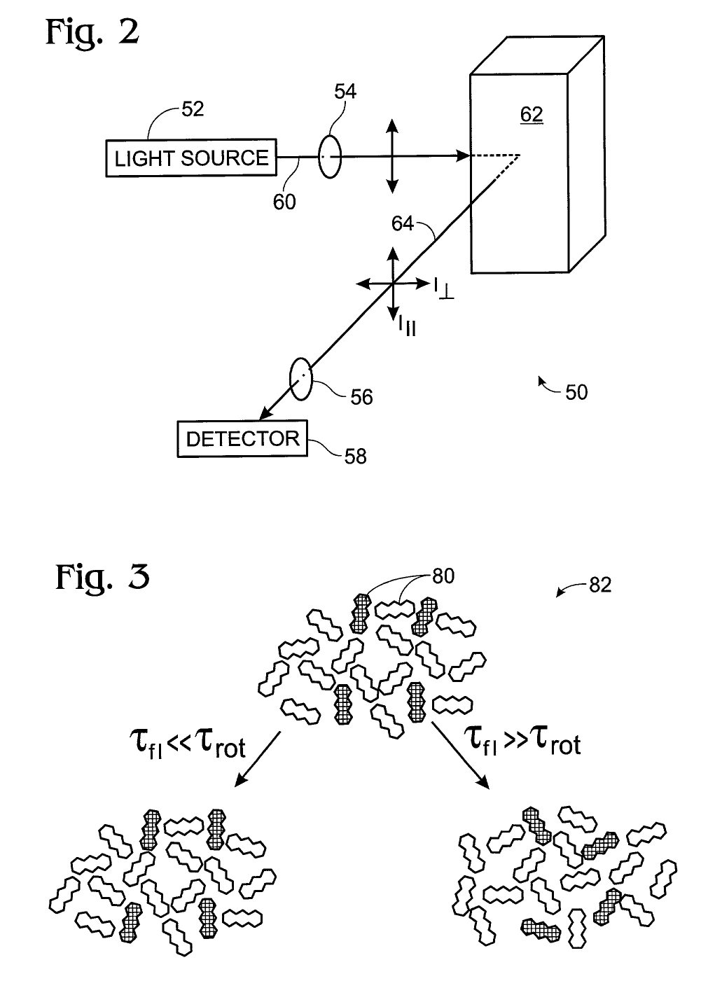

FIG. 2 shows a simple apparatus 50 for performing a polarization assay. Apparatus 50 includes a light source 52, an excitation polarizer 54, an emission polarizer 56, and a detector 58. Light 60 produced by light source 52 is directed through excitation polarizer 54, which passes polarized excitation light (indicated by vertical arrow). Polarized excitation light is directed onto a sample 62, which emits light 64 in response. Emitted light 64 may have components oriented parallel (∥; indicated by vertical arrow) and/or perpendicular (⊥; indicated by horizontal arrow) to the polarization of excitation light 60. The emitted light is directed through emission polarizer 56, which, depending on its orientation, passes parallel (I_{∥}) or perpendicular (I_{⊥}) components of emission light 64 for detection by detector 58. Apparatus 50 also may be used for intensity assays, if the polarizers are held fixed, typically in the same orientation, or removed.

FIG. 3 is a schematic view showing how luminescence polarization is affected by molecular rotation. In a luminescence polarization assay, specific molecules 80 within a composition 82 are labeled with one or more luminophores. The composition then is illuminated with polarized excitation light, which preferentially excites luminophores having absorption dipoles aligned parallel to the polarization of the excitation light. These molecules subsequently decay by preferentially emitting light polarized parallel to their emission dipoles. The extent to which the total emitted light is polarized depends on the extent of molecular reorientation during the time interval between luminescence excitation and emission, which is termed the luminescence lifetime, τ. The extent of molecular reorientation in turn depends on the luminescence lifetime and the size, shape, and environment of the reorienting molecule. Thus, luminescence polarization assays may be used to quantify binding reactions and enzymatic activity, among other applications. In particular, molecules commonly rotate via diffusion with a rotational correlation time τᵣₒₜ that its proportional to their size. Thus, during their luminescence lifetime, relatively large molecules will not reorient significantly, so that their total no luminescence will be relatively polarized. In contrast, during the same time interval, relatively small molecules will reorient significantly, so that their total luminescence will be relatively unpolarized.

The relationship between polarization and intensity is expressed by the following equation.

$$P = \frac{{I}_{\vert \vert} - {I}_{⊥}}{{I}_{\vert \vert} + {I}_{⊥}} \qquad ( 3 )$$

Here, P is the polarization, I_{∥} is the intensity of luminescence polarized parallel to the polarization of the excitation light, and I_{⊥} is the intensity of luminescence polarized perpendicular to the polarization of the excitation light. P generally varies from zero to one-half for randomly oriented molecules (and zero to one for aligned molecules). If there is little rotation between excitation and emission, I_{∥} will be relatively large, I_{⊥} will be relatively small, and P will be close to one-half. (P may be less than one-half even if there is no rotation; for example, P will be less than one if the absorption and emission dipoles are not parallel.) In contrast, if there is significant rotation between absorption and emission, I_{∥} will be comparable to T_{⊥}, and P will be close to zero. Polarization often is reported in milli-P (mP) units (1000×P), which for randomly oriented molecules will range between 0 and 500, because P will range between zero and one-half.

Polarization also may be described using other equivalent quantities, such as anisotropy. The relationship between anisotropy and intensity is expressed by the following equation:

$$r = \frac{{I}_{\vert \vert} - {I}_{⊥}}{{I}_{\vert \vert} + 2 {I}_{⊥}} \qquad ( 4 )$$

Here, r is the anisotropy. Polarization and anisotropy include the same information, although anisotropy may be more simply expressed for systems containing more than one luminophore. In the description and claims that follow, these terms may be used interchangeably, and a generic reference to one should be understood to imply a generic reference to the other.

The relationship between polarization, luminescence lifetime, and rotational correlation is expressed by the Perrin equation:

$$( \frac{1}{P} - \frac{1}{3} ) = ( \frac{1}{{P}_{0}} - \frac{1}{3} ) \cdot ( 1 + \frac{τ}{{τ}_{r o t}} ) \qquad ( 5 )$$

Here, P₀ is the polarization in the absence of molecular motion (intrinsic polarization), τ is the luminescence lifetime (inverse decay rate) as described above, and τᵣₒₜ is the rotational correlation time (inverse rotational rate) as described above.

The Perrin equation shows that luminescence polarization assays are most sensitive when the luminescence lifetime and the rotational correlation time are similar. Rotational correlation time is proportional to molecular weight, increasing by about 1 nanosecond for each 2,400 Dalton increase in molecular weight (for a spherical molecule). For shorter lifetime luminophores, such as fluorescein, which has a luminescence lifetime of roughly 4 nanoseconds, luminescence polarization assays are most sensitive for molecular weights less than about 40,000 Daltons. For longer lifetime probes, such as Ru(bpy)₂dcbpy (ruthenium 2,2′-dibipyridyl 4,4′-dicarboxyl-2,2′-bipyridine), which has a lifetime of roughly 400 nanoseconds, luminescence polarization assays are most sensitive for molecular weights between about 70,000 Daltons and 4,000,000 Daltons.

3. Energy Transfer Assays

Energy transfer is the transfer of luminescence energy from a donor luminophore to an acceptor without emission by the donor. in energy transfer assays, a donor luminophore is excited from a ground state into an excited state by absorption of a photon. If the donor luminophore is sufficiently close to an acceptor, excited-state energy may be transferred from the donor to the acceptor, causing donor luminescence to decrease and acceptor luminescence to increase (if the acceptor is luminescent). The efficiency of this transfer is very sensitive to the separation R between donor and acceptor, decaying as 1/R⁻⁶. Energy transfer assays use energy transfer to monitor the proximity of donor and acceptor, which in turn may be used to monitor the presence or activity of an analyte, among others.

Energy transfer assays may focus on an increase in energy transfer as donor and acceptor are brought into proximity. These assays may be used to monitor binding, as between two molecules X and Y to form a complex X:Y. Here, colon (:) represents a noncovalent interaction. In these assays, one molecule is labeled with a donor D, and the other molecule is labeled with an acceptor A, such that the interaction between X and Y is not altered appreciably. Independently, D and A may be covalently attached to X and Y. or covalently attached to binding partners of X and Y.

Energy transfer assays also may focus on a decrease in energy transfer as donor and acceptor are separated. These assays may be used to monitor cleavage, as by hydrolytic digestion of doubly labeled substrates (peptides, nucleic acids). In one application, two portions of a polypeptide are labeled with D and A, so that cleavage of the polypeptide by a protease such as an endopeptidase will separate D and A and thereby reduce energy transfer. In another application, two portions of a nucleic acid are labeled with D and A, so that cleave by a nuclease such as a restriction enzyme will separate D and A and thereby reduce energy transfer.

Energy transfer between D and A may be monitored in various ways. For example, energy transfer may be monitored by observing an energy-transfer induced decrease in the emission intensity of D and increase in the emission intensity of A (if A is a luminophore). Energy transfer also may be monitored by observing an energy-transfer induced decrease in the lifetime of D and increase in the apparent lifetime of A.

In a preferred mode, a long-lifetime luminophore is used as a donor, and a short-lifetime luminophore is used as an acceptor. Suitable long-lifetime luminophores include metal-ligand complexes containing ruthenium, osmium, etc., and lanthanide chelates containing europium, terbium, etc. In time-gated assays, the donor is excited using a flash of light having a wavelength near the excitation maximum of D. Next, there is a brief wait, so that electronic transients and/or short-lifetime background luminescence can decay. Finally, donor and/or acceptor luminescence intensity is detected and integrated. In frequency-domain assays, the donor is excited using time-modulated light, and the phase and/or modulation of the donor and/or acceptor emission is monitored relative to the phase and/or modulation of the excitation light. In both assays, donor luminescence is reduced if there is energy transfer, and acceptor luminescence is observed only if there is energy transfer.

### II. Overview of Exemplary Apparatus

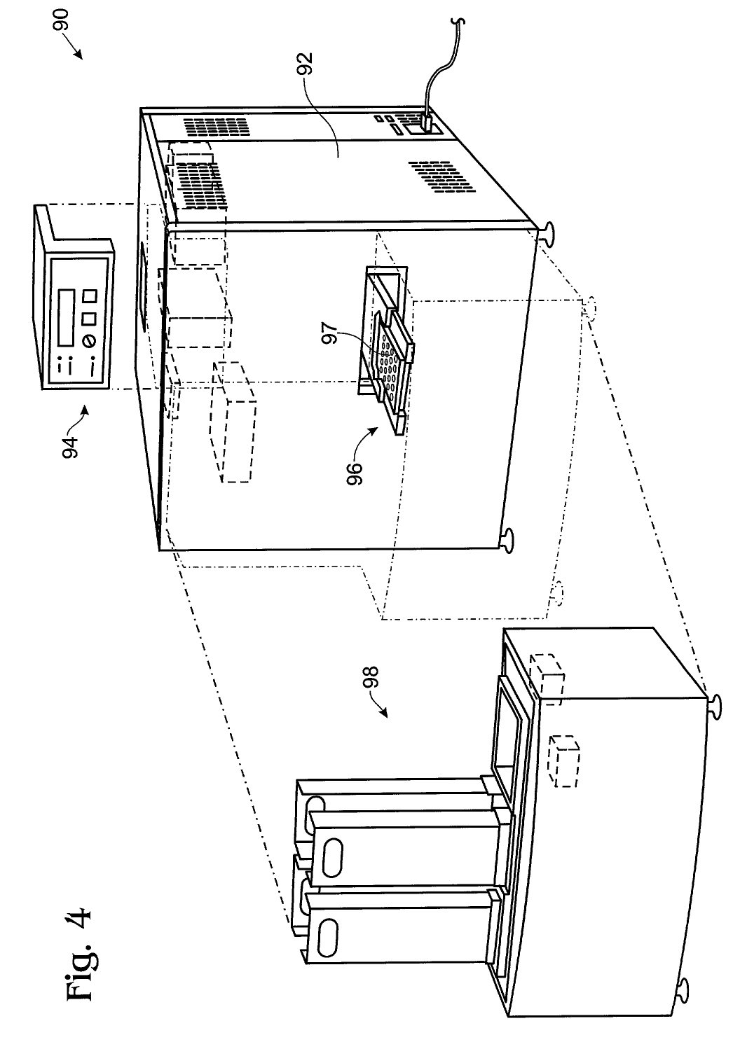

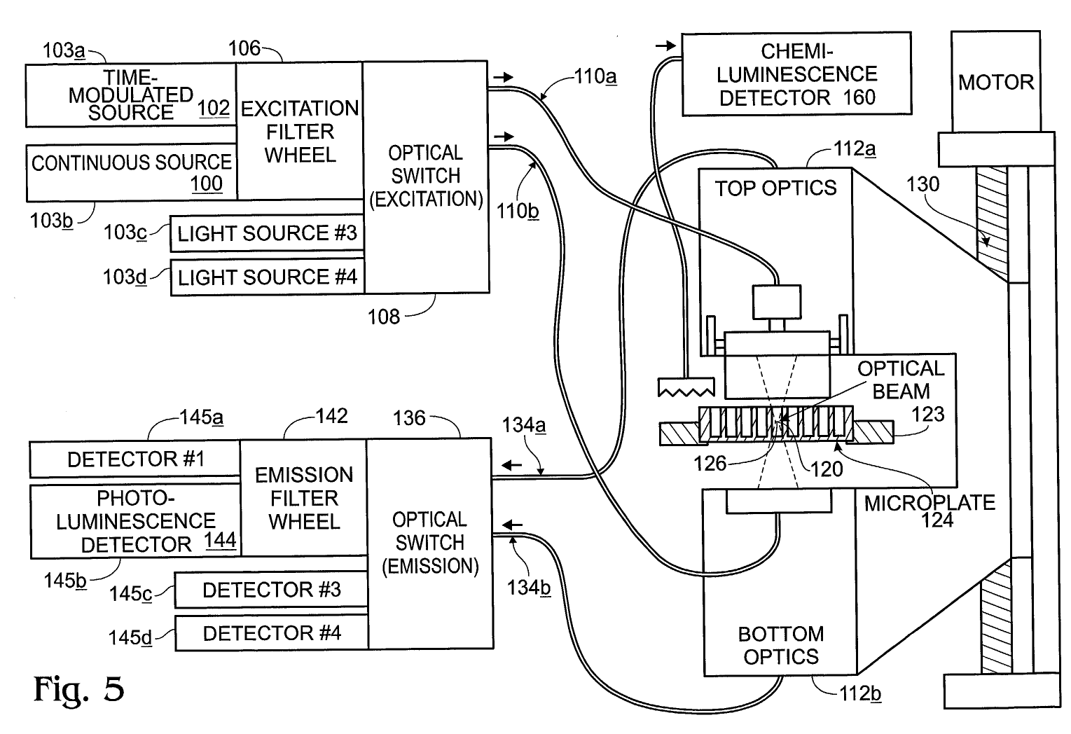

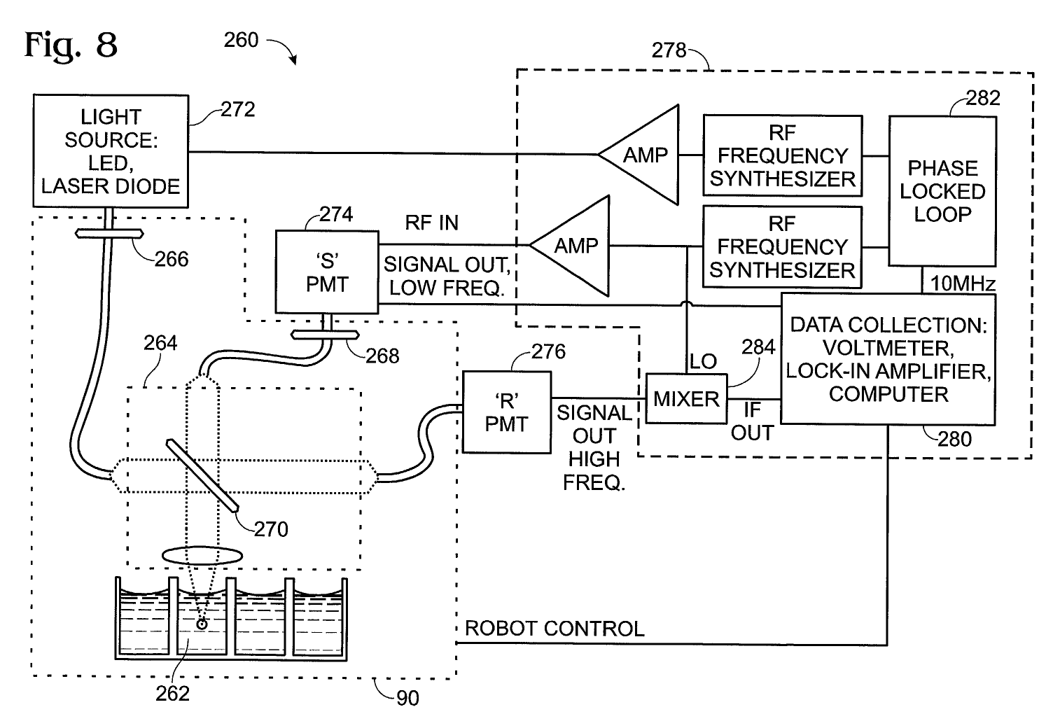

FIGS. 4-8 show an exemplary apparatus 90 for detecting light emitted by an analyte in a composition. Apparatus 90 may include a variety of components, including an optical system (FIGS. 5-7), a frequency-domain detection system (FIG. 8), a housing 92 for enclosing the optical arid/or frequency-domain detection systems, a moveable control unit 94 for controlling the apparatus, a sample transporter 96 for moving samples and/or sample containers 97 into and/or out of the apparatus for examination, and a sample feeder 98 for delivering samples and/or sample containers to and/or from the sample transporter. These components, and/or subsets and/or variations thereof, may comprise (1) a stage for supporting the composition, (2) one or more light sources for delivering light to a composition, (3) one or more detectors for receiving light transmitted from the composition and converting it to a signal, (4) first and second optical relay structures for relaying light between the light source, composition, and detector. and (5) a processor for analyzing the signal from the detector.

Apparatus 90 may be used for a variety of assays, including but not limited to intensity, polarization, and energy transfer assays, as described herein. Components of the optical system may be chosen to optimize sensitivity and dynamic range for each assay supported by the apparatus. Toward this end, optical components with low intrinsic luminescence are preferred. In addition, some components may be shared by different modes, whereas other components may be unique to a particular mode. For example, steady-state photoluminescence assays use a continuous light source; time-resolved photohliminescence assays use a time-modulated light source; and chemiluminescence assays do not use a light source. Similarly, photoluminescence and chemiluminescence modes use different detectors.

These and other aspects of the invention are described in detail below. including (A) the optical system, and (B) the frequency-domain detection system. This disclosure is supplemented by the patents, patent applications, and publications identified above under Cross-References, particularly U.S. Pat. No. 5,355,215, issued Oct. 11, 1994; U.S. Pat. No. 6,097,025, issued Aug. 1, 2000; U.S. patent application Ser. No. 09/777,343, filed Feb. 5, 2001; U.S. Provisional Patent Application Serial No. 60/267,639, filed Feb. 10, 2001; and Ser. No.______ , filed Oct. 29, 2001, titled LIGHT DETECTION DEVICE, and naming Joseph H. Jackson III, Dean G. Hafeman, and Todd E. French as inventors. These supplemental materials are incorporated herein by reference in their entirety for all purposes.

A. Optical System

FIGS. 5-7 show portions of the optical system of apparatus 90. As configured here, apparatus 90 includes a continuous light source 100 and a time-modulated light source 102. Apparatus 90 includes light source slots 103a-d for four light sources, although other numbers of light source slots and light sources also could be provided. Light source slots 103a-d function as housings that may surround at least a portion of each light source, providing some protection from radiation and explosion. The direction of light transmission through the incident light-based optical system is indicated by arrows.

Continuous source 100 provides light for absorbance, photoluminescence, and scattering assays, among others. Continuous light source 100 may include arc lamps, incandescent lamps, fluorescent lamps, electroluminescent devices, lasers, laser diodes, and light-emitting diodes (LEDs), among others. Preferred continuous sources include (1) a high-intensity, high color temperature xenon arc lamp, such as a CERMAX xenon lamp (Model Number LX175F; ILC Technology, Inc.), and (2) an LED, such as a NICHIA-brand bright-blue LED (Model Number NSPB500; Mountville, Pa.), which is particularly useful with analytes that absorb blue light. Color temperature is the absolute temperature in Kelvin at which a blackbody radiator must be operated to have a chromaticity equal to that of the light source. A high color temperature lamp produces more visible light than a low color temperature lamp, and it may have a maximum output shifted toward or into visible wavelengths and ultraviolet wavelengths where many luminophores absorb. The preferred continuous source has a color temperature of 5600 Kelvin, greatly exceeding the color temperature of about 3000 Kelvin for a tungsten filament source. The preferred source provides more light per unit time than flash sources, averaged over the duty cycle of the flash source, increasing sensitivity and reducing read times. Apparatus 90 may include a modulator mechanism configured to vary the intensity of light incident on the composition without varying the intensity of light produced by the light source.

Time-modulated source 102 provides light for time-resolved absorbance and/or photoluminescence assays, such as photoluminescence lifetime and time-resolved photoluminescence polarization assays. A preferred time-modulated source is a xenon flash lamp, such as a Model FX-1160 xenon flash lamp from EG&G Electro-Optics. The preferred source produces a “flash” of light for a brief interval before signal detection and is especially well suited for time-domain measurements. Other time-modulated sources include pulsed lasers, electronically modulated lasers and LEDs, and continuous lamps and other sources whose intensity can be modulated extrinsically using a suitable optical modulator. Intrinsically modulated continuous light sources are especially well suited for frequency-domain measurements in that they are generally easier to operate and more reliable.

If the light source must be extrinsically modulated, an optical modulator may be used. The optical modulator generally includes any device configured to modulate incident light. The optical modulator may be acousto-optical, electro-optical, or mechanical, among others. Suitable modulators include acousto-optical modulators. Pockels cells, Kerr cells, liquid crystal devices (LCDs), chopper wheels, tuning fork choppers, and rotating mirrors, among others. Mechanical modulators may be termed “choppers,” and include chopper wheels, tuning fork choppers, and rotating mirrors, among others, as described below.

In apparatus 90, continuous source 100 and time-modulated source 102 produce multichromatic, unpolarized, and incoherent light. Continuous source 100 produces substantially continuous illumination, whereas time-modulated source 102 produces time-modulated illumination. Light from these light sources may be delivered to the sample without modification, or it may be filtered to alter its intensity, spectrum, polarization, or other properties.

Light produced by the light sources follows an excitation optical path to an examination site or measurement region. Such light may pass through one or more “spectral filters,” which generally comprise any mechanism for altering the spectrum of light that is delivered to the sample. Spectrum refers to the wavelength composition of light. A spectral filter may be used to convert white or multichromatic light, which includes light of many colors, into red,. blue, green, or other substantially monochromatic light, which includes light of one or only a few colors. For example, a spectral filter may be used to block the red edge of the broad-spectrum light produced by the blue LED described above. It. apparatus 90, spectrum is altered by an excitation interference filter 104, which preferentially transmits light of preselected wavelengths and preferentially absorbs light of other wavelengths. For convenience, excitation interference filters 104 may be housed in an excitation filter wheel 106, which allows the spectrum of excitation light to be changed by rotating a preselected filter into the optical path. Spectral filters also may separate light spatially by wavelength. Examples include gratings, monochromators, and prisms.

Spectral filters are not required for monochromatic (“single color”) light sources. such as certain lasers and laser diodes, which output light of only, a single wavelength. Therefore, excitation filter wheel 106 may be mounted in the optical path of some light source slots 103a,b but not other light source slots 103c,d. Alternatively, the filter wheel may include a blank station that does not affect light passage.

Light next passes through an excitation optical shuttle (or switch) 108, which positions ,n excitation fiber optic cable 110a,b in front of the appropriate light source to deliver light to top or bottom optics heads 112a,b, respectively. Light is transmitted through a fiber optic cable much like water is transmitted through a garden hose. Fiber optic cables can be used easily to turn light around comers and to route light around opaque components of the apparatus. Moreover, fiber optic cables give the light a more uniform intensity profile A preferred fiber optic cable is a fused silicon bundle, which has low autoluminescence. Despite these advantages, light also can be delivered to the optics heads using other mechanisms, such as mirrors.

Light arriving at the optics head may pass through one or more excitation “polarization filters.” which generally comprise any mechanism for altering the polarization of light. Excitation polarization filters may be included with the top and/or bottom. optics head. In apparatus 90, polarization is altered by excitation polarizer-s 114, which are included only with top optics head 112a for top reading; however, such polarizers also can be included with bottom optics head 112b for bottom reading. Excitation polarization filters 114 may include an s-polarizer S that passes only s-polarized light, a p-polarizer P that passes only p-polarized light, and a blank O that passes substantially all light, where polarizations are measured relative to the beamsplitter. Excitation polarizers 114 also may include a standard or ferro-electric liquid crystal display (LCD) polarization switching system. Such a system may be faster than a mechanical switcher. Excitation polarizers 114 also may include a continuous mode LCD polarization rotator with synchronous detection to increase the signal-to-noise ratio in polarization assays. Excitation polarizers 114 may be incorporated as an inherent component in some light sources, such as certain lasers, that intrinsically produce polarized light.

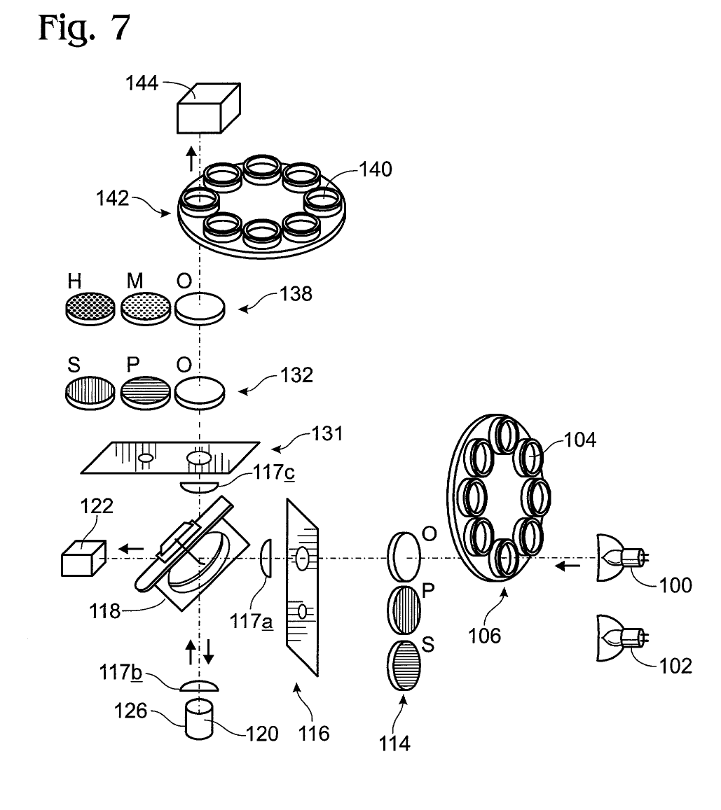

Light at one or both optics heads also may pass through an excitation “confocal optics element,” which generally comprises any mechanism for focusing light into a “sensed volume.” In apparatus 90, the confocal optics element includes a set of lenses 117a-c and an excitation aperture 116 placed in an image plane conjugate to the sensed volume, as shown in FIG. 7. Aperture 116 may be implemented directly, as an aperture, or indirectly, as the end of a fiber optic cable. Preferred apertures have diameters of 1 mm and 1.5 mm. Lenses 117a,b project an image of aperture 116 onto the sample, so that only a preselected or sensed volume of the sample is illuminated. The area of illumination will have a diameter corresponding to the diameter of the excitation aperture.

Light traveling through the optics heads is reflected and transmitted through a beamsplitter 118, which reflects light toward a composition 120 and transmits light toward a light monitor 122. Both the reflected and transmitted light pass through lens 117b, which is operatively positioned between beamsplitter 118 and composition 120.

Beamsplitter 118 is used to direct excitation or incident light toward the sample and light monitor, and to direct light leaving the sample toward the detector. The beamspitter is changeable, so that it may be optimized for different assay modes or compositions. In some embodiments, switching between beamsplitters may be performed manually, whereas, in other embodiments, such switching may be performed automatically. Automatic switching may be performed based on direct operator command, or based on an analysis of the sample by the instrument. If a large number or variety of photoactive molecules are to be studied, the beamsplitter must be able to accommodate light of many wavelengths; in this case, a “50:50” beamsplitter that reflects half and transmits half of the incident light independent of wavelength is optimal. Such a beamsplitter can be used with many types of molecules, while still delivering considerable excitation light onto the composition, and while still transmitting considerable light leaving the sample to the detector. If one or a few related photoactive molecules are to be studied, the beamsplitter needs only to be able to accommodate light at a limited number of wavelengths; in this case, a “dichroic” or “multichroic” beamsplitter is optimal. Such a beamsplitter can be designed with cutoff wavelengths for the appropriate sets of molecules and will reflect most or substantially all of the excitation and background light, while transmitting most or substantially all of the emission light in the case of luminescence. This is possible because the beamsplitter may have a reflectivity and transmissivity that varies with wavelength.

The beamsplitter more generally comprises any optical device for dividing a beam of light into two or more separate beams. A simple beamsplitter (such as a 50:50 beamsplitter) may include a very thin sheet of glass inserted in the beam at an angle, so that a portion of the beam is transmitted in a first direction and a portion of the beam is reflected in a different second direction. A more sophisticated beamsplitter (such as a dichroic or multi-dichroic beamsplitter) may include other prismatic materials, such as fused silica or quartz, and may be coated with a metallic or dielectric layer having the desired transmission and reflection properties, including dichroic and multi-dichroic transmission and reflection properties. In solve beamsplitters, two right-angle prisms are cemented together at their hypotenuse faces, and a suitable coating is included on one of the cemented faces.

Light monitor 122 is used to correct for fluctuations in the intensity of light provided by the light sources. Such corrections may be performed by reporting detected intensities as a ratio over corresponding times of the luminescence intensity measured by the detector to the excitation light intensity measured by the light monitor. The light monitor also can be programmed to alert the user if the light source fails. A preferred light monitor is a silicon photodiode with a quartz window for low autoluminescence.

The sample (or composition) may be held in a sample holder supported by a stage 123. The composition can include compounds, mixtures, surfaces, solutions, emulsions, suspensions, cell cultures, fermentation cultures, cells, tissues, secretions, and/or derivatives and/or extracts thereof. Analysis of the composition may involve measuring the presence, concentration, or physical properties (including interactions) of a photoactive analyte in such a composition. Composition may refer to the contents of a single microplate well, or several microplate wells, depending on the assay. In some embodiments, such as a portable apparatus, the stage may be extrinsic to the instrument.

The sample holder can include microplates, biochips, or any array of samples in a known format. In apparatus 90, the preferred sample holder is a microplate 124, which includes a plurality of microplate wells 126 for holding compositions. Microplates are typically substantially rectangular holders that include a plurality of sample wells for holding a corresponding plurality of samples. These sample wells are normally cylindrical in shape although rectangular or other shaped wells are sometimes used. The sample wells are typically disposed in regular arrays. The “standard” microplate includes 96 cylindrical sample wells disposed in a 8×12 rectangular array on 9 millimeter centers.

The sensed volume typically has an hourglass shape, with a cone angle ranging between about 15° and 35° and a minimum diameter ranging between about 0.1 mm and 2.0 mm. For 96-well and 384-well microplates, a preferred minimum diameter is about 1.5 mm. For 1536-well microplates, a preferred minimum diameter is about 1.0 mm. The size and shape of the sample holder may be matched to the size and shape of the sensed volume, as described in U.S. patent application Ser. No. 09/478,819, filed Jan. 5, 2000. which is incorporated herein by reference in its entirety for all purposes.

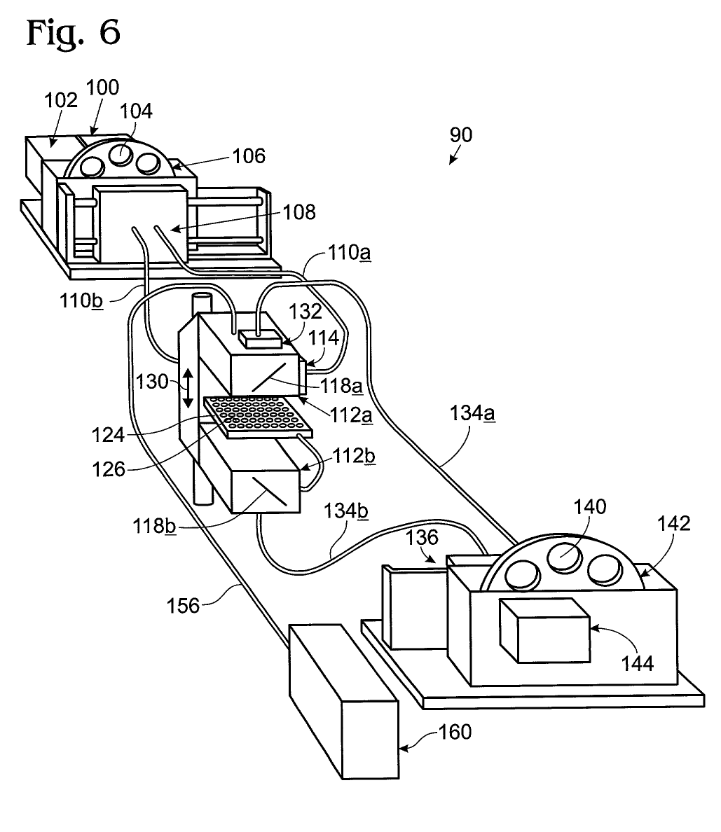

The position of the sensed volume can be moved precisely within the composition to optimize the signal-to-noise and signal-to-background ratios. For example, the sensed volume may be moved away from walls in the sample holder to optimize signal-to-noise and signal-to-background ratios, reducing spurious signals that might arise from luminophores bound to the walls and thereby immobilized. In apparatus 90, position in the X,Y-plane perpendicular to the optical path is controlled by moving the stage supporting the composition, whereas position along the Z-axis parallel to the optical path is controlled by moving the optics heads using a Z-axis adjustment mechanism 130, as shown in FIGS. 5 and 6. However, any mechanism for bringing the sensed volume into register or alignment with the appropriate portion of the composition also may be employed.

The combination of top and bottom optics permits assays to combine: (1) top illumination and top detection, or (2) top illumination and bottom detection, or (3) bottom illumination and top detection, or (4) bottom illumination and bottom detection. Same-side illumination and detection, (1) and (4), is referred to as “epi” and is preferred for photoluminescence and scattering assays. Opposite-side illumination and detection, (2) and (3), is referred to as “trans” and has been used in the past for absorbance assays. In apparatus 90, epi modes are supported, so the excitation and emission light travel the same path in the optics head, albeit in opposite or anti-parallel directions. However, trans modes also can be used with additional sensors, as described below. In apparatus 90, top and bottom optics heads move together and share a common focal plane. However, in other embodiments, top and bottom optics heads may move independently, so that each can focus independently on the same or different sample planes. In some embodiments, the optics head and/or sample holder may be independently scanned, for example, as described in U.S. patent application Ser. No. 09/768,765, filed Jan. 23, 2001, which is incorporated herein by reference in its entirety for all purposes.

Generally, top optics can be used with any sample holder having an open top, whereas bottom optics can be used only with sample holders having optically transparent bottoms, such as glass or thin plastic bottoms. Clear bottom sample holders are particularly suited for measurements involving analytes that accumulate on the bottom of the holder.

Light is transmitted by the composition in multiple directions. A portion of the transmitted light will follow an emission pathway to a detector. Transmitted light passes through lens 117c and may pass through an emission aperture 131 and/or an emission polarizer 132. In apparatus 90, the mission aperture is placed in an image plane conjugate to the sensed volume and transmits light substantially exclusively from this sensed volume. In apparatus 90, the emission apertures in the top and bottom optical systems are the same size as the associated excitation apertures, although other sizes also may be used. The emission polarizers are included only with top optics head 112a. The emission aperture and emission polarizer are substantially similar to their excitation counterparts. Emission polarizer 132 may be included in detectors that intrinsically detect the polarization of light.

Excitation polarizers 114 and emission polarizers 132 may be used together in nonpolarization assays to reject certain background signals. Luminescence from the sample holder and from luminescent molecules adhered to the sample holder is expected to be polarized, because the rotational mobility of these molecules should be hindered. Such polarized background signals can be eliminated by “crossing” the excitation and emission polarizers, that is, setting the angle between their transmission axes at 90°. As described above, such polarized background signals also can be reduced by moving the sensed volume away from walls of the sample holder. To increase signal level, beamsplitter 118 should be optimized for reflection of one polarization and transmission of the other polarization. This method will work best where the luminescent molecules of interest emit relatively unpolarized light, as will be true for small luminescent molecules in solution.

Transmitted light next passes through an emission fiber optic cable 134a,b to an emission optical shuttle (or switch) 136. This shuffle positions the appropriate emission fiber optic cable in front of the appropriate detector. In apparatus 90, these components are substantially similar to their excitation counterparts, although other mechanisms also could be employed.

Light exiting the fiber optic cable next may pass through one or more emission “intensity filters,” which generally comprise any mechanism for reducing the intensity of light. Intensity refers to the amount of light per unit area per unit time. In apparatus 90, intensity is altered by emission neutral density filters 138, which absorb light substantially independent of its wavelength, dissipating the absorbed energy as heat. Emission neutral density filters 138 may include a high-density filter H that absorbs most incident light, a medium-density filter M that absorbs somewhat less incident light, and a blank O that absorbs substantially no incident light. These filters may be changed manually, or they may be changed automatically, for example, by using a filter wheel. Intensity filters also may divert a portion of the light away from the sample without adsorption. Examples include beamsplitters, which transmit some light along one path and reflect other light along another path, and diffractive beamsplitters (e.g., acousto-optic modulators), which deflect light along different paths through diffraction. Examples also include hot mirrors or windows that transmit light of some wavelengths and absorb light of other wavelength.

Light next may pass through an emission interference filter 140, which may be housed in an emission filter wheel 142. In apparatus 90, these components are substantially similar co their excitation counterparts, although other mechanisms also could be employed. Emission interference filters block stray excitation light, which may enter the emission path through various mechanisms, including reflection and scattering.

If unblocked, such stray excitation light could be detected and misidentified as photoluminescence, decreasing the signal-to-background ratio. Emission interference filters can separate photoluminescence from excitation light because photoluminescence has longer wavelengths than the associated excitation light. Luminescence typically has wavelengths between 200 and 2000 nanometers.

The relative positions of the spectral, intensity, polarization, and other filters presented in this description may be varied without departing from the spirit of the invention. For example, filters used here in only one optical path, such as intensity filters, also may be used in other optical paths. In addition, filters used here in only top or bottom optics, such as polarization filters, may also be used in the other of top or bottom optics or in both top and bottom optics. The optimal positions and combinations of filters for a particular experiment will depend on the assay mode and the composition, among other factors.

Light last passes to a detector, which is used in absorbance, photoluminescence, and scattering assays. In apparatus 90, there is one detector 144, which detects light from all modes. A preferred detector is a photomultiplier tube (PMT). Apparatus 90 includes detector slots 145a-d for four detectors, although other numbers of detector slots and detectors also could be provided.

More generally, detectors comprise any mechanism capable of converting energy from detected light into signals that may be processed by the apparatus, and by the processor in particular. Suitable detectors include photomultiplier tubes, photodiodes, avalanche photodiodes, charge-coupled devices (CCDs), and intensified CCDs, among others. Depending on the detector, light source, and assay mode, such detectors may be used in a variety of detection modes. These detection modes include (1) discrete (e.g., photon-counting) modes, (2) analog (e.g., current-integration) modes, (3) point, and/or (4) imaging modes, among others, for example, as described in U.S. patent application Ser. No. 09/643,221, filed Aug. 18, 2000, which is incorporated herein by reference in its entirety for all purposes.

B. Frequency-domain System

FIG. 8 shows portions of a frequency-domain system 260 for use with apparatus 90 for detecting and/or processing light emitted by an analyte in a composition 262. The detecting and/or processing may be performed in the frequency-domain. System 260 may interface with the optical components of apparatus 90, including its fiber-optic-coupled optics head 264, excitation 266 and emission 268 filters, dichroic beam splitter 270, and mechanisms for sample positioning and focus control. Alternatively, or in addition, system 260 may include other light sources 272, sample (‘S’) detectors 274, reference is (‘R’) detectors 276, and/or detection electronics 278. Here, alternative components 272- 278 are shown separated from apparatus 90, but they readily may be included inside the housing of apparatus 90, if desired.

System 260 may detect emitted light and convert it to a signal using any suitable mechanism. This demodulation/deconvolution may be internal to the photodetector, or it may be performed with external electronics or software. For example, emitted light can be detected using sample detector 274, which may be an ISS-brand gain-modulated PMT (Champaign, Ill.). High-frequency emitted light can be frequency down-converted to a low-frequency signal using a technique called heterodyning. The phase and modulation of the low-frequency signal can be determined using a lock-in amplifier 280, such as a STANFORD RESEARCH SYSTEMS brand lock-in amplifier (Model Number SR830; Sunnyvale, Calif.). Lock-in amplifier 280 is phase locked using a phase-locked loop 282 to a modulation frequency of light source 272, such as the fundamental frequency or a harmonic thereof. To correct for drift in the light source, the output of light source 272 may be monitored using reference detector 276, which may be a HAMAMATSU-brand PMT (Model Number H6780: Bridgewater, N.J.). If reference PMT 276 can respond to high-frequency signals, the heterodyning step can be performed using an external mixer 284. The phase and modulation of reference PMT 276 also may be captured by lock-in amplifier 280 and used to normalize the signal from sample PMT 274.

A computer or processor controls the apparatus, including the external components. The computer also directs sample handling and data collection. Generally, phase and modulation data are collected at one or more frequencies appropriate for the lifetime of the analyte. In some cases, phase and modulation may be measured at one or a few frequencies and processed by the computer or processor to help reduce detected background.

### III. Improvements in Signal Resolution

This section describes apparatus, methods, and compositions of matter for improving signal resolution in optical spectroscopy. The apparatus may include components for detecting light emitted by an analyte in a composition. These components may include (1) a stage for supporting the composition, (2) a light source and a first optical relay structure that directs light from the light source toward the composition, so that the analyte may be induced to emit light, (3) a detector and a second optical relay structure that directs light from the composition toward the detector, so that the light may be detected and converted to a signal, and (4) a processor for analyzing the signal. The processor may be used to discriminate between a first portion of the signal that is attributable to the light emitted by the analyte and a second portion of the signal that is attributable to a non-analyte emitter. The non-analyte emitter may include background, and/or the non-analyte emitter may include a reference compound for correcting for scattering and absorption among others.

These and other aspects of the invention are described in detail below, including (A) background, (B) summary, (C) overview, (D) intensity assays, (E) polarization assays, (F) additional methods, (G) reference compounds, and (H) examples. TL his disclosure is supplemented by the patents, patent applications. and publications identified above under Cross-References, particularly: U.S. Provisional Patent Application Serial No. 60/072,499, filed Jan. 26, 1998; U.S. Provisional Patent Application Serial No. 60/072,780, filed Jan. 27, 1998; U.S. Provisional Patent Application Serial No. 60/075,806, filed Feb. 24, 1998; U.S. Provisional Patent Application Serial No. 60/0i84,167, filed May 4, 1998; U.S. patent application Ser. No. 09/626,208, filed Jul. 26, 2000; Provisional Patent Application Serial No. 60/167,463, filed Nov. 24, 1999; Provisional Patent Application Serial No. 60/182,419, filed Feb. 14, 2000; patent application Ser. No. 09/722,247, filed Nov. 24, 2000; 09/767,316; U.S. patent application Ser. No. 09/770,720, filed Jan. 25, 2001; and U.S. Provisional Patent Application Serial No. 60/178,026, filed Jan. 26, 2000. These supplemental materials are incorporated herein by reference in their entirety for all purposes. These supplemental materials describe, among others, the application of aspects of the invention to the study of nucleic acid hybridization, nucleic acid polymorphisms, and cytoskeletal interactions.

A. Background

Optical spectroscopic assays are subject to artifacts that alter the apparent luminescence of the analyte and thus the accuracy, repeatability, and reliability of the assay. Some artifacts increase the apparent luminescence of the analyte, causing intensity-based assays to overreport the amount of light emitted by the analyte. Such artifacts include background. Other artifacts decrease the apparent luminescence of the analyte, causing intensity-based assays to underreport the amount of light emitted by the analyte. Such artifacts include scattering and absorption Such artifacts also include changes in the composition that change the optical transfer function (photons collected/photons injected), including changes in index of refraction and surface tension.

Optical spectroscopic assays also are subject to artifacts that alter the apparent polarization of the analyte. Such artifacts also include background, scattering, and absorption, among others, and can increase or decrease the apparent polarization.

Among artifacts that alter polarization while increasing the apparent luminescence of the analyte, background is especially significant. Background refers to light and other signals that do not arise from the analyte, but that can be confused with light that does arise from the analyte. Background may arise from non-analyte luminescent components of the sample (e.g., library compounds, target molecules, etc.). Background also way arise from luminescent components of the sample container and detection system (e.g., microplates, optics, fiber optics, etc.). Background also may arise from scattered excitation light that leaks through the optical filters, which is equivalent to luminescence with a zero lifetime, and from room light.

There is no way to eliminate every source of background, so methods must be used to discriminate between analyte and background. If the analyte and background have different spectra, background may be at least partially discriminated using appropriate optical filters, which pass light emitted by the analyte but block background. If the analyte and background have overlapping spectra, background may be at least partially discriminated in two ways. First, background may be discriminated using a blank. in this method, data such as intensity data are collected for the sample and for a blank that lacks analyte but otherwise resembles the sample. Background is at least partially discriminated by subtracting the data obtained from the blank from tile data obtained from the sample. Second, background may be discriminated by gating. In this method, data are collected from the sample only at times when the background is low or nonexistent.

Unfortunately, these methods of rejecting background suffer from a number if shortcomings, especially if the analyte and background have overlapping spectra. The use of blanks requires making two measurements for every sample, at least if the background is different for each sample. Background may be different for each sample if each sample is housed in a different container and/or if each sample contains a different, intrinsically luminescent target molecule, such as a peptide, protein, or nucleic acid, among others. The use of gating requires knowledge of the lifetime and intensity of the background. The use of gating also requires collecting data only over limited times, so that data collection is slowed and potentially useful data is discarded. Gating is especially problematic for short-lifetime background, because luminescence from the analyte is most intense for short times after excitation.

Among artifacts that alter polarization while decreasing the apparent luminescence of the analyte, scattering and absorption are especially significant. Scattering can arise if the composition containing the analyte is turbid, so that excitation and/or emission light are scattered out of the optical path and therefore not detected. Absorption can arise if non-analyte components of the composition can absorb excitation and/or emission light. Absorption. of excitation light reduces luminescence indirectly, by reducing the amount of light available to excite luminescence. Absorption of emission light reduces luminescence directly. Collectively, absorption of excitation and emission light is termed “color quenching.” Scattering and color quenching may vary from sample to sample and therefore be difficult to characterize.

There is no way to eliminate every source of scattering and absorption. This is especially true in compositions containing biological molecules, because biological molecules such as nucleic acids and proteins may absorb light having wavelengths commonly used in luminescence assays.

Background, scattering, absorption, and other artifacts affecting apparent luminescence are significant shortcomings, even for single measurements. However, they are potentially crippling shortcomings in high-throughput genomics applications, where tens or hundreds of thousands of samples may be analyzed each day. In genomics applications, the use of blanks may double the consumption of reagents and the time required for sample preparation and data collection, as well as associated costs. Moreover, in genomics applications, biological molecules that scatter and absorb light often must be employed.

B. Summary

The invention provides apparatus, methods, and compositions for improving signal resolution in optical spectroscopy. These improvements may be obtained without using information from a blank, and/or without requiring a determination of the lifetime or intensity of the background. These improvements also may be obtained irrespective of whether a significant amount of the background is being detected by the detector at the same time that light emitted by the analyte is being detected. Consequently, the invention permits discrimination between analyte and background and/or other non-analyte emitters in measurements performed in a single sample container. The invention also permits light to be detected and analyzed continuously, so that signal is not wasted and data collection is not slowed.

The apparatus may include components for detecting light emitted by an analyte in a composition. These components may include (1) a stage, (2) a light source and a first optical relay structure that directs light from the light source toward the composition, (3) a detector and a second optical relay structure that directs light from the composition toward the detector, and (4) a processor. The stage may be used to support the composition. The light source and first optical relay structure may be used to induce the analyte to emit light. The detector and second optical relay structure may be used to detect light transmitted from the composition and to convert the detected light to a signal. The processor may be used to discriminate between a first portion of the signal that is attributable to the light emitted by the analyte and a second portion of the signal that is attributable to a non-analyte emitter, signal modifier, or perturbant. The non-analyte emitter may include background, and/or the non-analyte emitter may include a reference compound for correcting for scattering and absorption, among others.

The processor may employ various algorithms. For example, the processor may discriminate between the first and second portions of the signal without requiring a determination of the lifetime or intensity of the background. The processor also may discriminate between the first and second portions without requiring the use of information obtained from a blank. The processor also may discriminate between the first and second portions in the frequency domain. The processor also may employ other algorithms.

The processor may calculate various quantities. For example, the processor may calculate the intensity of the analyte. The processor also may calculate the polarization of the analyte. The processor also may calculate a quantity that expresses the intensity or polarization of the analyte as a function of the intensity or polarization of a reference compound. The processor also may calculate other quantities.

The methods may include steps for detecting light emitted by an analyte in a composition. These steps may include (1) illuminating the composition, so that light is emitted by the analyte, (2) detecting light transmitted from the composition and converting it to a signal, and (3) processing the signal to discriminate between a first portion of the signal that is attributable to the light emitted by the analyte and a second portion of the signal that is attributable to a background. The methods also may include additional or alternative steps.

The compositions of matter may include first and second luminophores. wherein the emission spectra of the first and second luminophores overlap significantly, and wherein light emitted by the first luminophore is resolvable from light emitted by the second luminophore using lifetime-resolved methods. The first luminophore may be an analyte, and the second luminophore may be a reference compound.

C. Overview

Background can be represented, in many applications. as a combination of (1) a relatively constant background luminescence (from well to well in microplate experiments) having a relatively constant anisotropy and (2) random fluctuations in both the luminescence level and its anisotropy caused by luminescent contamination (“hot wells” in microplate experiments). This background can be reduced or subtracted using various methods, including:

1. conventional background subtraction using control wells, which generally is not effective in reducing background from hot wells.

2. Premeasuring background from the microplate and subtracting the background after the reagents are added and the measurement is completed.

3. Using FLARe technology to perform the measurement and FLAMe methods to subtract background in polarization measurements, which is effective in reducing variable background from “hot wells,” if the background has an average lifetime distinct from the analyte lifetime

4. Premeasuring the background anisotropy; performing a total intensity measurement on each well; using the average value of the total intensity for all wells to determine the fractional intensity of the background of each well. because all wells should have the same total intensity; and using the anisotropy-based method for background-subtraction of polarization data described below to perform the background subtraction.

The latter methods may involve converting detected light to a signal, and discriminating between a first portion of the signal that is attributable to light emitted by the luminophore and a second portion of the signal that is attributable to a background. The discriminating step may be performed using a processor. The processor may discriminate between the first and second portions of the signal without requiring a determination of the lifetime or intensity of the background, or without requiring the use of information obtained from a blank (irrespective of whether a significant amount of the background is being detected by a detector at the same time that light emitted by the analyte is being detected). The processor also may discriminate between the first and second portions in the frequency domain without requiring a determination of the intensity of the background, or without requiring the use of information obtained from a blank.

C.1 Intensity-based Method

The following intensity-based method may be used to analyze polarization results:

1. Take polarization measurements on all wells on plate.

2. Identify buffer (background) wells on plate.

3. Determine average intensities of background wells for both ∥ and ⊥ channels.

4. Subtract average background ∥ and ⊥ channel intensities from all wells.

5. Calculate polarization for each well using,G factor and background-subtracted ∥ and ⊥ intensities.

Here, step 5 is carried out using the following relation between intensity and polarization:

$$P = \frac{( {I}_{\vert \vert} - {I}_{\vert \vert 0} ) - G ( {I}_{⊥} - {I}_{⊥ 0} )}{( {I}_{\vert \vert} - {I}_{\vert \vert 0} ) + G ( {I}_{⊥} - {I}_{⊥ 0} )} , \qquad ( 6 )$$

where the ∥ and ⊥ subscripts indicate the ∥ and ⊥ intensities, respectively, and the 0 subscript indicates a background intensity.

C.2 Anisotropy-based Method

A novel alternative anisotropy-based procedure also may be used to analyze polarization results. A basic difference between the intensity-based and anisotropy-based procedures is how the background is subtracted: in the intensity-based procedure, intensities are subtracted, whereas in the anisotropy-based procedure, anisotropies are subtracted. The anisotropy-based procedure may provide the following benefits: (1) a more robust method for background subtraction, and (2) insight into how hot wells affect polarization measurements, and a mechanism to address them.

C.3 Derivation of Anisotropy-based Method

To simplify the math, the anisotropy-based method is derived in terms of anisotropy rather than polarization, with the understanding that we can readily convert between anisotropy and polarization.

$$R = \frac{2 P}{3 - P} , P = \frac{3 R}{2 + R} , \frac{2}{R} = \frac{3}{P} - 1. \qquad ( 7 )$$

The underlying assumption for this analysis is that the assay system can be decomposed into two components: (1) the label of interest, and (2) everything else, which is lumped together as background. This typically would include autoluminescence from the microplate or other substrate and from the optical elements of the light detection device. (The same assumption is used in the intensity-based background-subtraction analysis.) The average anisotropy for the system is then given by the following expression:

R_{T}=f_{L}R_{L}+f₀R₀. (8)

where the multiplier f indicates the fractional intensity of a given component, and the subscripts T, L., and 0 indicate total. libel of interest. and background. respectively. Solving for the anisotropy of the label of interest and invoking the relationship f_{L}=1−f₀ yields:

$${R}_{L} = \frac{{R}_{T} - {f}_{0} {R}_{0}}{{f}_{L}} = \frac{{R}_{T} - {f}_{0} {R}_{0}}{1 - {f}_{0}} , \qquad ( 9 )$$

T he preceding equation indicates that background can be subtracted by manipulating anisotropies rather than intensities. The anisotropy of the label (R_{L}) can be estimated from the total anisotropy (R_{T}) if the background anisotropy (R₀) and background relative intensity (f₀) are known.

Before proceeding, it is instructive to review typical values for the parameters in this equation. R_{L} depends on the label of interest; for free fluorescein in PBS, it is about 0.02 (27 mP), and for the antibody-bound tracer in the TKX™ assay kit marketed by LJL BioSystems, it is about 0.1 (140 mP).R₀ can range from about 0.400 (500 mP) for PBS in black plates to less than about 0.015 (22 mP) for white plates. f₀ has an absolute range of 0.0 to 1.0, but will be small in most applications. For instance, in the TKX assay, the average background intensity is typically about 0.006. In the fluorescein dilation series used to test the light detection device presented above, the buffer wells are roughly the same brightness as 6 pM fluorescein, so that f₀ is about 0.06 when compared with our performance specification of 100 pM.

A potential advantage of the anisotropy-based procedure is that it may be more robust than the intensity-based procedure. If intensities vary for some reason, such as a change in lamp power or alignment, the intensity-based background-subtraction procedure may give erroneous results. However, the anisotropy-based background-subtraction procedure will still give correct results because the background anisotropy and relative background intensity should remain unchanged.

C.4 Propagation of Error

We want to be sure that anisotropy-based background subtraction does not introduce unacceptably high errors into our results. Error propagation can be estimated by

$$Δ {R}_{L} = \sqrt{{( \frac{1}{1 - {f}_{0}} )}^{2} {( Δ {R}_{T} )}^{2} + {( \frac{{f}_{0}}{1 - {f}_{0}} )}^{2} {( Δ {R}_{0} )}^{2} + {( \frac{{R}_{T} - {R}_{0}}{{( 1 - {f}_{0} )}^{2}} )}^{2} {( Δ {f}_{0} )}^{2}} \qquad ( 10 )$$

For small f₀, this simplifies to

ΔR_{L}=\sqrt{(ΔR_{T})²+f₀²(ΔR₀)²+(R_{T}−R₀) ²(Δf₀)²} (11)

This equation shows that:

1. Errors in R_{T} (instrument errors) translate directly into. errors in R_{L}.

2. Errors in the background anisotropy have only a small effect on our determination of R_{L}; for instance, if f₀ is 0.01 and ΔR₀ is 0.1 (150 mP), the effect on R_{L} is <0.001 (1.5 mP).

3. Errors in f₀ (hot wells) give appreciable errors in R_{L} Whenever R_{T} and R₀ are significantly different. For instance if R_{T}=0.1, R₀=0.4 and Δf₀=0.1, the error in R_{L} is <0.03 (45 mP).

Note that ΔR_{L} skyrockets when the background is bright. For instance, if the background and label have equal brightness (f₀=0.5). then

ΔR_{L}=\sqrt{(2ΔR_{T})²+(ΔR₀)²+(R_{T}−R₀)²(4Δf₀)²} (12)

This may explain why the current lower-detection limit (LDL) of the fluorescein polarization is about 30 pM; because the background has a brightness of about 6 pM, the errors begin to accumulate as we approach this concentration.

C.5 Application: Treated Plates for Control of Hot Wells in Polarization

Assume that we can fabricate or treat microplates in such a way that their background anisotropy is controllable. For instance, we could add some titanium dioxide to a black plate to cause scattering, which would reduce background polarization. Specifically, consider a plate designed to work with the TKX assay. In the TKX assay, we look for a decrease in anisotropy from a nominal value of 0.100 (140 mP) to some lower value. The plate is designed with a background anisotropy of about 0.100 (140 mP) so that it provides a background that matches the assay. Now we see from Equations 8 and 9 that all “non-hit” wells give R_{T}=R_{L}=R₀=0.100.

Next, look at the behavior of a hot well. It can be extremely bright, say f₀=0.5, but because its anisotropy is the same as background, it is not detected as a “hit,” because by Equations 8 and 9 it still gives R_{T}=R_{L}=R₀=0.100. This hot-well immunity is also evidenced in Equation 12: when R_{T} and R₀ are about the same, errors in f₀ (hot wells) do not propagate to R_{L}.

If it is not technically feasible to make microplates Math controlled anisotropy, then the same effect might be achieved by adding polarized components to the assay chemistry. to achieve the desired background anisotropy.

C.6 Experimental Results

Six 96-well microplates were filled with PBS (250 μL/well) and read on Analyst S/N F003. The following table shows intensity and polarization data for each plate.

| | ¦\|Channel cps | | ⊥ Channel cps | | Polarization (mP) | |
|---|---|---|---|---|---|---|
| Plate | Avg | StDev | Avg | StDev | Avg | StDev |
| white plate | 616624 | 20276 | 637303 | 19092 | 8 | 14 |
| black plate 1 | 49303 | 2272 | 17369 | 1212 | 498 | 18 |
| black plate 2 | 48805 | 1257 | 16718 | 525 | 508 | 14 |
| black plate 3 | 48907 | 1471 | 16984 | 799 | 503 | 18 |
| black plate 4 | 48401 | 1122 | 16647 | 478 | 506 | 14 |
| black plate 5 | 48581 | 1484 | 16833 | 810 | 504 | 17 |

The data indicate that:

1. The background polarization of the of the black plates is very high (about 500 mP).

2. The background polarization of the black plates is consistent from plate to plate.

3. The background polarization of the white plate is very low.

These data indicate that background anisotropy could be measured less frequently. Moreover, the consistency in the ∥ and ⊥ intensities suggests that a similar approach could be implemented with our current intensity-based background-subtraction methodology. That is, ∥ and ⊥ channel background intensities could be measured less frequently than every plate.

In other experiments, the background (buffer well) intensity was compared with that of fluorescein. Four different plates were read on 4 different Analyst units. In all cases, the brightness was similar (about 6 pM fluorescein), even though different instruments were used.

Buffer brightness (pM)

| Unit | 96 wells | 384 wells |
|---|---|---|
| AN0085 | 4.8 | 4.0 |
| AN0086 | 7.8 | 4.9 |
| AN0088 | 5.1 | 4.5 |
| AN0090 | 6.8 | 6.4 |

C.7 FLAMe Method

Another method to remove unwanted fluorescence background is to employ the fluorescence lifetime anisotropy method (FLAMe). This method can eliminate the effect of background fluorescence in a polarization assay if the background has an average lifetime distinct from the analyte lifetime.

FLAMe uses the time-resolved fluorescence anisotropy measured in the frequency domain to distinguish the long and short lifetime components. The measurement is then manipulated to establish the ratio of bound probe molecules to the sum of the bound and free molecules (the fraction of bound molecules). The goal of the method is to establish a way to measure the fraction of bound molecules (or free ones) without interference from other fluorescing compounds.

C.8 Derivation of the FLAMe Method

The lifetime discriminated intensity (LDI) may be used for the rejection of short lifetime background when a long lifetime analyte is used (also the reverse is possible). The LDI can be substituted anywhere a conventional intensity would be used. For a polarization assay, the LDI of the parallel intensity and the LDI of the perpendicular intensity can replace the parallel and perpendicular intensity values used to calculate the polarization (or anisotropy).

$$P = \frac{( L D {I}_{\vert \vert} ) - G ( L D {I}_{⊥} )}{( L D {I}_{\vert \vert} ) + G ( L D {I}_{⊥} )} \qquad ( 13 )$$

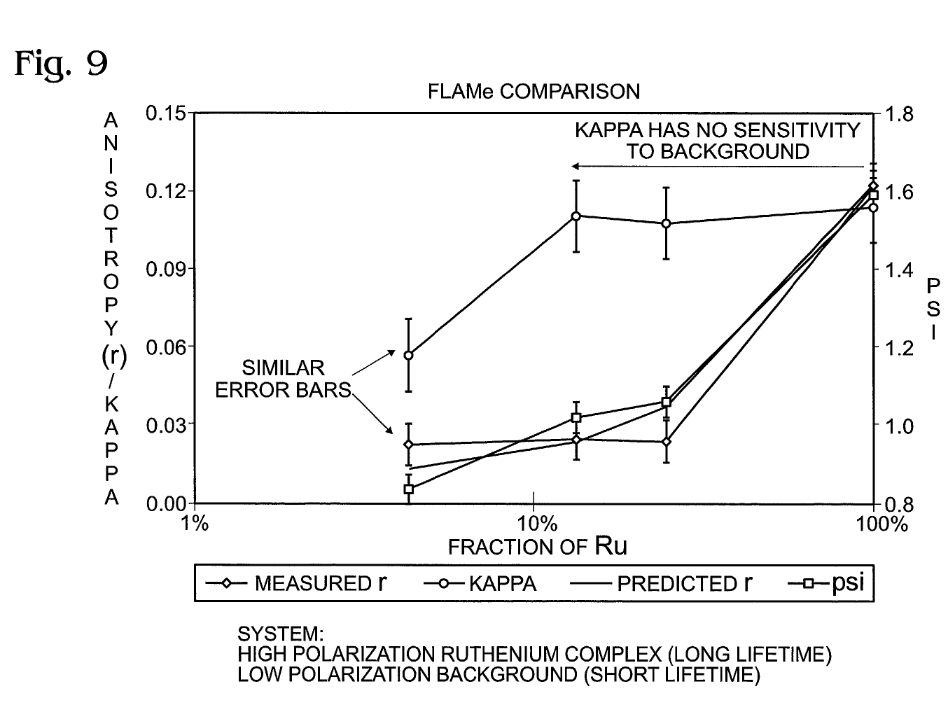

FIG. 9 shows using experimental results that short-lifetime background with low polarization does not significantly affect performance of FLAMe methods.

D. Intensity Assays

The apparatus and methods provided by the invention can be used to discriminate between analyte and background in intensity assays. Background-corrected intensities derived from such intensity assays can be used directly, ,s intensities, or they can be used indirectly to determine quantities such as polarization and luminescence lifetime. Generally, the invention permits determination of background-corrected intensities for systems having one or more analytes and one or more background components.

D1 Two-component Analysis

In systems having two detectable components, such as analyte and background, the contribution of each component to-the total intensity can be determined using the intensity, phase, and modulation of the system, measured at a single angular modulator frequency ω. This embodiment of the invention may be termed lifetime-discriminated intensity (LDI).

In the time domain, the luminescence of a complex luminophore or of a mixture of luminophores normally decays as a series of exponentials.

$$I ( t ) = {\sum }_{i} {α}_{i} {ⅇ}^{- t / {τ}_{i}} \qquad ( 14 )$$

Here, I(t) is the time-dependent luminescence intensity, αᵢ is a preexponential factor, and τᵢ is the luminescence lifetime of the ith component. The fraction of the steady-state luminescence intensity contributed by each component may be found by integrating Equation 14 over time.

$${f}_{i} = {α}_{i} {τ}_{i} / {\sum }_{j} {α}_{j} {τ}_{j} \qquad ( 15 )$$

Here, fᵢ is the fractional intensity of the ith component.

In the frequency domain, the phase and modulation phasor of a complex luminophore or a mixture of luminophores is a vector sum of the phase and modulation of the individual components, weighted by the individual components' fractional contributions to the total intensity.

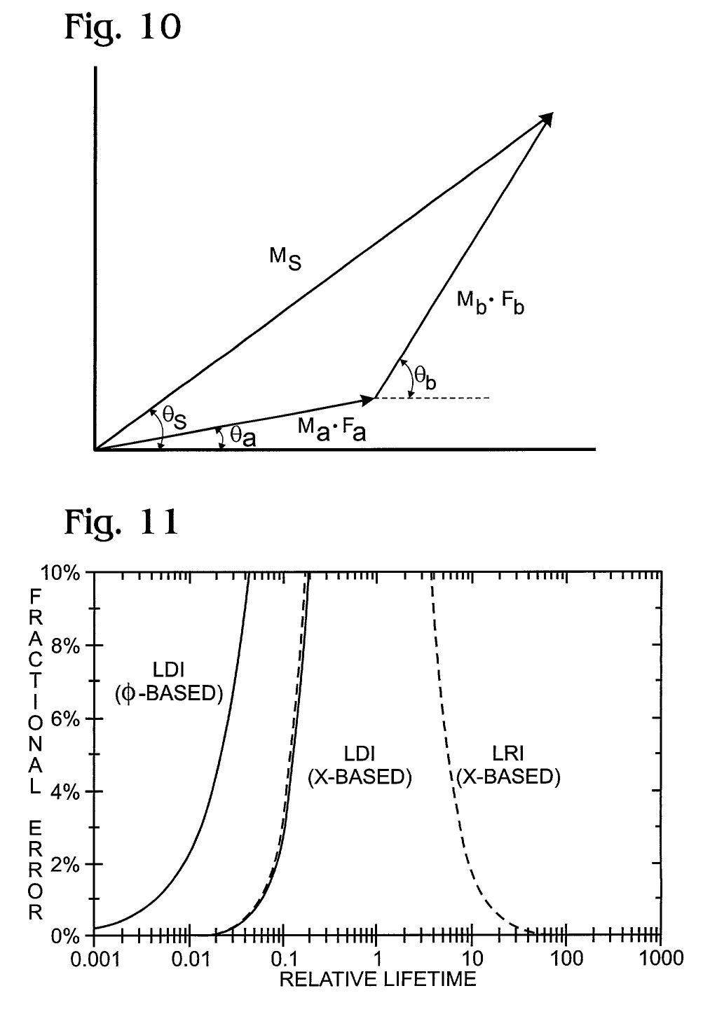

FIG. 10 shows phase and modulation for a system containing two luminophores, such as an analyte and background. The phase and modulation of the system can be expressed in terms of X and Y components of the phasor.

M₁=\sqrt{M_{s,x}²+M_{x,y}²} (16)

$${φ}_{s} = arctan ( \frac{{M}_{s , y}}{{M}_{s , x}} ) \qquad ( 17 )$$

Here ‘s’ denotes system, and ‘x’ and ‘y’ denote X and Y components. The X and Y components for the system can be expressed in terms of X and Y components for the analyte and background alone.

M_{s,x}≡Mₛ·cos φₛ=fₐ·Mₐ·cos φₐ+(1−fₐ)·M_{b}·COS φ^{b} (18)

M_{s,y}≡Mₛ·sin φₛ=fₐ·Mₐ·sin φₐ+(1−]fₐ)·M_{b} ·sin φ_{b} (19)

Here ‘a’ denotes analyte, and ‘b’ denotes background.

Equations 18 and 19 can be rearranged to solve for the fractional intensities of the analyte and background. The fractional intensity fₐ of the analyte is

$${f}_{a} = \frac{{M}_{b , i} - {M}_{s , i}}{{M}_{b , i} - {M}_{a , i}} \qquad ( 20 )$$

Here ‘i’ denotes x or y, corresponding to X or Y components. To calculate fractional intensity using Equation 15, three quantities must be known: Mₛᵢ, corresponding to the system; M_{a,i}, corresponding to analyte alone; and M_{bi}, corresponding to background alone. M_{s,i}, is determined for each sample, by making a measurement on each sample. M_{a,i} is determined for each analyte. not for each sample, either (1) by measuring the modulation phasor using a blank containing the analyte “without” background (possibly at high concentration), or (2) by calculating the modulation phasor using Equations 1 and 2 and the analyte lifetime as measured above without background. This is applicable in the case where the analyte is the same but the background is different in every sample (as in high-throughput screening (HTS)). M_{b,i}, may be estimated for each sample by making a measurement on a blank for each sample. In HTS, M_{b,i} typically varies from sample to sample, because the background includes contribution from the composition. An alternative method leading to larger errors in HTS would be to measure an average background using a single blank (M_{b,i}) and to apply this background to each sample.

Tile apparatus and methods provided by the invention allow a more elegant and accurate solution to background correction, which does not require the use of a blank. Equation 20 can be rewritten as a power series of ω_{τ}_{_{b}} or 1 ω_{τ}_{_{b}} (assuming that the background follows a single exponential decay). The motivation for the power series is that the power series can be conveniently truncated if the background has a short lifetime (ω_{τ}_{_{b}}<<1) or if the background has a long lifetime (1/ω_{τ}<<1). If the background has a short lifetime, the analyte fractional intensity is

$${f}_{a} = \frac{1 - {M}_{s , x}}{1 - {M}_{a , x}} + \frac{{M}_{a , x} - {M}_{s , x}}{{( 1 - {M}_{a , x} )}^{2}} \cdot {( {ωτ}_{b} )}^{2} + … {\to }^{ {{ωτ}_{o} \to 0}^{lim} } \frac{1 - {M}_{s , x}}{1 - {M}_{a , x}} \qquad ( 21 )$$

If the background has a long lifetime, the analyte fractional intensity is

$${f}_{a} = \frac{{M}_{s , x}}{{M}_{a , x}} + \frac{{M}_{s , x} - {M}_{a , x}}{{M}_{a , x}^{2}} \cdot \frac{1}{{( {ωτ}_{b} )}^{2}} + … {\to }^{ {{ωτ}_{o} \to ∞}^{lim} } \frac{{M}_{s , x}}{{M}_{a , x}} \qquad ( 22 )$$

Equations 21 and 22 discriminate between light emitted by the analyte and short- or long-lifetime background, based on differences in lifetime, without requiring the lifetime or intensity of the background. If the value of the background lifetime is only known to be short (as compared to the frequency), we employ the limiting case of Equation 21. Likewise, if the background lifetime is only known to be long, we employ the limiting case of Equation 22. When the background lifetime is better known (yet, still short or long), higher order terms in Equations 21 and 22 may be calculated and used to yield a better approximation.

Although both the X and Y versions of Equation 20 are valid, it is more fruitful to make approximations with the X version because the X expansions only have nonzero terms with even powers of the background lifetime (or inverse lifetime, as appropriate),whereas the Y expansions have all powers of the background lifetime (or inverse lifetime, as appropriate). Thus, when an approximation is made, the order of the first neglected term in the X case always will be equal to or higher than the first neglected term in the Y case. The modulation- and phase-based equations for fₐ (not shown) behave in the same way as the equations in the Y case, in that all powers of the background lifetime are included in the expansion. For example, in a phase-based formulation, if the background has a short lifetime, the analyte fractional intensity is

$${f}_{a} = \frac{tan {φ}_{s}}{{M}_{a , y} + ( 1 - {M}_{a , x} ) \cdot tan {φ}_{s}} + \frac{{M}_{a , y} + ( 2 - {M}_{a , x} ) \cdot tan {φ}_{s}}{{( {M}_{a , y} + ( 1 - {M}_{a , x} ) \cdot tan {φ}_{s} )}^{2}} \cdot {ωτ}_{b} + … \qquad ( 23 )$$

However, the phase-based approach has a potential advantage. If only the phase is desired, a device could be optimized to measure just the high-frequency (AC) intensity or phase without measuring the average (DC) intensity. With the elimination of DC electronics, the device is likely to be more stable electronically and to provide a more precise measurement. This increased precision may allow the frequency to be reduced so that the neglected terms in the phase approach (Equation 23) become comparable to those in the modulation phasor approach (Equation 21). This increase in precision may even make the phase approach preferable to the modulation phasor approach.

Variations in the excitation intensity and lifetime of the background do not affect the determination of fₐ, to the extent that the background lifetime remains small or large, as appropriate. This is true even if the background includes multiple components, as long as the lifetime of each component is short (Equations 21 and 23) or long (Equation 22).

In these cases, the average or effective lifetime of the background may be used in Equations 21-23 as needed.

Alternative versions of Equations 21 and 22 can formulated by creating a power series in τ_{b}/τₐ (for short-lifetime background) or τ_{b}τ/ₐ (for long-lifetime background) from Equation 20. For example, the short-lifetime expansion is

$${f}_{a} = \frac{1 - {M}_{s , x}}{1 - {M}_{a , x}} + \frac{{M}_{a , x} - {M}_{s , x}}{{M}_{a , x} \cdot ( 1 - {M}_{a , x} )} \cdot {( \frac{{τ}_{b}}{{τ}_{a}} )}^{2} + … \qquad ( 24 )$$

This expansion demonstrates that the lifetime ratio has as much effect on. the approximation as does the background lifetime, frequency product. The lifetime ratio expansion also may prove useful if one knows the lifetime ratio better than the absolute lifetime of the background and a second order correction is desired.

D.2 Three-component Analysis

Sometimes the background has both short- and long-lifetime components. In these cases, the two-component models of Equations 21-24 will incorrectly report the fractional analyte intensity because the unexpected background (either long or short lifetime, depending on the equation) will be mixed with the analyte signal. In such situations, a three-component analysis should be used.

In a system having three detectable components, such as an analyte and both short- and long-lifetime backgrounds, the contribution of each component to the total intensity can be determined using the intensity, phase, and modulation of the system, measured at two angular modulation frequencies (ω₁,ω₂). In this case, the fractional intensity of the analyte is

$$\begin{matrix}{f}_{a} = p ( {ω}_{1} ) - q ( {ω}_{1} ) \cdot \frac{p ( {ω}_{2} ) - p ( {ω}_{1} )}{q ( {ω}_{2} ) - q ( {ω}_{1} )} & ( 25 ) \\ p ( ω ) ≡ \frac{1 - {M}_{s , x}}{1 - {M}_{a , x}} + \frac{{M}_{a , x} - {M}_{s , x}}{{( 1 - {M}_{a , x} )}^{2}} \cdot {( {ωτ}_{b s} )}^{2} + … & ( 26 ) \\ q ( ω ) ≡ \frac{\frac{1}{{( {ωτ}_{b1} )}^{2}} - 1}{1 - {M}_{a , x}} + \frac{\frac{1}{{( {ωτ}_{b1} )}^{2}} - {M}_{a , x}}{{( 1 - {M}_{a , x} )}^{2}} \cdot {( {ωτ}_{b s} )}^{2} + … & ( 27 )\end{matrix}$$

Here ‘bs’ and ‘bi’ denote short- and long-lifetime background, respectively. As with the two-component models, we believe that the best mode is the modulation phasor approach with the X component. The reasons for this choice and the benefits are the same as described above. Additionally, the other approaches (such as the phase approach) still are valid and would appear to have the same benefits and limitations as described above. If the short- and/or long-lifetime background include multiple components, the average or effective lifetime of the short components and the average or effective lifetime of the long components should be used for τ_{bs}, and τ_{bl}, respectively. This embodiment of the invention may be termed lifetime-resolved fractional intensity.

D.3 Practical Considerations

The methods to reduce background luminescence outlined above have all determined the fractional intensity of the analyte. In most operations, the quantity of interest is not the analyte fractional intensity but the analyte intensity, which is the total intensity times the fractional intensity. We term the product of the total intensity and the fractional intensity given by Equations 20-24 (single-frequency, two-component) the lifetime discriminated intensity (LDI). We term the product of the intensity and the fractional intensity given by Equation 25 (dual frequency, three-component) the lifetime-resolved intensity (LRI).

FIG. 11 shows simulation results demonstrating the ability of the invention to discriminate between an analyte and a background. Results are shown for three zeroth-order embodiments of the invention, as described in Equations 21 (LDI, Mₓ-based), 23 (LDI, φ-based), and 25 (LRI). The error is determined by the choice of frequency and analyte lifetime. When the lifetimes of the analyte and background differ by more than a factor of ten for the equations based on the X components of the modulation, the error is low enough (<2%) for HTS applications.

The choice of frequency also is important for small systematic errors. In the lifetime-discriminated case (Equation 21), the frequency must be chosen so that the measured quantity (M_{s,x}) is useable. The errors in M_{s,x} must not translate into a large uncertainty in the derived fractional intensity. If the fraction of analyte is large, any frequency appropriate for measuring the analyte will suffice. For example, if the analyte has a lifetime of 100 nanoseconds, any frequency in the range of 300 kHz to 8 MHz is appropriate (from ⅕ to 5× the inverse lifetime).

If the fraction of analyte is low, however, the frequency selection is constrained by the fact that M_{s,x} is dominated by the short lifetime background. Its value will be too close to the upper limit (1.000) if the frequency is too small. A normal value for the error in M would be 0.005. With this size error, it is not reasonable to make a precise measurement of M when its value is greater than 0.980. This upper limit will make low frequencies unusable. For a ruthenium-complex analyte having a lifetime of 360 nanoseconds and a background having a lifetime of <5 nanoseconds, a reasonable frequency is 2-3 MHz.

In the lifetime-resolved case (Equation 26), the choice of frequencies is more difficult. Roughly, one frequency is needed to discriminate between the long and intermediate lifetimes, and one frequency is needed to discriminate between the intermediate and short lifetimes. Each frequency may be chosen as for a two-component system. However. using an optimization program to choose the frequencies may be more reliable and robust. The program optimizes the frequencies to minimize systematic error due to finite lifetimes of the short and long components, while also minimizing the error due to changes in analyte lifetime.

D.4 Experimental Verification

The luminescence intensity due to the analyte can be found by multiplying the total intensity by the calculated fractional intensity, using Equations 20 (LDI), 22 (LDI), or Equation 23 (LRI), among others. Total intensity is obtained from the steady-state value of the luminescence emission, without performing a separate experiment. To test these concepts, we built a phase and modulation fluorometer capable of measuring samples in a microplate, as described above. The instrument uses epi-luminescence geometry. an intensity-modulated blue LED, and a gain-modulated PMT.

Experiments were conducted to assess the ability of the apparatus and methods to discriminate between analyte and background. The analyte was [Ru(bpy)₃]C1₂ (ruthenium tris-2,2′-bipyridyl chloride), which has a long lifetime in buffer (measured at 330 nanoseconds at a temperature of 26-28° C. in 20 millimolar PBS, pH 7.4). The background was from the sample container and/or added R-phycoerythrin. R-phycoerythrin was used as an intentional background contaminant because its excitation and emission spectra overlap those of Ru(bpy)₃ and because it has a short lifetime in buffer (measured at 2.9 nanoseconds in 20 millimolar PBS, pH 7.4). All samples were prepared with 20 mM PBS, pH 7.4, and all data were collected with a 400 millosecond integration time in COSTAR-brand flat-black 96-well microplates.

Ruthenium is a good long-lifetime probe for several reasons. First, ruthenium has a long lifetime. Second, ruthenium's lifetime is not extremely sensitive to oxygen concentration, even though ruthenium sometimes is used as ail oxygen sensor. This is because ruthenium's lifetime is short relative to good oxygen sensors. In particular ruthenium's lifetime is not particularly sensitive to normal changes in oxygen content in air-equilibrated buffer, so that no special measures must be taken to remove oxygen from the system. Third, ruthenium is an atomic luminophore, so that it is not subject to the common problem of photobleaching. Finally, the ruthenium complex has a convenient excitation spectrum (460 nanometer peak) and a large (140 nanometer) Stokes' shift. (The Stokes' shift is the separation between maxima in excitation and emission spectra.)

Conventional background subtraction fails when the background concentration is too large due to fluctuations in background intensity and variations from sample to sample. A 1% variation between samples will make it impossible to measure an analyte whose intensity is only 1% of the background signal. To have confidence that a signal exists, a three standard-deviations rule may be used. The minimum resolvable signal is defined as a signal that is three standard deviations larger than the average background.

For a background-subtracted value, our confidence limit translates to a fractional error (or coefficient of variation, CV) of about 47%. (Both sample and background were assumed to have the same error with the difference three times the error; CV=\sqrt{3/2}.) Such a large CV is usable only for qualitative measurements. For quantitative measurements, a smaller CV is desired. Typical dispensing errors, concentration errors, and instrument drift can combine to give an error of several percent. Considering these other errors, it is practical to use data with a 10% CV for quantitative work, which may be considered the limit for precise data. These confidence and precision limits allow quantitatively comparison of data from background-subtracted intensity, lifetime-discriminated intensity, and lifetime-resolved intensity measurements.

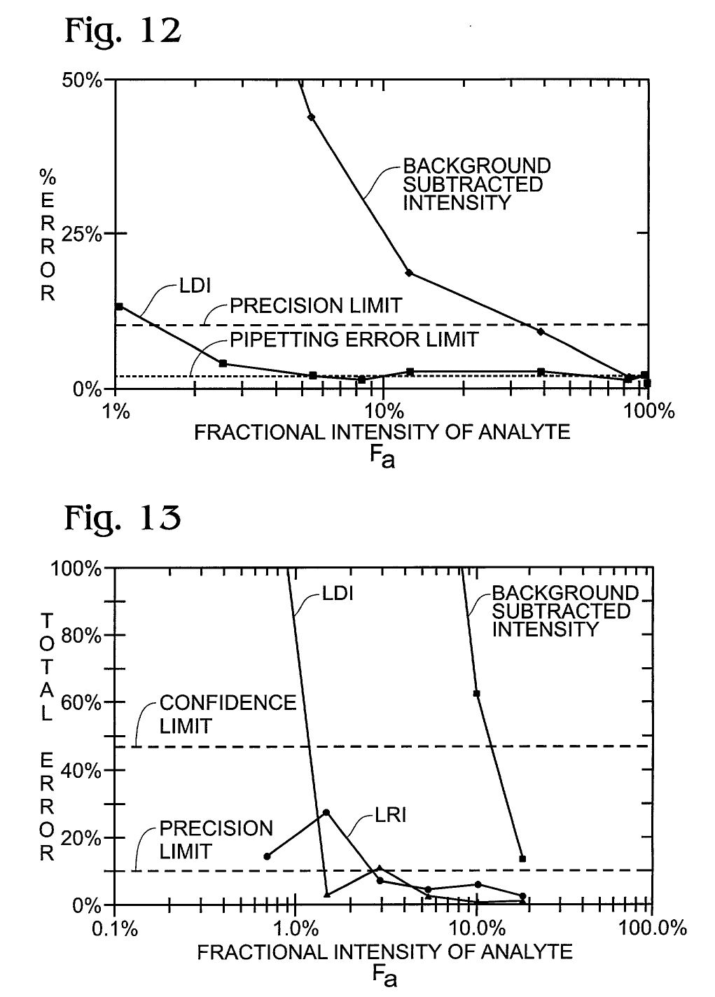

FIG. 12 shows experimental results demonstrating sensitivity to background. determined by adding increasing concentrations of R-phycoerythrin to a constant concentration of Ru(bpy)₃. The result was a series of solutions with increasing total intensity but constant analyte intensity. All solutions were prepared in duplicate, and errors in the average were compared with expected values. FIG. 12 shows three curves. LDI corresponds to Equation 21, evaluated at 2.85 MHz. LRI corresponds To Equation 26, evaluated at f₁=0.35 MHz and f₂=4.33 MHz. BSI corresponds to the background-subtracted intensity, computed using a blank. The ability of a method to discriminate analyte and background is given by the analyte fractional intensity at which measurement error exceeds the confidence limit. The background-subtraction method can discriminate between analyte and background only if the analyte fractional intensity exceeds 17%, whereas LDI and LRI can discriminate between analyte and background if the analyte fractional intensity exceeds 2% and <0.8%, respectively. Therefore, both methods are less than one-tenth as responsive to background luminescence as background subtraction. This reduced responsivity is achieved while reducing experimental complexity. Under the proper conditions, LDI and LRI do not require any measurement of the background luminescence, including its lifetime and intensity. The contribution of background to the measured intensity is removed simply because of its short lifetime.

FIG. 13 shows experimental results demonstrating sensitivity to analyte, determined by adding increasing concentrations of Ru(bpy)₃ to a constant (1 nanomolar) concentration of R-phycoerythrin. The result was a series of solutions with increasing total intensity but constant background intensity. This setup permits a determination of the minimum resolvable fraction of analyte in the presence of background. All solutions were prepared in duplicate, and errors in the average were compared with expected values. We measured the LDI was measured at 2.85 MHz, and LRI was measured at 0.35 and 2.85 MHz. The difference between methods is again substantial. Background subtraction quickly fails to resolve th, analyte (at a fractional intensity of 13% or 100 micromolar of ruthenium complex). LDI reports the correct analyte intensity down to a fractional intensity of 1% (10 μM), while LRI reports the correct intensity down to less than 0.7% (5 micromolar). This is a greater than tenfold increase in the sensitivity to the analyte for either method. These consistent results suggest that LDI and LRI measurements can be a significant improvement over conventional background subtraction.

The invention is robust, simple, and fast, making it ideal for high-throughput screening. LDI is able accurately to distinguish short- and long-lifetime components using phase and modulation at only a single frequency. LRI is able accurately to separate three lifetime components using phase and modulation at two frequencies. Extension to even more components also is possible. Knowledge of the lifetime of one component is used to determine the intensity of each component, without requiring a determination of the lifetime or intensity of the other component.

E. Polarization Assays

The apparatus and methods provided by the invention also can be used to discriminate between analyte and background in polarization assays. Generally, the invention permits determination of background-corrected polarizations for systems having one or more analytes and one or more background components.

Background-corrected steady-state polarizations (or anisotropies) may be determined using Equation 3 (or Equation 4), where I₈₁ and I_{⊥}may be determined using appropriate combinations of parallel and perpendicular excitation and emission polarizers, and the apparatus and methods described above for computing background-corrected intensities. Such corrections are important, because steady-state anisotropies are intensity-weighted averages of the anisotropies of all components present, so that background affects the measured anisotropies directly.

Background-corrected time-resolved polarizations (or anisotropies) may be determined using time-domain or frequency-domain techniques. In the time domain, background-corrected polarizations may be determined using Equation 3 (or Equation 4), where I_{∥}and I_{⊥}are replaced by I_{∥}(t) and I_{⊥}(t). In the frequency domain, background-corrected polarizations may be determined using appropriate combinations of parallel and perpendicular phase Up and parallel and perpendicular modulation Mₚ. Here ‘p’ denotes parallel or perpendicular, corresponding to parallel and perpendicular components. φₚ and Mₚ are determined using the same apparatus and methods as φ and M, with the addition of parallel and perpendicular polarizers, as appropriate. φₚ and Mₚ may be rewritten in terms of ω and τ(t).

φ_{pω}=tan⁻¹(N_{pω}/D_{pω}) (28)

M_{pω}=\sqrt{N²_{pω}+D²_{pω}}/Jₚ) (29)

$$\begin{matrix}{J}_{p} = {\int }_{0}^{∞} {I}_{p} ( t ) ⅆ t & ( 30 ) \\ {N}_{p ω} = {\int }_{0}^{∞} {I}_{p} ( t ) sin ( ω t ) ⅆ t & ( 31 ) \\ {D}_{p ω} = {\int }_{0}^{∞} {I}_{p} ( t ) cos ( ω t ) ⅆ t & ( 32 )\end{matrix}$$

Experimental results may be interpreted using a differential phase angle Δ_{ω} and a ratio Λ_{ω} of the parallel and perpendicular AC components of the polarized emission.

Δ_{ω}=φ_{⊥ω}−φ_{⊥ω} (33)

$${Λ}_{ω} = \frac{A {C}_{\vert \vert}}{A {C}_{⊥}} = \frac{\sqrt{{N}_{\vert \vert ω}^{2} + {D}_{\vert \vert ω}^{2}}}{\sqrt{{N}_{⊥ ω}^{2} + {D}_{⊥ ω}^{2}}} \qquad ( 34 )$$

Λ_{ω} may be used to define a frequency-dependent quantity r_{ω}, called the modulated anisotropy.

$${r}_{ω} = \frac{{Λ}_{ω} - 1}{{Λ}_{ω} + 2} \qquad ( 35 )$$

r_{ω} tends to the fundamental anisotropy rₒ at high frequency and to the steady-state anisotropy rₛₛ at low frequency.

Frequency-domain time-resolved polarization may be used to investigate the motional properties of biological molecules in more detail than steady-state polarization. For example, a biophysical model may be used to generate functional forms of I_{∥}(t) and I_{⊥}(t), using parameters such as lifetimes and rotational correlation times. This model can be used to predict Δ_{ω} and Λ_{ω}. Experiments then can be done to measure Δ_{ω} and Λ_{ω}, at one or more modulation frequencies. Experimental results may be fitted to the model by adjusting the parameters to give the best fit between predicted and observed values of Δ_{ω} and Λ_{ω} or r_{ω}, for example, by using nonlinear least-squares optimization algorithms.

Alternatively, a simpler approach may be used, in which experiments are conducted at one or a few modulation frequencies, and experimental results are interpreted without resort to fitting to detailed models. Such an approach may be sufficient quickly to assay for significant changes in molecular mobility, for example, as occurs upon binding. Such binding may be to a target molecule as part of an assay, or to walls of the sample container, among others.

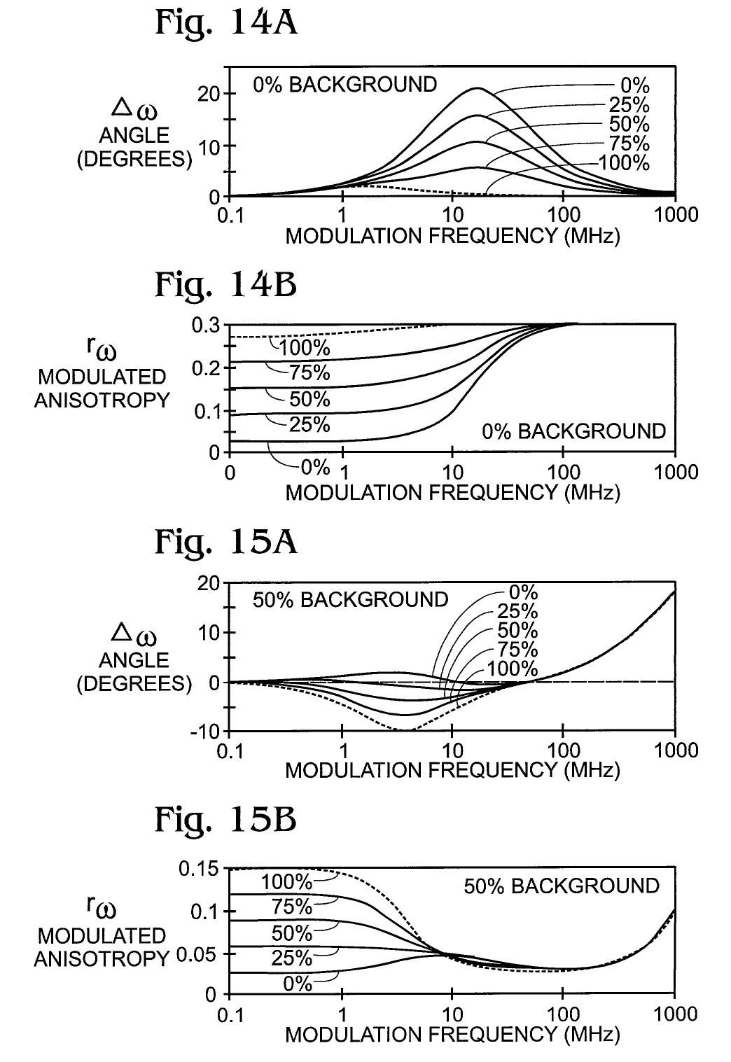

FIG. 14 shows how Δ_{ω} , (Panel A) and r_{ω} (Panel B) depend on ω for a simple binding system in the absence of background. Here, the labeled molecule has a fundamental anisotropy rₒ=0.3, a luminescence lifetime τ=100 nanoseconds, and a rotational correlation time τᵣₒₜ=10 nanoseconds in the free state and 1000 nanoseconds in the bound state. FIG. 14 shows results for 0%, 25%, 50%, 75%, and 100% binding. The extent of binding of the labeled molecule can be determined quickly and sensitively by measuring Δ_{ω} and r_{ω} at a single suitable frequency (e.g., ˜20 MHz for Δ_{ω} and <˜0 MHz for r_{ω}), and then reading off the extent of binding from an empirical calibration curve. Alternatively, binding could be determined using LDI and LRI, among others, if the binding is associated with a change in analyte lifetime.

FIG. 15 shores how Δ_{ω} (Panel A) and r_{ω} (Panel B) depend on ω for a simple binding system in the presence of 50% background. Here, the background has a fundamental anisotropy rₒ =0.3 a luminescence lifetime τ=1 nanosecond, and a rotational correlation time timer τᵣₒₜ=0.1 nanosecond. These conditions correspond to compositions having a long-lifetime analyte and a short-lifetime background; the effective luminescence lifetime of the background usually is short, probably 0.1 to 10 nanoseconds. Unfortunately, a comparison of FIGS. 14 and 15 shows that there are no frequencies at which either Δ_{ω} or r_{ω} is unaffected by the background. This greatly diminishes the utility of Δ_{ω} or r_{ω}, especially because background varies from sample to sample, and so generally cannot be included in a calibration curve.

These shortcomings are addressed by the invention, which provides alternative functions that better discriminate between analyte and background, without requiring information from a blank and without requiring a determination of the lifetime or intensity of the background. Two such functions, denoted “psi” and “kappa” functions, are described below.

E.1 Psi Function

The psi function, or Ψ_{ω}, is a ratio of the parallel and perpendicular AC intensities, weighted by the sines of the parallel and perpendicular phases, respectively.

$${Ψ}_{ω} = \frac{A {C}_{\vert \vert} sin ( {φ}_{\vert \vert ω} )}{A {C}_{⊥} sin ( {φ}_{⊥ ω} )} \qquad ( 36 )$$

Ψ_{ω} may be shown to be a ratio of the sine Fourier transforms N_{pω} of the intensity decays in associated parallel and perpendicular measurements. To see this, simple trigonometry and the relationship φ_{pω}=tan⁻¹ (N_{pω}/D_{pω}) gives

$$sin ( {φ}_{p ω} ) = \frac{{N}_{p ω}}{\sqrt{{N}_{p ω}^{2} + {D}_{p ω}^{2}}} \qquad ( 37 )$$

Then, using Equation 37 defining Λ_{ω} gives

$${Ψ}_{ω} = \frac{A {C}_{\vert \vert} sin ( {φ}_{\vert \vert ω} )}{A {C}_{⊥} sin ( {φ}_{⊥ ω} )} = \frac{\sqrt{{N}_{\vert \vert ω}^{2} + {D}_{\vert \vert ω}^{2}}}{\sqrt{{N}_{⊥ ω}^{2} + {D}_{⊥ ω}^{2}}} \frac{sin ( {φ}_{\vert \vert ω} )}{sin ( {φ}_{⊥ ω} )} = \frac{{N}_{\vert \vert ω}}{{N}_{⊥ ω}} \qquad ( 38 )$$

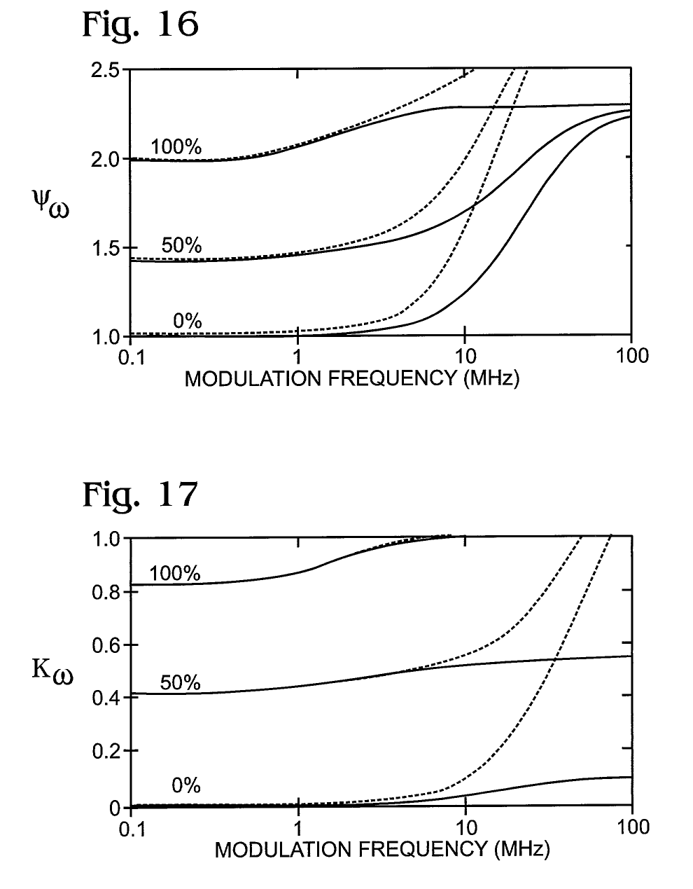

FIG. 16 shows how Ψ_{ω} depends on ω for the system of FIG. 14 and 15, in the presence of 0% (Panel A) and 50% (Panel B) background. Generally, the lower the frequency, the less Ψ_{ω} is affected by the (short-lifetime) background. In particular, below ω˜10 MHz, Ψ_{ω} is much less affected by background than Δ_{ω} , and r_{ω}. However, as d becomes small, θₚ also becomes small, and measurement of the sine becomes imprecise. The optimum modulation frequency will be determined by a balance of these factors, among others.

The behavior of Ψ_{ω} for short-lived signals can be understood as follows. Assume that there are n molecular components, each with a single luminescence lifetime τᵢ and a single rotational correlation tinge τᵢ. The fraction of the steady-state luminescence intensity (no polarizers) contributed by each component is given by Equation 8. In the time domain, the anisotropy of each component is given by

rᵢ(t)≦rₒᵢe^{-/θ}^{₁} (39)

Then by the standard relationships

$${I}_{\vert \vert} ( t ) = \frac{1}{3} I ( t ) ( 1 + 2 {r}_{i} ( t ) ) ; {I}_{⊥} ( t ) = \frac{1}{3} I ( t ) ( 1 - {r}_{i} ( t ) ) \qquad ( 40 )$$

Taking the sine Fourier transform gives

$$\begin{matrix}{N}_{\vert \vert ω} = \frac{1}{3} \{ {\sum }_{i} {a}_{i} {τ}_{i} [ L ( {ωτ}_{i} ) + 2 {r}_{o i} \frac{{σ}_{i}}{{τ}_{i}} L ( {ωσ}_{i} ) ] \} & ( 41 ) \\ {N}_{⊥ ω} = \frac{1}{3} \{ {\sum }_{i} {a}_{i} {τ}_{i} [ L ( {ωτ}_{i} ) - {r}_{o i} \frac{{σ}_{i}}{{τ}_{i}} L ( {ωσ}_{i} ) ] \} & ( 42 )\end{matrix}$$

Here, L(x)=x/(1+x²). For |x|<<1, L(x)˜x and L(0)=0. L(x) reaches a maximum value of

$$\frac{1}{2}$$

at x=1. For |x|>>1, L(x)˜1/x, and L(∞)=0. The rotational correlation time enters the system only through

$${σ}_{i} = \frac{{τ}_{i} {θ}_{i}}{{τ}_{i} + {θ}_{i}} \qquad ( 43 )$$

Because t,0701

min(τᵢ,θᵢ)≦σᵢ<min(τᵢ,θᵢ), σ always is smaller than either τ or σ. The ratio σᵢ/τᵢ=θᵢ/(τᵢ+θᵢ )<1. Ψ_{ω} can be formed by taking a ratios of the N's and recalling that

$${α}_{i} {τ}_{i} = {f}_{i} {\sum }_{j} {α}_{j} {τ}_{j} .$$

$${Ψ}_{ω} = \frac{{N}_{\vert \vert ω}}{{N}_{⊥ ω}} = \frac{{\sum }_{i} {f}_{i} [ L ( {ωτ}_{i} ) + 2 {r}_{o i} \frac{{σ}_{i}}{{τ}_{i}} L ( {ωσ}_{i} ) ]}{{\sum }_{i} {f}_{i} [ L ( {ωτ}_{i} ) - {r}_{o i} \frac{{σ}_{i}}{{τ}_{i}} L ( {ωσ}_{i} ) ]} \qquad ( 44 )$$

Here, the normalizing sum canceled out of all the terms.

Based on the behavior of L(x) for small x, Ψ_{ω} gives small weight to signals from short-lived species (ωτᵢ or ωσᵢ<<1), in comparison to signals for which or ωσᵢ˜1. Ψ_{ω} also gives small weight to the anisotropy contributions of long-lived components that have extremely short rotational correlation times (i.e., ωσᵢ<<1, σᵢ/τᵢ<<1).

E.2 Kappa Function

The kappa function, or κ_{ω}, is a ratio involving the parallel and perpendicular AC intensities, weighted in part by the cosines of the parallel and perpendicular phases, respectively.

$${K}_{ω} = \frac{{I}_{‖} - A {C}_{‖} cos {φ}_{‖ ω} - ( {I}_{⊥} - A {C}_{⊥} cos {φ}_{⊥ ω} )}{{I}_{‖} - A {C}_{‖} cos {φ}_{‖ ω} + 2 ( {I}_{⊥} + A {C}_{⊥} cos {φ}_{⊥ ω} )} \qquad ( 45 )$$

κ_{ω} may be shown to be a ratio involving lifetime-discriminated intensities, as defined above, in associated parallel and perpendicular measurements.

$${K}_{ω} = \frac{L D {I}_{‖} - L D {I}_{⊥}}{L D {I}_{‖} + 2 L D {I}_{⊥}} \qquad ( 46 )$$

Equation 46 is analogous to anisotropy, as may be seen by comparing Equation 46 for κ_{ω} with Equation 4 for r.

FIG. 17 shows how κ_{ω} depends on ω for the system of FIGS. 14 and 15, in the presence of 0% (solid lines) and 90% (dashed lines) background. Results for κ_{ω} are similar to results for Δ_{ω} except that κ_{ω} may be less sensitive than Ψ_{ω} to frequency for low frequencies, and to binding for high binding. Neither the kappa nor the psi function depends on properties of the background, so neither function requires use of a blank or a determination of the lifetime or intensity of the background.

F. Additional Methods

The invention provides additional methods for discriminating between analyte and background in intensity (and thus indirectly in polarization) assays. Generally, these methods permit determination of background-corrected intensities for systems having one or more analytes and one or more background components. The remainder of this section is divided into three sections, which describe different methods provided by the invention: (A) “exact” algorithms for analyzing FLARe™ data, (B) correction of lifetime measurements for short-lived background, and (C) third-order FLDI (fluorescence lifetime discriminated intensity) algorithm for analyzing FLARe™ data. These different methods are described in additional and/or alternative forms in the following patent applications: U.S. Provisional Patent Application Serial No. 60/l167,463, filed Nov. 24, 1999; U.S. Provisional Patent Application Serial No. 60/182,419, filed Feb. 14, 2000; and U.S. patent application Ser. No. 09/722,247, filed Nov. 24, 2000. These applications are incorporated herein by reference in their entirety for all purposes.

F.1 “Exact” Algorithms for Analyzing, FLARe™ Data

A sample in a fluorometric assay may contain multiple fluorescent components. Some are present intentionally. and the characteristics of their emissions form the basis of the assay. Others constitute background and interfere with the interpretation of the assay. Sources of background include the optical components of the detection instrument, contaminants in the sample container, and various components of the assay solution. Where the background is the same in every sample being assayed (e.g., a predictable emission from the sample container), a separate measurement coupled with background subtraction car sometimes improve performance. However, a particular problem occurs during high-throughput screening for new pharmaceuticals, where the library compound being assayed is fluorescent. Background subtraction would necessitate doubling the number of assays performed (true measurement and background measurement for each compound), and background subtraction is in any event of limited utility.

Here we describe how arbitrarily accurate solutions to realistic models for the time-dependent fluorescence of mixtures of fluorophores can significantly reduce the effects of background without requiring the preparation of additional samples containing library compounds for background analysis.

We retain the fairly standard nomenclature that we have used in previous patent applications involving FD measurements of the type discussed here:

ν modulation frequency in Hz

ω modulation frequency in radians/s, =πν

τ lifetime in ns or s

θ phase angle (equivalent to φ above)

M Modulation

n number of spectroscopically distinct types of fluorophores in the sample

fᵢ fraction of the steady-state fluorescence contributed by the i^{th} fluorophore

For an FD measurement, we define the quantities:

N=f₁ωτ₁/[1+(ωτ₁)²]+f₂ωτ₂/[1+(ωτ₂)²]+. . . fₙωτₙ/[2+(ωτₙ)²] (47 )

D=f₁/[1+(ωτ₁)²]+f₂/[1+(ωτ₂)²]+. . . fₙ/[1+(ωτₙ)²] (48)

Then is can be shown (see J. Lakowicz. Principles of Fluorescence Spectroscopy, 2^{nd} Ed., 1999) that the observed phase and modulation are:

θ=arctan(N/D) (49)

M=(N²+D²)^{½} (50)

Estimates of the intensity and lifetime parameters can be extracted from phase and modulation measurements by, e.g., nonlinear least-squares fitting of predicted to observed data.

For this to work, the number of unknowns must in general not exceed the number of independent data points. There are at most 2n−1 unknowns (fractional intensities and lifetimes, reduced by one because the fractions must sum to unity). If reference measurements have already determined the values of parameters for individual components or subsets of components, this number can be reduced. The number of independent data points can be increased by making measurements at multiple modulation frequencies. For example, using two modulation frequencies generates four data points (θ and M each at two values of ω).

In general, these solutions are numerical rather than analytical, and generating them may be time consuming computationally. Simplifications can result from the fact that it is not necessary to determine the parameters for background components, only to correct for the effects of background on the signal of interest. Various approximations in the equations can also simplify the computational task.

F.2 Correction of Lifetime Measurements for Short-Lived Background

A single FD measurement with angular modulation frequency ω gives, in addition to FLINT, modulation M and phase θ that can be used (starting from Equations 1 and 2) to calculate a mean lifetime τ for the sample:

τ=tan(θ)/ω (51)

τ=[(1/M²−1)/ω]^{½} (52)

If the fluorescence signal is produced by a single fluorophore exhibiting a single-exponential decay, these two equations yield the same value of the lifetime, the time constant for the decay.

When the fluorescence signal is more complicated, the two equations typically give different values of τ. Relating the measurement to the underlying molecular processes is more complicated and in general requires measurements at multiple wavelengths or modulation frequencies that are interpreted by fitting to some model. For example, when there are two fluorophores with distinct lifetimes, the measured values of phase and modulation are weighted averages of the phase and modulation results that would be obtained in experiments on the separate components. Moreover, the weighting is different for phase and modulation. Two separate FD measurements at appropriately chosen modulation frequencies are required to resolve the lifetimes and relative. contributions to the FLINT of the two components.

The need to make multiple measurements on a sample slows the analytical process and is a disadvantage in applications, such as high-throughput screening, where it is important to minimize the assay time. Under some conditions, however, it is possible to resolve some of the molecular information from a complex sample with a single measurement.

For example. as shown above, it is possible to resolve the FLINT contributed by a long-lived label of interest in the presence of short-lived fluorescence background in a single FD measurement. This case has practical utility, because most fluorophores that contribute to contaminating background fluorescence in drug-discovery applications have lifetimes that are shorter than those of some of the available labels (especially metal-ligand complexes involving transition metals such as Ru, Os, and Re without limitation).

Here we report that under similar conditions, i.e., a label with a lifetime that is significantly longer than the lifetimes of all other contaminating signals, it is possible resolve the lifetime of that label in a single FD measurement, relatively free of interference from short-lived contaminants. This is contrasted with our previous work, which showed only that the FLINT of the label could be resolved from interference due to short-lived background.

The lifetime-measurement method that we describe here, which we call Fluorescence Lifetime Discriminated Lifetime (FLDL), is an approximation that works best when the ratio of background to label lifetimes is small and the ratio of background to label FLINT is small. However, when the lifetimes are well separated it is possible to resolve the label lifetime to a good approximation even when the FLINT from the background is significantly greater than that of the label.

Following is the theoretical development of the method.

Signals from an analyte A and background B combine to give the signal from the total system S. The lifetime of the analyte is τ_{A}, and that of the background τ_{B}. We assume that τ_{B}<τ_{A}, preferably τ_{B}<<τ_{A}, We treat the background as a single component without significant loss of generality as long as the assumptions about lifetimes apply to all the background components (in which case the representation is of an averaged background).

Further definitions are: the fraction of the FLINT from the analyte is f_{A}. We define the quantities Xᵢ=Mᵢ cos(θᵢ) and Yᵢ=Mᵢ sin(θᵢ), where i can equal A, B, or S. The values of M_{A}, θ_{A}, M_{B}, and θ_{B} are those that would obtain if the A and B components were present separately.

From above, we know that under the restrictions on relative lifetimes imposed above the following two expressions hold to a good approximation:

f_{A}=(1−Xₛ)/(1−X_{A}) (53)

and

tan(θ_{A})=Y_{S}/(Xₛ−1+f_{A}) (54)

Substituting Equation 53 into Equation 54 gives

tan(θ_{A})=[Y_{S}/(1−X_{S})][(1−X_{A})/X_{A}] (55)

Now from elementary trigonometry and Equation 5 we have

cos(θ_{A})=(¹+(ωτ_{A})²)^{-½} (56)

and

M_{A}=(1(ωτ_{A})²)^{-½} (57)

so that

X_{A}=(1+(ωτ_{A})²)⁻¹ (58)

and

1−X_{A}=(ωτ_{A})²/(1+(ωτ_{A})²) (59)

Substituting Equation 51 for component A along with Equations 58 and 59 into Equation 55 and rearranging to solve for τ_{A}, we finally have

τ_{A}=(1−X_{S})/Y_{S}=(1−M_{S} cos(θ_{S}))/(M_{S} sin(θ_{S})) (60)

In other words, we have an expression for the label lifetime τ_{A} purely in terms of quantities that can be obtained in a single FD measurement on the system that contains both analyte and background.

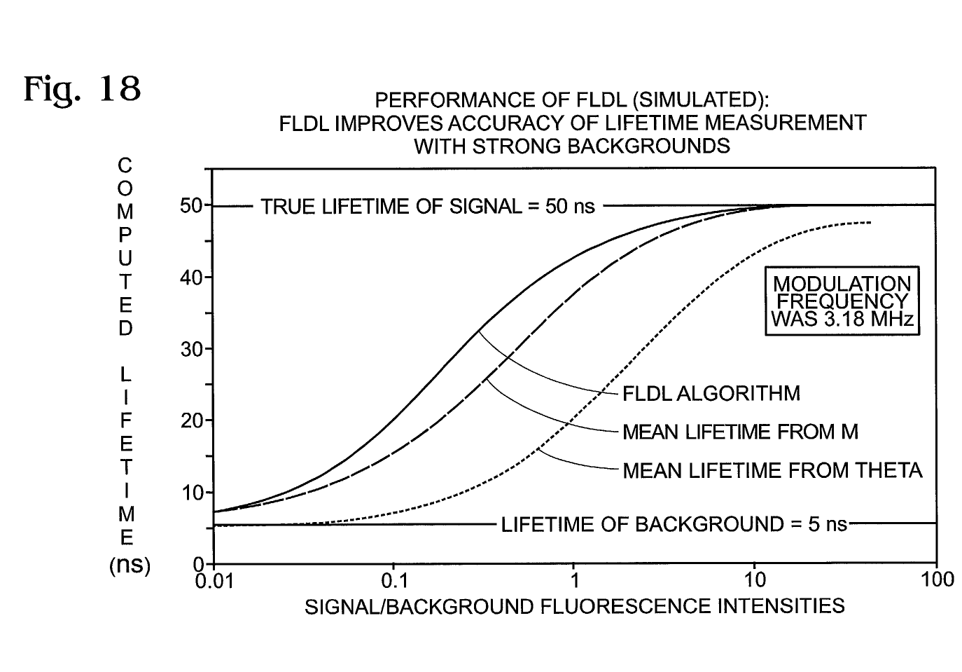

FIG. 18 shows the performance that can be expected of the algorithm, obtained using a simulation of FD experiments on a two-component system containing analyte (fluorescent label) and a fluorescent background in varying proportions. The FLDL, algorithm demonstrates its superiority to the application of Equations 51 or 52 in that the lifetime of the analyte calculated with FLDL is much closer to the true value than the lifetime calculated with Equation 1 or 2 when there is appreciable background fluorescence.

F.3 Third-order FLDL (Fluorescence Lifetime Discriminated Intensity) Algorithm for Analyzing, FLARe™ Data

The goal of this work is to derive methods to improve the accuracy of fluorescence intensity and fluorescence-lifetime measurements of compounds of interest (called analytes, or, equivalently, labels) in the presence of unwanted background fluorescence. Among the fields in which these methods can be applied is drug discovery, particularly in high-throughput screening assays.

Our previous FLDL methods were based on measuring fluorescent systems, containing fluorescence both from analyte, A and background, B. An expression for the fraction f_{A} of the fluorescence intensity contributed by A was obtained as a series expansion in ωτ_{B}, where this product was <1. This expansion contained only even powers of the product. Truncating before the second-order term thus gave an expression that was good to first order in ωτ_{B}. A benefit of this method is that there is no need to determine the value ofτ_{B}.

The present invention truncates the expansion before the fourth-order term and thus is good to third order in ωτ_{B}. This improves the ability of the method to determine analyte intensity in the presence of background fluorescence. In contrast to previous work, however, τ_{B} now appears in the formulas and must be measured explicitly or implicitly.

This can be done by making measurements at two modulation frequencies, ω₁ and ω₂. The series expansion can then be used to generate two equations (on for each frequency) in two unknowns (f_{A} and τ_{B}). Elimination of the lifetime yields an equation for f_{A}.

Here are the details. The earlier series expansion can be written in the form:

f_{A} α((ω)+β(ω)τ_{B}² (61)

Here α(ω)) and β(ω) are the following expressions, where dependence on ω is written explicitly:

α(ω)=[1−X_{S}(ω)]/[1−X_{A}(ω)] (62)

β(ω)=ω²[X_{A}(ω)−X_{S}(ω)]/[1−X_{A}(107)]² (63)

Eliminating τ_{B}² yields the expression:

f_{A}=[α(ω₁)β((ω₂)−α(ω₂)β(ω₁)]/[β(ω₂)−β(ω₁)] (64)

This form of the equation requires measurement of the analyte fluorescence in the absence of background, which is generally not difficult and, moreover, can be done once and stored for reference and inclusion in the analysis of many samples.

Despite being based on a truncated power series in τ_{B}², this result gives accuracy comparable to that obtained with much more complicated expressions derived from exact equations for the behavior of two-component systems.

G. Reference Compounds

The apparatus, methods, and compositions of matter provided by the invention also can be used to correct for modifications in analyte signal from scattering, absorption, and other modulators, including background, through use of a reference compound. These modifications may affect intensity and polarization, among others.

The compositions of matter provided by the invention may include first and second luminophores having emission spectra that overlap significantly, but luminescence emissions that may be resolved using lifetime-resolved methods. The first and second luminophores may include an analyte and a reference compound. The analyte may be designed to participate in an assay, and the reference compound may be designed to participate in an assay, and the reference compound may be designed to be inert and constant from assay to assay.

The apparatus provided by the invention may include a stage, light source, detector, processor, and first and second optical relay structures. These components are substantially as described above, especially in supporting and inducing an emission from a composition, and in detecting and converting the emission to a signal. The emission may include fluorescence or phosphorescence.

The processor may use information in the signal to determine the intensity of the light emitted by the analyte and the intensity of the light emitted by the reference compound. The analyte and reference compound have luminescence lifetimes that are resolvable by lifetime-resolved methods, so that the intensities of the analyte and reference compound may be determined using lifetime-resolved methods. These methods may include frequency-domain methods, such as those described above for distinguishing analyte and background.

In the presence of a signal modulator, such as scattering or absorption, the apparent intensity I_{c}′ of light detected, from a composition will equal the product of a transmission factor T and the true intensity I_{c} of the light emitted from the composition.

I_{c}′=T·I_{c} (65)

The transmission factor may include contributions from changes in the excitation light and changes in the emission light. The transmission factor typically (but not always) will range from zero to one.

If the composition contains both an analyte and a reference compound, the apparent intensity of the composition will equal the product of the transmission factor and the sum of the true intensity I_{A} of the analyte and the true intensity IR of the reference compound.

I_{c}′=T·(Iₐ+fᵣ) (66)

The apparent intensity Iₐ′ of the analyte will equal the apparent intensity of the composition minus the apparent intensity of the reference compound. Similarly, the apparent intensity Iᵣ′ of the reference compound will equal the apparent intensity of the composition minus the apparent intensity of the analyte.

These intensities may be computed using LDI or LRI methods, among others. For example, a typical experiment may include a short-lifetime analyte and a long-lifetime reference compound, although other combinations also may be used. In this case, the apparent intensity of the analyte may be calculated using Equation 22, where the reference compound effectively is treated as long-lifetime background.

$${I}_{a}^{′} = T \cdot {I}_{a} = T \cdot ( {I}_{c} - {I}_{r} ) = {I}_{c}^{′} \cdot ( 1 - \frac{1 - {X}_{c}}{1 - {X}_{r}} ) \qquad ( 67 )$$

Similarly, the apparent intensity of the reference compound may be calculated using Equation 21, where the analyte effectively is treated as short-lifetime background.

$${I}_{r}^{′} = T \cdot {I}_{r} = T \cdot ( {I}_{c} - {I}_{a} ) = {I}_{c}^{′} \cdot \frac{1 - {X}_{c}}{1 - {X}_{r}} \qquad ( 68 )$$

The processor also uses information in the signal to calculate a quantity that. expresses the intensity of the analyte as a function of the intensity of the reference compound. This quantity may be a ratio of the intensity of the analyte to the intensity of the reference compound, among others.

$$\frac{{I}_{a}}{{I}_{r}} = \frac{{I}_{a}^{′}}{{I}_{r}^{′}} = \frac{{X}_{c} - {X}_{r}}{1 - {X}_{c}} \qquad ( 69 )$$

Such a ratio is independent of the degree of modulation in the sample, and thus will be comparable for every sample in a family of samples, if for example every sample has the same concentration of reference compound.

The processor also is capable or discriminating between the light emitted by the analyte, the light emitted by a reference compound, and a background, if all three have different lifetimes, using the dual-frequency lifetime-resolved methods described above (e.g., Equation 26).

The methods provided by the invention may include various steps, including (1) providing a composition that includes the analyte and a reference compound, (2) illuminating the composition, so that light is emitted by the analyte and reference compound, (3) detecting the light emitted by the analyte and reference compound and converting it to a signal, (4) processing the signal to determine the intensity of the light emitted by the analyte and the intensity of the light emitted by the reference compound, and (5) calculating a quantity that expresses the intensity of the analyte as a function of the intensity of the light emitted by the reference compound. The methods also may include additional or alternative steps. The methods may be practiced using the apparatus described above.

The invention may handle a variety of analytes, reference compounds, and backgrounds. Generally, the excitation and emission spectra of the reference compound should be the same as the excitation and emission spectra of the analyte, so that the intensity of the reference compound will be modulated by the same amount as the intensity of the analyte. (Because the factors that modulate detection of luminescence are generally wavelength dependent, reference compounds having different spectra than the analyte provide only a partial solution, at best.) For optimal resolution, the lifetime of the reference compound should be significantly larger or significantly smaller than the lifetime of the analyte, and the lifetimes of the reference compound and analyte should be greater than the lifetime of the background. Also for optimal resolution, the specific lifetime of the background should be confined to a range. These conditions apply for most assays of commercial interest; for example, in most high-throughput assays, the background from the microplate and assay components is under 10 nanoseconds. These are preferred conditions; because the lifetime-resolved methods described above are so sensitive, the composition actually need include only a small amount of the reference compound (roughly 2% of the total intensity), and the lifetimes of analyte, reference compound, and background can be reasonably similar.

The reference compound may be associated with the composition using a variety of mechanisms. The reference compound may be associated with the composition directly, for example, by dissolving or suspending (e.g., as a micelle) the reference compound in the composition. The reference compound also may be associated with the composition indirectly, for example, by incorporating the reference compound into or onto beads, other carriers, or sample containers associated with the composition.

Associating the reference compound with beads or other carriers has a number of advantages. The carriers may be suspended in the composition or allowed to sink to the bottom of the sample container holding the composition. The carriers also may be attached to the walls or bottom of the sample container, for example, by chemical linkages such as biotin-streptavadin. The carriers also may be rendered magnetic, so that they may be pulled to one part of the sample container (e.g., a side or bottom) to permit the composition to be analyzed with and without the reference compound.

Associating the reference compound with the sample container also has a number of advantages. The reference compound may be layered onto the surface of the sample container, or formed into the plastic or other material used to form the sample container. Such approaches eliminate the need to add the reference compound to the composition, and they may prevent the reference compound from interacting with components of the composition and affecting the associated assay.

H. Examples

Additional and/or alternative aspects of the invention are described without limitation in the following numbered paragraphs:

1. An apparatus for detecting light emitted by an analyte in a composition, the apparatus comprising (A) a stage for supporting the composition; (B) a light source and a first optical relay structure that directs light from the light source toward the composition, so that the analyte may be induced to emit light; (C) a detector and a second optical relay structure that directs light from the composition toward the detector, so that light transmitted from the composition may be detected and converted to a signal; and (D) a processor that uses information in the signal to discriminate between a first portion of the signal that is attributable to the light emitted by the analyte and a second portion of the signal that is attributable to light from a non-analyte emitter, without requiring a determination of the lifetime or intensity of the light from the non-analyte emitter.

2. The apparatus of paragraph 1, where at least a portion of the non-analyte emitter comprises background which causes light that is not attributable to the analyte to be detected by the detector.

3. The apparatus of paragraph 1, where at least a portion of the non-analyte emitter comprises a reference compound, and where the processor calculates a quantity that expresses the intensity of the analyte as a function of the intensity of the reference compound.

4. The apparatus of paragraph 3, where the processor also may discriminate between a third portion of the signal that is attributable to a second non-analyte emitter comprising background.

5. The apparatus of paragraph 3, where the intensity of the reference compound is indicative of light absorption or-scattering effects.

6. An apparatus for detecting light emitted by an analyte in a composition, the apparatus comprising (A) a stage for supporting the composition, (B) a light source and a first optical relay structure that directs light from the light source toward the composition, so that the analyte may be induced to emit light; (C) a detector and a second optical relay structure that directs light from the composition toward the detector, so that light transmitted from the composition may be detected and converted to a signal: and (D) a processor that uses information in the signal to discriminate between a first portion of the signal that is attributable to the light emitted by the analyte and a second portion of the signal that is attributable to a background, without requiring a determination of the lifetime or intensity of the background.

7. The apparatus of paragraph 6, where the processor discriminates between the first and second portions of the signal without requiring use of information obtained from a blank.

8. The apparatus of paragraph 6, where the processor discriminates between the first and second portions of the signal irrespective of whether a significant amount of the background is being detected by the detector at the same time that light emitted by the analyte is being detected.

9. The apparatus of paragraph 6, where the processor discriminates between the first and second portions of the signal to calculate the luminescence lifetime of the analyte.

10. The apparatus of paragraph 6, where the processor discriminates between the first and second portions of the signal to calculate the intensity of the light emitted by the analyte.

11. The apparatus of paragraph 6, the first optical relay structure including an excitation polarizer, the second optical relay structure including an emission polarizer. where the processor discriminates between the first and second portions of the signal to calculate the polarization of the light emitted by the analyte.

12. The apparatus of paragraph 11, the analyte including two populations distinguishable by rotational mobility, where the processor uses the polarization of the light emitted by the analyte to discriminate between a plurality of signal components, each signal component due to emission of light from a different population of analyte.

13. The apparatus of paragraph 6, where the processor uses information in the signal to discriminate in the frequency-domain between the first and second portions of the signal.

14. The apparatus of paragraph 13, where the information in the signal is frequency-domain information.

15. The apparatus of paragraph 13, where the information in the signal is time-domain information, and where the processor transforms the time-domain information into frequency-domain information.

16. The apparatus of paragraph 13, where the processor discriminates between the first and second portions of the signal using phase, modulation, or phase and modulation information.

17. The apparatus of paragraph 6, where the wavelength of the light emitted by the analyte is in the range 200-1000 nanometers.

18. The apparatus of paragraph 6, where the light emitted by the analyte includes at least one of fluorescence arid phosphorescence.

19. The apparatus of paragraph 6, the analyte being a first analyte, where the background includes a second analyte.

20. The apparatus of paragraph 6, the composition including a reference compound, where both the analyte and the reference compound may be induced to emit light by the light source, and where the processor may use the signal to calculate a quantity that expresses the intensity of the analyte as a function of the intensity of the reference compound.

21. An apparatus for detecting light emitted by an analyte in a composition., the apparatus comprising (A) a stage for supporting the composition; (B) a light source and a first optical relay structure that directs light from the light source toward the composition, so that the analyte may be induced to emit light; (C) a detector and a second optical relay structure that directs light from the composition toward the detector, so that light transmitted from the composition may be detected and converted to a signal; and (D) a processor that uses information in the signal to discriminate between a first portion of the signal that is attributable to the light emitted by the analyte and a second portion of the signal that is attributable to a background without requiring use of information obtained from a blank, irrespective of whether a significant amount of the background is being detected by the detector at the same time that light emitted by the analyte is being detected.

22. The apparatus of paragraph 21, where the processor uses the information received from the detector to discriminate, in the frequency-domain, between the first and second portions of the signal.

23. The apparatus of paragraph 21, where the lifetime of the analyte is at least twice the effective lifetime of the background.

24. The apparatus of paragraph 21, where the lifetime of the analyte is no more than half the effective lifetime of the background.

25. The apparatus of paragraph 21, where the background is characterized by two effective lifetimes, one shorter than the analyte lifetime, one longer than the analyte lifetime.

26. The apparatus of paragraph 25, where the lifetime of the analyte is at least twice The effective lifetime of the shorter-lifetime background, and where the lifetime of the analyte is no more than half the effective lifetime-of the longer-lifetime background.

27. An apparatus for detecting light emitted by an analyte in a composition, the apparatus comprising (A) a stage for supporting the composition; (B) a light source and a first optical relay structure that directs light from the light source toward the composition, so that the analyte may be induced to emit light; (C) a detector and a second optical relay structure that directs light from the composition toward the detector, so that light transmitted from the composition may be detected and converted to a signal; and (D) a processor that uses information in the signal to discriminate, in the frequency-domain, between a first portion of the signal that is attributable to the light emitted by the analyte and a second portion of the signal that is attributable to a background, without requiring a determination of the intensity of the background.

28. The apparatus of paragraph 27, where the processor can discriminate between the first and second portions of the signal using frequency-domain information corresponding to a single frequency.

29. The apparatus of paragraph 27, the background being characterized by two effective lifetimes, one shorter than the analyte lifetime, one longer than the analyte lifetime, where the processor can discriminate between the first and second portions of the signal using frequency-domain information corresponding to two frequencies.

30. An apparatus for detecting light emitted by an analyte in a composition, the apparatus comprising (A) a stage for supporting the composition; (B) a light source and a first optical relay structure that directs light from the light source toward the composition, so that the analyte may be induced to emit light; (C) a detector and a second optical relay structure that directs light from the composition toward the detector, so that light transmitted from the composition may be detected and converted to a signal; and (D) a processor that uses information in the signal to discriminate, in the frequency-domain between a first portion of the signal that is attributable to the light emitted by the analyte and a second portion of the signal that is attributable to a background, without requiring use of information obtained from a blank.

31. An apparatus for detecting light emitted by an analyte in a composition, the apparatus comprising (A) a stage for supporting the composition. (B) a light source and a first optical relay structure that directs light from the light source toward the composition, so that the analyte may be induced to emit light; (C) a detector and a second optical relay structure that directs light from the composition toward the detector, so that the intensity of the light transmitted from the composition may be detected and converted to a signal; and (D) a processor That determines the intensity of the light emitted by the analyte by discriminating, in the frequency-domain, between a first portion of the signal that is attributable to the light emitted by the analyte and a second portion of the signal that is A attributable to a background.

32. The apparatus of paragraph 31, where the intensity is a steady-state intensity.

33. An apparatus for detecting light emitted by an analyte in a composition, the apparatus comprising (A) a stage for supporting the composition, the composition having first and second populations of the analyze, the first and second populations having different polarizations; (B) a light source and a first optical relay structure having an excitation polarizer, where the first optical relay structure directs light from the light source through the excitation polarizer toward the composition, so that the analyte may be induced to emit light; (C) a detector and a second optical relay structure having an emission polarizer, where the second optical relay structure directs light emitted from the composition through the emission polarizer toward the detector, so that the polarization of the light transmitted from the composition may be detected and converted to a signal; and (D) a processor that uses information regarding the light transmitted from the composition to discriminate between the first and second populations, by calculating a quantity related to the relative fractions of molecules in the first and second populations, the quantity being insensitive lo the presence of a background.

34. The apparatus of paragraph 33, where the processor is capable of discriminating between the background and light emitted by the first and second populations of analyte.

35. The apparatus of paragraph 33, the polarization depending on luminescence lifetime, where the processor is capable of discriminating between light emitted by the first population and light emitted by the second population based on a difference in the luminescence lifetimes of the first and second populations.

15 36. The apparatus of paragraph 33, the polarization depending on rotational mobility, where the processor is capable of discriminating between light emitted by the first population and light emitted by the second population based on a difference in the rotational mobilities of the first and second populations.

37. A method for detecting light emitted by an analyte in a composition, the method comprising (A) illuminating the composition, so that light is emitted by the analyte; (B) detecting light transmitted from the composition and converting it to a signal: and (C) processing the signal to discriminate between a first portion of the signal that is attributable to the light emitted by the analyte and a second portion of the signal that is attributable to a background, without requiring determination of the lifetime or intensity of the background.

38. The, method of paragraph 37, where the processing step uses lifetime resolved methods.

39. The method of paragraph 37, where the processing step uses frequency-domain methods.

40. A method for detecting light emitted by an analyte in a composition, the method comprising (A) illuminating the composition, so that light is emitted by the analyte; (B) detecting light transmitted from the composition and converting it to a signal; and (C) processing the signal to discriminate between a first portion of the signal that is attributable to the light emitted by the analyte and a second portion of the signal that is attributable to a background, without using information obtained from a blank.

41. An apparatus for determining the intensity of light emitted by a luminescent analyte in a composition that includes the analyte and a luminescent reference compound, the apparatus comprising (A) a stage for supporting the composition; (B) a light source and a first optical relay structure that directs light from the light source toward the composition, so that the analyte and reference compound may be induced to emit light; (C) a detector and a second optical relay structure that directs light from the composition toward the detector, so that light transmitted from the composition may be detected and converted to a signal; and (D) a processor that uses information in the signal to determine the intensity of light emitted from the analyte as a function of the intensity of light emitted from the reference compound by using lifetime-resolved methods.

42. The method of paragraph 41, where the processor calculates a ratio of the intensity of light emitted from the analyte to the intensity of light emitted from the reference compound.

43. The apparatus of paragraph 41, where the processor is capable of discriminating between a background and light emitted by the analyte and reference compound.

44. A method for determining the intensity of light emitted by a luminescent analyte in a composition that includes the analyte and a luminescent reference compound, the method comprising (A) providing the composition; (B) illuminating the composition, so that light is emitted by the analyte and reference compound; (C) detecting the light emitted by the analyze and reference compound and converting it to a signal; and (D) processing the signal to determine the intensity of light emitted from the analyte as a function of the intensity of light emitted from the reference compound by using lifetime-resolved methods.

45. The method of paragraph 44, where the processing step includes calculating a ratio of the intensity of light emitted from the analyte to the intensity of light emitted from the reference compound.

46. The method of paragraph 44, further comprising discriminating between a background and the light emitted by the analyte and reference compound.

47. The method of paragraph 44, where the emission spectrum of the analyte and the emission spectrum of the reference compound overlap significantly.

48. The method of paragraph 44, where the excitation spectrum of the analyte and the excitation spectrum of the reference compound overlap significantly.

49. The method of paragraph 44. where the lifetime-resolved methods include frequency-domain methods.

50. The apparatus of paragraph 44, where the light emitted by the analyte includes at least one of fluorescence and phosphorescence.

51. A composition of matter comprising first and second luminophores, where the emission spectra of the first and second luminophores overlap significantly. and where fight emitted by the first luminophore is resolvable from light emitted by the second luminophore using lifetime-resolved methods.

52. The composition of paragraph 51, where the lifetime-resolved methods include frequency-domain methods.

53. The composition of paragraph 52, where the light emitted by the second luminophore is indicative of light absorbing or scattering effects.

54. The composition of paragraph 51, where the first luminophore is an analyte, and the second luminophore is a reference compound.

55. The composition of paragraph 51 further comprising reagents, where the first luminophore reacts to indicate the amount of a target substance, and the second luminophore is indicative of light absorbing or scattering effects independent of how much target substance is present.

56. A method for determining the rotational mobility of an analyte in a composition, the method comprising (A) providing a composition that includes the analyte and a reference compound, the analyte and the reference compound being luminescent, the luminescence lifetimes of the analyte and reference compound being resolvable by lifetime-resolved methods; (B) illuminating the composition, so that light is emitted by the analyte and reference compound; (C) detecting the light emitted by the analyte and reference compound; (D) calculating the rotational mobility of the light emitted by the analyte and the rotational mobility of the light emitted by the reference compound, based on the light that they emit and their luminescence lifetimes; and (E) constructing a function that expresses the rotational mobility of the analyte relative to the rotational mobility of the reference compound.

57. The method of paragraph 56 further comprising calculating an amount of target substance in the composition based on the rotational mobility of the analyte.

58. An apparatus for detecting light emitted by an analyte in a composition, the apparatus comprising (A) a stage for supporting the composition; (B) a light source and a first optical relay structure that directs light from the light source toward the composition, so that the analyte may be induced to emit light; (C) a detector and a second optical relay structure that directs light from the composition toward the detector, so that light transmitted from the composition may be detected and converted to a signal; and (D) a processor that can discriminate between a first portion of the signal that is attributable to the light emitted by the analyte and a second portion of the signal that is attributable to a background using only information that can be obtained from the signal in a single frequency measurement on the composition.

59. The apparatus of paragraph 58, where the processor discriminates between the first and second portions of the signal using phase, modulation, or phase and modulation information.

60. The apparatus of paragraph 58, where the processor can discriminate between the first and second portions of the signal without requiring a determination of the lifetime of the analyte or the intensity of the background.

61. The apparatus of paragraph 58, where the processor can discriminate between the first a,d second portions of the signal without requiring a determination of the lifetime or intensity of the background.

62. The apparatus of paragraph 58, where the processor can discriminate between the first and second portions of the signal without requiring use of information obtained from a blank.

63. The apparatus of paragraph 58, where the processor can discriminate between the first and second portions of the signal irrespective of whether a significant amount of the background is being detected by the detector at the same time that light emitted by the analyte is being detected.

64. The apparatus of paragraph 58, where the processor can discriminate between the first and second portions of the signal to calculate the luminescence lifetime of the analyte.

65. The apparatus of paragraph 58, where the processor can discriminate between the first and second portions of the signal to calculate the intensity of the light emitted by the analyte.

66. The apparatus of paragraph 58, the first optical relay structure including an excitation polarizer, the second optical relay structure including an emission polarizer, where the processor discriminates between the first and second portions of the signal to calculate the polarization of the light emitted by the analyte.

67. The apparatus of paragraph 58, where the light emitted by the analyte includes at least one of fluorescence and phosphorescence.

68. The apparatus of paragraph 58, the analyte being a first analyte, where the background includes a second analyte.

69. An apparatus for detecting light emitted by an analyte in a composition, the apparatus comprising (A) a stage for supporting the composition: (B) a light source and a first optical relay structure that directs light from the light source toward the composition, so that the analyte may be induced to emit light; (C) a detector and a second optical relay structure that directs light from the composition toward the detector, so that light transmitted from the composition may be detected and converted to a signal; and (D) a processor that uses information in the signal to discriminate between a first portion of the signal that is attributable to the light emitted by the analyte and a second portion of the signal that is attributable to a background, without requiring a determination of the lifetime of the analyte or the intensity of the background.

70. The apparatus of paragraph 69, where the processor discriminates between the first and second portions of the signal without requiring a determination of the lifetime of the background.

71. The apparatus of paragraph 69, where the processor discriminates between the first and second portions of the signal without requiring use of information obtained from a blank.

72. The apparatus of paragraph 69, where the processor discriminates between the first and second portions of the signal irrespective of whether a significant amount of the background is being detected by the detector at the same time that light emitted by the analyte is being detected.

73. The apparatus of paragraph 69, where the processor discriminates between the first and second portions of the signal to calculate the luminescence lifetime of the analyte.

74. The apparatus of paragraph 69, where the processor discriminates between the first and second portions of the signal to calculate the intensity of the light emitted by the analyte.

75. The apparatus of paragraph 69, where the processor uses information in the signal to discriminate in the frequency-domain between the first and second portions of the signal.

76. A method for detecting light emitted by an analyte in a composition, the method comprising (A) illuminating the composition, so that light is emitted by the analyte; (B) detecting light transmitted from the composition and converting it to a signal; and (C) processing the signal to discriminate between a first portion of the signal that is attributable to the light emitted by the analyte and a second portion of the signal that is attributable to a background using only information that can be obtained from the signal in a single frequency measurement on the composition.

77. The method of paragraph 76, where the processing step includes the step of evaluating a function constructed purely in terms of quantities that can be obtained from the single frequency measurement.

### IV. Identification and/or Correction of Quenching

This section describes systems including apparatus and methods for identifying and/or correcting for quenching in luminescence assays using combinations of luminescence lifetimes and/or luminescence intensities. In one aspect, these systems involve identifying quenching using combinations of luminescence lifetimes and/or intensities. In another aspect, these systems involve correcting for quenching by eliminating false positives or false negatives due to quenching in luminescence assays. These systems are described primarily in the context of time-domain RET assays, although the concepts apply equally well to frequency-domain RET assays, as well as other luminescence assays.

These and other aspects of the invention are described in detail below, including (A) background, (B) description of methods. and (C) examples. This disclosure is supplemented by the patents, patent applications, and publications identified above under Cross-References, particularly U.S. provisional patent application Ser. No. 60/094,306, filed Jul. 27, 1998; and U.S. patent application Ser. No. 09/766,131, filed Jan. 19, 2001. These supplementary materials are incorporated herein by reference in their entirety for all purposes.

Background

Generally, quenching refers to any process that decreases the luminescence intensity of a given substance. Quenching can arise from a variety of processes, including excited state reactions, energy transfer, collisions. and complex formation. Dynamic (or collisional) quenching results from collisional encounters between a luminophore and a dynamic quencher. For this reason, dynamic quenching may be more significant for long-lifetime luminophores, because luminophore and quencher may diffuse significantly during the long lifetime and so be more likely to interact collisionally. Static quenching results from complex formation between a luminophore and a static quencher. Both static and dynamic quenching require molecular contact between the luminophore and quencher. In the case of dynamic quenching, the quencher and luminophore must diffuse together during the lifetime of the excited state. Upon contact, the luminophore returns to the ground state, without emission of a photon. In the case of static quenching, a complex is formed between the luminophore and the quencher, and this complex is nonfluorescent. In either event, the luminophore and quencher must be in contact.

More specifically quenching may be defined in the context of a given assay as any process that decreases the luminescence intensity of a given substance, other than a process of interest. For example, as described below, in assays known as resonance energy transfer assays, interactions between assay species may lead to a decrease in the luminescence of one of the species. In such an assay, the energy transfer leading to such a decrease would be excluded from the definition of quenching.

A variety of compounds can act as quenchers; examples are described in Joseph R. Lakowicz, Principles of Fluorescence Spectroscopy (1983), which is incorporated herein by reference in its entirety for all purposes. Probably the best known quencher is molecular oxygen, which quenches almost all known luminophores. Generally, whether a particular compound will act as a quencher depends on the mechanisms by which it can interact with each particular luminophore, which in turn depends on the relative structures of the compound and luminophore in a given environment.

Apparent quenching also can occur, due to optical properties of the sample. For example, high optical densities or turbidity can decrease luminescence intensities. This type of quenching contains little molecular information.

Luminescence assays form the foundation of many assays employed in screening libraries of compounds to provide leads for the development of new therapeutic drugs. (See, for example, the patents. patent applications, and publications incorporated herein by reference above.) In such screening, hundreds of thousands of samples may be analyzed each day) and during primary screening typically only about 0.1% of the moles will give positive results (“hits”) that merit further investigation. Unfortunately, the number of “hits” may be significantly overestimated if mechanisms other than those underlying the assay lead to changes in luminescence or luminescence properties. For example, if only 1% of the compounds caused quenching that might be confused with a hit, then the number of false positives caused by quenching would outnumber the number of true hits by a factor of 10. If a significant portion of false positive tests due to quenching could be identified and treated as negative hits, or retested under different conditions, then the efficiency of the screening protocol could be improved dramatically, resulting in a savings of time and money.

The invention provides apparatus and methods for identifying and correcting for quenching in luminescence assays, including time-resolved resonance energy transfer (RET) assays. One aspect of the invention involves identifying quenching using combinations of luminescence lifetimes and/or intensities. Another aspect of the invention involves correcting for quenching by eliminating false positives or false negatives due to quenching in luminescence assays. These and other aspects of the invention are described in the following three sections: (1) luminescence assays. (2) application of methods. and (3) description of apparatus.

B. Description of Methods

The invention provides methods for identifying and correcting for interference from luminescence quenching in luminescence assays. These methods may include performing a luminescence assay, and comparing measured and expected assay results using combinations of luminescence lifetimes and/or luminescence intensities to identify and correct for false hits due to quenching.

The invention may be applied to a variety of luminescence assays, particularly assays involving measurement of luminescence intensities. This section presents an application of the invention to resonance energy transfer (RET) assays.

In a typical RET assay, donors are excited from their ground states into an excited state by the absorption of a photon, and the proximity of acceptors is monitored using the effects of energy transfer on donor and/or acceptor lifetimes and/or intensities. Unfortunately, RET assays may be complicated by mechanisms that alter donor and acceptor properties in ways that mimic or mask the effects of energy transfer. The invention provides apparatus and methods for identifying and correcting for these mechanisms, particularly quenching.

The methods provided by the invention may include labeling a first binding partner with an energy-transfer donor, D, and labeling a second binding partner with an energy-transfer acceptor, A, as described above. The first and second binding partners may be free or bound together, so that donor and acceptor bound to these partners may be found as four species: free donor (D_{f}), bound donor (D_{b}), free acceptor (A_{f}), and bound acceptor (A_{b}).

Generally, each of D_{f}, D_{b}, A_{f}, and A_{b} may be characterized by different spectroscopic properties,. including lifetimes and excitation/emission spectra. In particular, D_{b} and A_{b} may have different spectroscopic properties than D_{f} and A_{f}, respectively, due to energy transfer and differences in quenching efficiency. Typically, D and A are chosen such that the lifetime of D_{f} is (substantially) longer than the lifetime of A_{f}, although RET assays do not require such a choice.

The rate of decay, P(t), of an excited luminophore can be described using a first-order differential equation:

$$\frac{ⅆ P ( t )}{ⅆ t} = - k P ( t ) \qquad ( 70 )$$

Here, k is a rate constant that includes contributions from photon production (e.g., fluorescence and phosphorescence), energy transfer, quenching, and other processes. The solution of Equation 70 is a decaying exponential:

P(tl)=exp(−kt)=exp(−t/τ_{D}) (71)

Here, P(0)=1, corresponding to no decay at t=0, and τ_{D}=1/k is the donor lifetime.

The separate effects of energy transfer, quenching, and other decay mechanisms on luminescence lifetime can be identified and corrected for in part by identifying their separate effects on the rate constant k of Equations 70 and 71. Generally, the rate constant k is a sum of rate constants for each, mechanism that leads to decay of the excited state. Thus, for a fluorescent luminophore, the general rate constant k can be expressed as a sum of rate constants for fluorescence (k_{f}), dynamic quenching (k_{d}), other deactivation (kₒ), and energy transfer kₑ, among others. Fluorescence is used here to refer generally to emission of a photon, and may include one or both of fluorescence and phosphorescence, depending on the luminophore. Other deactivation is used here as a catchall for all other forms of nonradiative decay, including but not limited to thermal deactivation.

Static quenching also may be modeled using a rate constant. However, the rate constant for static quenching typically is so large that luminophores bound to static quenchers decay only via static quenching, rendering the luminophores nonluminescent. Thus, static quenching is modeled instead using mole fractions.

In principle, these rate constants may differ for each of D_{f}, D_{b}, A_{f}, and A_{b}. Thus, an energy transfer system may be described using rate constants for each of these species, as well as bound fractions of donor relative to acceptor, and donor and acceptor relative to quencher. Formal rate constants for fluorescence, internal conversion, dynamic quenching, and energy transfer are shown in the following table:

| | D_{f} | D_{b} | A_{f} | A_{b} |
|---|---|---|---|---|
| Fluorescence | k_{fdf} | k_{fdb} | k_{faf} | k_{fab} |
| Other deactivation | k_{odf} | k_{cdb} | k_{oaf} | k_{oab} |
| Dynamic quenching | k_{qdf} | k_{qab} | k_{qaf} | k_{qab} |
| Energy transfer | | kₑ | | |

Generally, these rate constants will vary with the specific donor and acceptor, and with different sample and assays conditions. The subscripts “f” and “b” on these rate constants may be dropped if the corresponding rate constants are the same for free and bound states; for example, if k_{odf}=k_{odb}, then both may be labeled k_{od}. The fraction of donor that is bound by acceptor is x. The fractions of free and bound donor and free and bound acceptor that are bound by static quencher (and rendered nonfluorescent) are f_{qdf}, f_{qdb}, f_{qaf}, and f_{qab}, respectively.

The methods provided by the invention may be used in time-resolved luminescence assays, including time-resolved time-domain assays and time-resolved frequency-domain assays. In time-domain assays, donors typically are excited by a pulse of light that is short relative to the apparent lifetimes of each species except A_{f}. The “per molecule” time evolution of the fluorescence of each species following excitation may be described using the following equations, for times that are long relative to the lifetime of A_{f}:

F_{Df}(t)=(1−f_{qdf})(k_{fd})exp(−t/τ_{Df}) (72a)

F_{Db}(t)=(1−f_{qdb})(k_{fb})exp(−t/τ_{Db}) (72b)

F_{Af}(t)≈0 (72c)

F_{Ab}(t)=(1−f_{qab})(kₑ)[k_{fa}/(k_{fa}+kₒₐ+k_{qab})]exp(−t/ τ_{Ab}) (72 d)

Here, τ_{Df}=/(k_{qdf}+kₒ+k_{fd}) is the lifetime of D_{f}, τ_{Db}=1/(k_{qdb}+k_{od}+k_{fd}+kₑ) is the lifetime of D_{b}, and τ_{Ab} is the lifetime of A_{b}. If τ_{Db} is much larger than the lag between energy transfer from D_{b} to A_{b} and subsequent emission from A_{b}, then τ_{Ab} may to good approximation be set equal to τ_{Db}. The fluorescence of free acceptor is about zero; because the equations apply for t >>τ_{Af} and/or because the free acceptor is not significantly excited by light used to excite the donor. In Equation 72, the exponential (time dependence from Equation 71 is multiplied by a first term that reduces the fluorescence to account for the fraction of luminophores quenched by quencher, and by a second term that reduces the fluorescence to account for nonradiative decay mechanisms.

Equation 72 is applicable for t >>τ_{Af}, where τ_{Db}>>τ_{Af}. These conditions were chosen because they simplify the analysis and because they correspond to common experimental conditions. However, these conditions may be relaxed within the scope of the invention, and equations analogous to Equation 72 may be derived to describe these relaxed conditions, such as where τ_{Db} is comparable to τ_{Af}.

In a RET experiment, donor and acceptor emission intensities may be recorded separately in different channels corresponding to different wavelengths. The observed decay of fluorescence in each channel is a weighted sum of the observed decays for the free and bound species:

F_{D}(t; λ_{D})=(1−x)F_{Df}(t)+X F_{Db}(t) (73a)

F_{A}(t; λ_{A})=xF_{Ab}(t) (73b)

Here, λ_{D} and λ_{A} denote the range of wavelengths over which luminescence is detected for donor and acceptor, respectively. Equation 73 may be generalized to account for spectral crosstalk between D and A channels; for example, if 1% of donor luminescence is detected in the acceptor channel, F_{A}(t) may be corrected by the transformation F_{A}(t)→F_{A}(t)−0.0F_{D}(t).

Equations 72 and 73 may be made more accurate by including additional coefficients and dependencies and by relaxing simplifying assumptions. For example, an instrumental gain coefficient can be used to quantify detection efficiencies and to account for differences in detection efficiency of donor and acceptor luminescence. The simplifications and assumptions addressed by these and other modifications do not affect the qualitative conclusions described herein.

Equations 72 and 73 (or their more detailed analogs) may be used to develop tables of expected effects of quenching and other conditions on lifetimes and intensities in RET and other luminescence assays. These tables in turn may be used to identify “false positive” or “false negative” experimental results, where the positive or negative result is at least partially due to quenching. Here, table refers to any representation showing how lifetimes and/or intensities are affected by quenching and other effects, and not merely to a physical representation of such relationships, such as an arrangement of ordered rows or columns.

The following example illustrates how the method may be used to develop such a table and to identify and correct for quenching effects in a time-domain RFT assay. The experimental system is characterized by various parameters, which describe donor, acceptor, quencher, apparatus, and detection protocol. Generally. these parameters may be measured and/or estimated.

Donor, acceptor, and quencher were characterized by rate constants and bound fractions. Here, parameters were roughly characteristic of lanthanide assay systems. Lifetimes and intensities were assumed to be affected by fluorescence, other deactivation, energy transfer, and dynamic and static quenching. Donor/acceptor binding were assumed to range between a minimum of xₘᵢₙ=0.1% donor bound by acceptor to a maximum of xₘₐₓ=50% donor bound by acceptor. Fluorescence, other deactivation, and energy transfer were characterized by the following rate constants:

| Rate Constants (μs⁻¹) | D_{f} | D_{b} | A_{b} |
|---|---|---|---|
| Fluorescence (k_{f}) | 0.002 | 0.002 | 250 |
| Other Deactivation (kₒ) | 0.0001 | 0.0001 | 50 |
| Energy Transfer (kₑ) | | 0.008 | 0 |

Dynamic quenching was characterized by rate constants (k_{q}) that ranged between 0 μs⁻¹ and 0.002 μs⁻¹. Static quenching was characterized by bound fractions f_{qdf}, f_{qdb}, f_{qaf}, and f_{qab} that ranged between 0% and 50%.

Apparatus and detection protocol were characterized by a detection efficiency and a crosstalk. Here, detection efficiency was assumed to be 100% for donor and acceptor luminescence, and crosstalk between donor and acceptor detection channels was assumed to be 0% for donor detection in the acceptor channel (relative to donor detection in the donor channel) and 0% for acceptor detection in the donor channel (relative to acceptor detection in the acceptor channel).

The effects of donor and acceptor binding and dynamic and static quenching may be characterized by evaluating Equations 72 and 73 for the parameters listed above using a computerized spreadsheet. Results may be determined for specific times by evaluating the equations at the specific times. Results may be determined for ranges of times (corresponding to experimental time windows) by integrating the equations over the ranges of times.

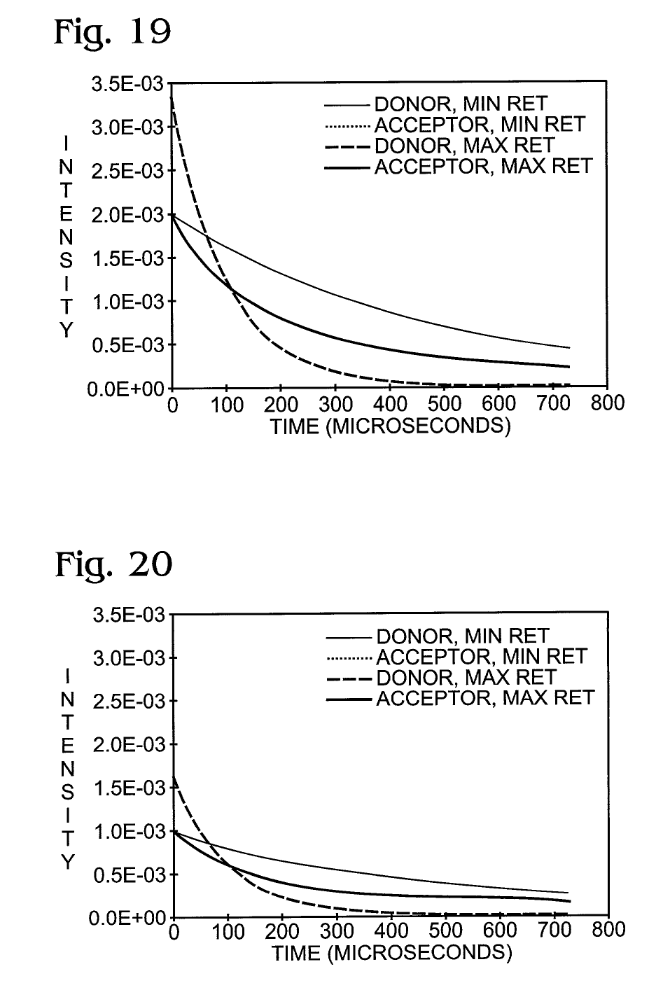

FIG. 19 shows luminescence intensities for acceptor and donor as functions of time and energy transfer. The associated lifetimes are 476 microseconds for D_{f} and 99 microseconds for D_{b} and A_{b}. Minimum and maximum RET correspond to 0.10% and 50% binding of acceptor to donor, simulating the modulation of energy transfer in a binding assay. The donor curve is a sum of emissions from free and bound donor. The acceptor curve arises only from bound acceptor, because free acceptor generally is not appreciably excited directly, and because emissions from free acceptor already have decayed on the time scale shown in the figure. The acceptor curve under minimum energy-transfer conditions is invisible because it is so low that it essentially lies on the time axis.

FIG. 19 also shows the effects of energy transfer: a decrease in donor intensity, an increase in acceptor intensity, a more rapid decay of acceptor than free donor, and a more rapid (and bi-exponential) decay of the donor signal due to the appearance of a component from the more rapidly decaying bound donor.

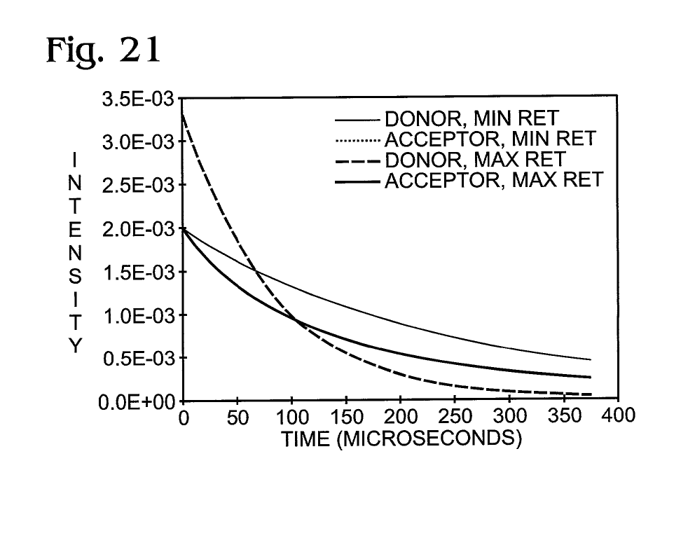

FIGS. 20 and 21 show the effects of static and dynamic quenching on the energy transfer system of FIG. 19. It is possible to create many examples with different types and amounts of quenching on the various species in the assay. For simplicity. and without limitation, these figures show only cases in which there is static or dynamic quenching of the free and bound donor.

FIG. 20 shows luminescence intensities for acceptor and donor as functions of time, energy transfer, and static quenching. Here, 50% of the free and bound donor are statically quenched. Static quenching reduces all emissions, starting at t=0. However, static quenching does not affect lifetimes of individual species, so that the rate of decay of the signals is not appreciably altered.

FIG. 21 shows luminescence intensities for acceptor and donor as functions of time, energy transfer, and dynamic quenching. Here, free and bound donor are dynamically quenched, with a rate constant of 0.002/microsecond, giving about 50% quenching of free donor and somewhat less quenching of bound donor. In this case, emissions are unaffected at t=0 but decay more rapidly because lifetimes of the individual species have been reduced (to 244 microseconds for free donor, and 83 microseconds for bound donor and bound acceptor).

Collecting lifetime information is a valuable adjunct to collecting intensities integrated over a fixed time window. In particular, intensities and lifetimes may be analyzed together to distinguish decreases in binding-derived energy transfer from static and dynamic quenching. For example, based on a comparison of results from FIGS. 19, 20, and 21, reduced lifetimes are diagnostic for dynamic quenching.

The following table shows bow changes in donor and acceptor binding and dynamic and static quenching differentially affect species lifetimes and species intensities:

| | Effects on | | | | Effects on | | | |
|---|---|---|---|---|---|---|---|---|
| | Species Lifetimes | | | | Species Intensities | | | |
| Condition . . . | D_{f} | D_{b} | A_{b} | A_{b}/D_{f} | D_{f} | D_{b} | A_{b} | A_{b}/D_{f} |
| Increased D:A | — | — | — | — | ↓ | ↑ | ↑ | ↑ |
| Binding | | | | | | | | |
| Decreased D:A | — | — | — | — | ↑ | ↓ | ↓ | ↓ |
| Binding | | | | | | | | |
| Dynamic | ↓ | — | — | ↑ | ↓ | — | — | ↑ |
| Quenching of D_{f} | | | | | | | | |
| Dynamic | ↓ | ↓ | ↓ | — | ↓ | ↓ | ↓ | — |
| Quenching of D_{f} | | | | | | | | |
| and D_{b} equally | | | | | | | | |
| Dynamic | — | — | ↓ | ↓ | — | — | ↓ | ↓ |
| Quenching of A_{b} | | | | | | | | |
| Static Quenching | — | — | — | — | ↓ | — | — | ↑ |
| of D_{f} | | | | | | | | |
| Static Quenching | — | — | — | — | ↓ | ↓ | ↓ | — |
| of D_{f} and D_{b} | | | | | | | | |
| equally | | | | | | | | |
| Static Quenching | — | — | — | — | — | — | ↓ | ↓ |
| of A_{b} | | | | | | | | |

The table generally applies to a broad range of conditions, even if entries were derived in some cases using specific parameters. “Changes” refers generally to relative changes, such as an incremental increase or decrease in D : A binding relative to an arbitrary initial value. Changes also may refer more specifically to changes relative to a blank or control that for example does not include a target analyte and/or a quencher. “Species” refers to D_{f}, D_{b}, A_{f}, and A_{b} considered separately, rather than in combination. Species lifetimes are intensive quantities, and species intensities are extensive quantities.

The first two rows of the table show how changes in the amount of donor: acceptor binding affect species lifetimes and species intensities. Changes in binding do not affect species lifetimes, although they do affect mean (weighted average of free and bound) lifetimes. In contrast, changes in binding do affect specie intensities. Specifically, increases in binding decrease intensities -from free donor and increase intensities from bound donor and acceptor, Conversely, decreases in binding increase intensities from free donor and decrease intensities from bound donor and acceptor.

The third through fifth rows of the table show hoist dynamic quenching of D_{f}, D_{f} and D_{b}, or A_{b} affects species lifetimes and species intensities. Generally, dynamic quenching of a species always decreases the lifetime and intensity of that species. Thus, because changes in donor: acceptor binding generally do not affect species lifetimes. decreases in species lifetimes are diagnostic for dynamic quenching.

The sixth through eighth rows of the table show how static quenching of D_{f}, D_{f} and D_{b}, or A_{b} affects species lifetimes and species intensities. Generally, static quenching does not affect species lifetimes, but decreases species intensities. Static quenching resembles a decrease in donor: acceptor binding, except that a decrease in donor: acceptor binding is accompanied by a decrease in intensity of bound donor and static quenching is not.

The invention may be implemented to carry out a screening protocol in which individual qualitative tests or assays are performed on a number of samples Screening protocols typically result in a relatively small number of true positives, and additionally, some number of false positives and false negatives. If the number of false positives and/or false negatives are too high, then the utility of the screening protocol may be significantly undermined. Adjusting the sensitivity of the test to decrease the number of false positives typically will cause some increase in the number of false negatives. Conversely, adjusting the sensitivity of th2 test to decrease the number of false negatives often will cause an increase in the number of false positives. The table showing relationships of lifetime and intensity changes in relation to quenching effects may be used to program the instrument so that the sensitivity of an assay in a screening protocol is optionally set to minimize false positives and false negatives, thus improving the overall efficiency of the procedure.

Apparent quenching can arise due to optical properties of a sample. including optical density and turbidity. A common example is “color quenching”, which is a reduction of measured luminescence intensities (without a change in lifetimes) by Beer-Lambert absorption of excitation and/or emission light by chromophores present in the assay solution at appreciable optical densities. Color quenching is common in screens for new pharmaceuticals, where library compounds may have significant extinction coefficients at the excitation and/or emission wavelengths of the labels. Color quenching occurs separately from the molecular photophysics of the donors and acceptors. A ratio of acceptor-to-donor emission can correct for absorption at donor excitation wavelengths, because such absorption will reduce all luminescence intensities to the same extent. This ratio also can correct for equal absorption (optical density) at donor and acceptor emission wavelengths. However, this (or another) ratio will not easily correct for unequal absorption (optical density) at donor and acceptor emission wavelengths, which if uncorrected may mimic changes in binding. In this case, lifetime measurements may be useful for correcting for color quenching, as described above.

Time-resolved RET assays typically are detected by monitoring integrated intensities using a single time window for donor and a single time window for acceptor. To gather the information discussed herein, lifetimes and intensities can be determined in time-domain) measurements by collecting data in multiple time windows, preferably more than two for each wavelength monitored. Alternatively, measurements can be done in the frequency domain, by exciting with amplitude-modulated light and measuring the phase and modulation of the emissions as a function of the frequency of excitation modulation. The frequency-domain results can be couched in terms of effects on directly measured phase angles and modulation (and perhaps unmodulated intensity) instead of derived lifetime and intensity. The analytical treatment of frequency-domain results differs in detail but not in spirit from the analytical treatment of time-domain results presented here, embodying the same photophysics. Substantially the same information is contained in ideal time-domain and frequency-domain results, although practical instrumental factors may render them of different utility.

In summary, combined measurements of lifetimes and intensities may be used to identify and correct for various forms of quenching, so that quenching can be distinguished from increases or decreases in the extent of donor/acceptor binding.

C. Examples

Additional and,or alternative aspects of the invention ate described without limitation in the following numbered paragraphs:

1. A method of performing a luminescence assay, the method comprising the steps of (A) performing an assay configured to relate a change in luminescence emission to the presence-of a target in a sample; (B) detecting a change in luminescence emission from the sample; and (C) identifying at least a portion of he change in luminescence emission which is due to quenching.

2. The method of paragraph 1, where the identifying step includes the step of determining at least a portion of the change in luminescence emission that is due to dynamic quenching.

3. The method of paragraph 1 where the identifying step includes the step of determining at least a portion of the change in luminescence emission that is due to static quenching.

4. The method of paragraph 1, where the performing step includes the step of designing the assay so that a change in luminescence emission may be correlated with RET.

5. The method of paragraph 1, where the performing step includes the step of designing the assay so that a change in luminescence emission may be correlated with time-resolved RET.

6. The method of paragraph 1 further comprising the step of processing lifetime and intensity measurements to identify a quenching effect.

7. The method of paragraph 1 further comprising the step of detecting luminescence in multiple time windows.

8. The method of paragraph 1 further comprising the stop of illuminating at least a portion of the sample with pulsed light.

9. The method of paragraph 1 further comprising the step of analyzing luminescence lifetime and intensity measurements to determine whether a significant portion of detected change in luminescence emission is due to quenching.

10. An apparatus for detecting luminescence, the apparatus comprising (A) an instrumentation system capable of detecting changes in luminescence emission from a sample; and (B) a processor configured to indicate changes in luminescence emission that are due to quenching.

11. The apparatus of paragraph 10 further comprising a controller that obtains and integrates luminescence intensity and lifetime measurements to determine quenching effects.

12. The apparatus of paragraph 10 further comprising a controller that processes luminescence detection in multiple time windows.

13. A method of discriminating quenching effects from RET effects in a time-resolved RET assay, the method comprising (A) deriving a formula at least partially based on known rate constants relating to luminescence and quenching for each of a donor and an acceptor of a RET pair.; and (B) using the formula to develop a table of expected effects on luminescence lifetimes and intensities in relation to a set of conditions including changes in donor:acceptor binding, and quenching.

14. The method of paragraph 13, where the deriving step results in the following formula:

F_{Df}(t)=(1−f_{qdf})(k_{fd})exp(−t/τ_{Df})

F_{Db}(t)=(1−f_{qdb})(k_{fb})exp(−t/τ_{Db})

F_{Af}(t)≈0

F_{Ab}(t)=(1−f_{qab})(kₑ)[k_{fa}/(k_{fa}+kₒₐ+k_{qab})]exp(−t/τ_{Ab})

where F_{Df}(t), F_{Db}(t), F_{Af}(t), and F_{Ab}(t) refer to the luminescence of the free donor, bound donor, free acceptor, and bound acceptor, respectively; f_{qdf}, f_{qdb}, and f_{qab} refer to the fraction of free donor, bound donor, and bound acceptor quenched by static quenchers, respectively; where k_{f}, kₑ, kₒ, and k_{q} are rate constants for luminescence, energy transfer, other deactivation, and dynamic quenching, respectively, for free donor, bound donor, free acceptor, and bound acceptor, as indicated; and where τ_{Df}, τ_{Db}, and τ_{Ab} are lifetimes of free donor, bound donor, and bound acceptor, respectively.

15. The method of paragraph 13 further comprising the step of performing a time resolved RET assay designed to detect changes in luminescence due to presence of target in a sample.

16. The method of paragraph 15, where the performing step includes the step of detecting changes in luminescence lifetime and intensities of the donor and acceptor.

17. A method of screening a plurality of samples for presence of target, the method comprising (A) depositing each sample in a separate sample container; (B) for each sample, performing a RET assay designed to detect target; and (C) in each assay, discriminating quenching effects from RET effects due to presence of target.

18. The method of paragraph 17, where the discriminating step includes the step of identifying false positives that are at least partially due the quenching.

19. The method of paragraph 17 further comprising the step of programming a light detection instrument based on known rate constants relating to luminescence and quenching of a donor and acceptor used in the RET assay.

20. The method of paragraph 17, where the performing step includes the step of detecting changes in luminescence lifetime and intensities of the donor and acceptor.

21. The method of paragraph 17, where the performing:, step includes the step of exciting a donor and an acceptor by a pulse of light that is short relative to the lifetimes of free donor, bound donor, and bound acceptor, but long relative to the lifetime of free acceptor.

22. The method of paragraph 17, where the performing step includes the step of conducting time-domain measurements by collecting data in multiple time windows to determine changes in luminescence lifetimes and intensities of the donor and the acceptor.

23. The method of paragraph 17, where the performing step includes the step of using frequency-domain measurements to determine changes in luminescence lifetimes and intensities of the donor and the acceptor.

24. The method of paragraph 17, where the depositing step includes the step of transferring each sample into a separate microplate well.

### V. Photon-counting Methods

This section describes systems including apparatus and methods for determining temporal properties of photoluminescence samples using frequency-domain photoluminescence measurements. These measurements may include photon counting and/or the separation of measured luminescence into potentially overlapping time bins.

These and other aspects of the invention are described in detail below, including (A) background, (B) description of system, and (C) examples. This disclosure is supplemented by the patents, patent applications, and publications identified above under Cross-References, particularly U.S. Provisional Patent Application Serial No. 60/121,229, filed Feb. 23. 1999; and U.S. patent application Ser. No. 09/767,579, filed Jan. 22, 2001. These supplemental materials are incorporated herein by reference in their entirety for all purposes.

A. Background

Frequency-domain measurements typically are conducted at high frequencies, especially for short-lifetime luminophores. To simplify these measurements, the emission signal may be converted to a lower frequency, as follows. In radio-frequency (RF) signal detection, an input frequency may be converted (heterodyned) to a fixed intermediate frequency (IF) by mixing it with (i.e., multiplying it by) a signal from a local oscillator (LO) of appropriate frequency. Multiplying two frequencies creates an output containing the sum and difference frequencies. One of these outputs is selected as the IF signal by filtering. The IF signal contains the phase and amplitude information of the original RF signal but at a more convenient (i.e., usually lower) fixed frequency. In frequency-domain heterodyne fluorometry, the RF emission signal is mixed with a second, coherent frequency, and the IF is the isolated difference frequency output. Typically, a gain-modulated detector performs the mixing step.

If the source and detector frequencies are the same in a heterodyning scheme, the method is called homodyning. Homodyning, by definition, results in a zero-frequency (DC) IF signal. The intensity is proportional to the cosine Or the difference of the phase between the detector and the emission. To acquire the entire phase and modulation information of the emission signal, the phase difference may be stepped systematically between the source and detector modulation signals. Alternatively, the RF signal may be demodulated using two LO signals whose phases are 90 degrees apart. The two resulting signals, the in-phase (I) and quadrature (Q) signals are the Cartesian representations of the phase and modulation (cosine and sine components).

Homodyning is commonly used to collect phase-resolved data with a single frequency reference and a fixed phase difference. By properly choosing the phase of the detector, one can suppress or enhance certain lifetimes. A disadvantage of homodyning relative to heterodyning is that homodyning is more affected by DC offsets in the mixing and detection electronics.

The heterodyne frequency-domain method has two significant advantages over time-domain methods: (1) an enhanced excitation duty cycle, and (2) measurement of phase and modulation.

An enhanced excitation duty cycle may be advantageous because it implies that a near maximal amount of luminescence is being excited from the sample. (The excitation duty cycle is the fraction of time that the system is illuminated.) If the illumination is a pure sine wave, the excitation duty cycle can be as large as 50%. However, if the illumination is a narrow pulse. as in multiharmonic phase and modulation fluorometry, the excitation duty cycle will be much lower, comparable to that for time-domain methods.

Measurement of phase and modulation may be advantageous because these quantities may be relatively unaffected by the DC luminescence intensity of the system. or by fluctuations in light source intensity, drift of electronic offsets, and errors in sample concentration. Conversely, intensity measurements, such as those used in time-domain methods, may be strongly affected by these factors, so that they must be corrected by normalization and/or calibration.

Despite these advantages, the heterodyne frequency-domain method has two significant disadvantages, especially relative to time-domain methods: (1) a reduced detection duty cycle, and (2) a low sensitivity.

A reduced detection duty cycle is a significant disadvantage because it reduces the amount of luminescence that is detected. (The detection duty cycle is the fraction of time that the detector can process light.) Typically, the detector is internally gated or gain modulated for the heterodyning step because the detector cannot respond externally to the high-frequency luminescence emission signal. If the luminescence is a pure sine wave, the detected signal optimally will be gated off 50% of the time, either by gating the signal or gating the detector.

A low sensitivity is a significant disadvantage because it requires higher quantities of reagents and/or longer analysis times, if a sample may be analyzed at all. This low sensitivity reflects in part the cumulative effects of dark noise, which becomes an ever larger fraction of the signal as light levels are reduced.

B, Description of System

The invention provides apparatus and methods for measuring a temporal property of a luminescent sample. The measurements may include (1) illuminating the sample with intensity-modulated incident light, (2) detecting luminescence emitted from the sample in response to the illumination, and (3) determining the temporal property using the measured luminescence. The measurements also may include photon counting and/or the separation of measured luminescence into potentially overlapping time bins. The measurements also may include determination of frequency-domain parameters by counting locked-in photons (CLIP™).

The measurements may involve repeated steps and/or additional steps. For example, the steps of illuminating the sample and detecting luminescence may be performed simultaneously. Moreover, these steps may be performed repeatedly on a single sample for signal averaging before performing the step of determining the temporal property, of they may be performed together with the step of determining the temporal property on a series of samples.

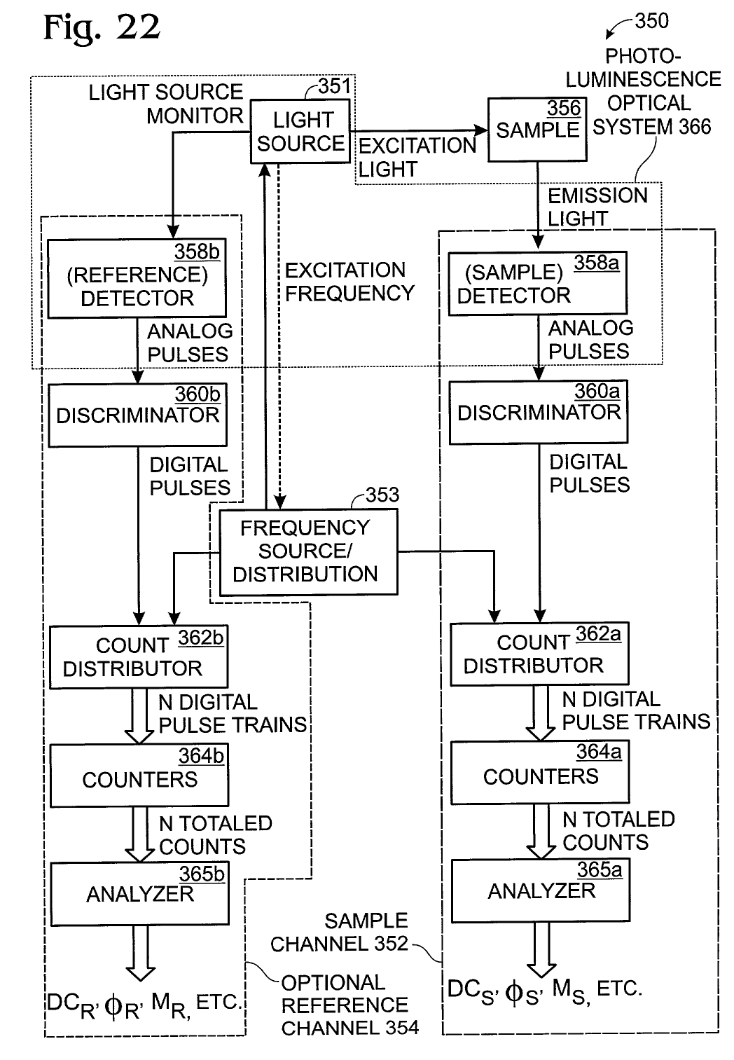

FIG. 22 is a schematic view of an apparatus 350 constructed in accordance with the invention. Apparatus 350 includes a light source 351, a sample channel 352, a frequency source 353, and an optional reference channel 354. Light source 351 is configured to illuminate a sample 356 with intensity-modulated light. Sample channel 352 is configured to detect and analyze light such as photoluminescence transmitted from the sample. Frequency source 353 is configured to generate a frequency, which may be derived from or used to drive the light, source, and which may be used to drive components of the sample and reference channels. Optional reference channel 354 is configured to detect light transmitted from the light source, so that the output of the sample channel can be corrected to account for fluctuations and/or other irregularities in the output of the light source.

The sample channel may include a (sample) detector 358aa discriminator 360a, a count distributor 62a, at least one parallel counter 64a, and an analyzer (or discrete analyzer) 65a. Detector 358a is configured to detect the light transmitted from sample 356 and to convert it to a signal. Discriminator 360a is configured to convert the signal into pulses that correspond to individual detected photons. Count distributor 62a is configured to direct the pulses to a counter corresponding to the phase delay of the photon, relative to the excitation signal, based on input from the frequency source. Each counter 64a is configured to tabulate the number of pulses directed to it by the count distributor. Analyzer 65 is configured to determine a temporal property of the sample, based on the detected luminescence. The temporal property may be compute discretely and/or computed in the frequency-domain, for example, by computing a Fourier transform.

The optional reference channel also may include a detector 358b, a discriminator 360b, a count distributor 62b (interfaced with a frequency source), at least one parallel counter 64b, and an analyzer 65a.

The light sources, detectors, and optical relay structures for transmitting light from the light. source to the sample (or optional reference detector) and from the sample to the sample photodetector in apparatus 350 collectively comprise a photoluminescence optical system 66. These components are described in detail in a subsequent section entitled “Photoluminescence Optical System.” Generally, light source 351 should produce light that is either intensity modulated or capable of being intensity modulated. Examples of suitable light sources include arc lamps, light-emitting diodes (LEDs), and laser diodes. Generally, detectors 358a,b should detect light and convert it to a signal that can be used to count the number of photons in the detected light. Examples of suitable detectors include photon-counting photomultiplier tubes and avalanche photodiodes.

The discriminator converts the output of the photodetector into an output representative of individual detected photons. Here, discriminators 360a,b convert analog pulses created by detectors 358a,b to digital pulses. The discriminator may be selected to create an output signal corresponding only to input signals having amplitudes or other characteristic parameters lying between preselected limits. For example, a lower limit may be set to distinguish individual photon signals from lower-amplitude dark noise. Similarly, an upper limit may be set to distinguish individual photon signals from higher-amplitude noise reflecting instrument anomalies and/or multiple-photon events. Of course, the lower limit may be set to zero and/or the upper limit set to infinite. The discriminator may be a separate component of the sample or reference channel or an integrated part of the detector or count distributor.

The count distributor directs or distributes signals received from the discriminator to one or more counters according to the phase of the incoming signal. The count distributor is interfaced with the frequency source and at described in detail in a subsequent section entitled “Count Distribution Circuit.”

The counter or counters tabulate the number of photons that arrive within a “phase bin” corresponding to a particular portion of a period or range of phase delays, based on information input from the count distributor. The phase bins for different. counters preferably cover different but overlapping ranges. A single counter may be used to perform heterodyning (or homodyning) operations using integrated photon pulses rather than analog charge, as long as the counter does not cover the entire excitation period. Two or more counters may be used to calculate phase and modulation (as described below) using the high-frequency signal. If two counters are used, some signal will be lost. However, if three or more counters are used, the entire signal may be collected.

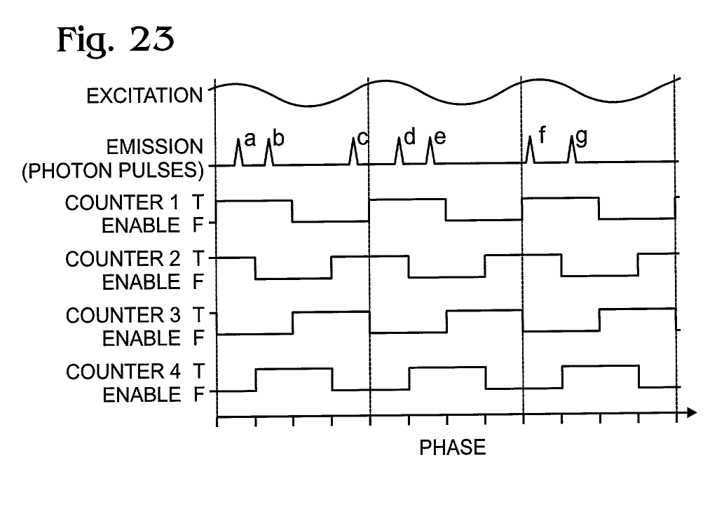

FIG. 23 shows a preferred implementation using four counters. Here, each counter captures photons for half a period, and each counter is delayed relative to the previous counter by 90 degrees. The associated phase bins are defined by counter enable signals within the count distributor. Specifically, a photon pulse will be counted by each counter that is enabled when the pulse arrives. In this example, counter 1 will record 6 pulses (a,b,d,e,f,g), counter 2 will record 4 pulses (a,c,d,f), counter 3 will record 1 pulse (c), and counter 4 will record 3 pulses (b,e,g).

Overlapping bins are convenient electronically and may be used to validate system performance. For example, in FIG. 23, each incoming photon will generate a count in two counters, so that the sum of counts in phase bins 1 and 3 should equal the sum of counts in phase bins 2 and 4.

The number of counted photons may be used to compute a frequency-domain quantity, such as phase and/or modulation, by Fourier transforming the numbers into the frequency domain. The Fourier transform can be used to separate harmonics of the excitation signal, which usually are unwanted, if four or more counters are used. The Fourier transform can be performed using a fast Fourier transform (FFT) algorithm to accelerate analysis, if the number of counters is (or can be numerically “padded” to) an integer power of two.

The Fourier transform of the embodiment in FIG. 23 leads to especially simple results. For example, the in-phase component I of the Fourier transform is the difference between the number of photons counted in phase bins 1 and 3 (equivalent to the Fourier cosine trans torn):

I=θ₁−θ₃ (74)

Here, the number of counts in phase bins 1, 2, 3, and 4 is denoted θ₁, θ₂, θ₃, and θ₄, respectively. Similarly, the quadrature component Q of the Fourier transform is the difference between the number of photons counted in phase bins 2 and 4 (equivalent to the Fourier sine transform):

Q=θ₂−θ₄ (75)

The phase φ is the arctangent of the ratio of the quadrature and in-phase components:

$$φ = arctan ( \frac{Q}{I} ) = arctan ( \frac{{θ}_{2} - {θ}_{4}}{{θ}_{1} - {θ}_{3}} ) \qquad ( 76 )$$

The AC amplitude AC is the square root of the sum of the squares of the in-phase and quadrature components:

AC=\sqrt{I²+Q²}=\sqrt{(θ₁−θ₃)²+(θ₂−θ4)²} (77)

The DC amplitude DC is the total number of photons, given by the sum of the number of photons counted in every phase bin:

DC=θ₁+θ₃+θ₂+θ₄ (78)

The DC amplitude also is given by the sum of the number of photons counted in complementary phase bins, e.g., 1 and 3. or 2 and 4. Finally, the modulation M is the ratio of the AC and DC amplitudes:

$$M = \frac{A C}{D C} = \frac{\sqrt{{( {θ}_{1} - {θ}_{3} )}^{2} + {( {θ}_{2} - {θ}_{4} )}^{2}}}{{θ}_{1} + {θ}_{3} + {θ}_{2} + {θ}_{4}} \qquad ( 79 )$$

The phase and modulation calculated using Equations 76 and 79 are apparent values. not the measured values appearing in Equations 1 and 2. However, the apparent phase and modulation may be “corrected” for instrumental factors giving rise to this difference to yield the measured values, for example, by measuring the apparent phase and modulation for a compound with known lifetime, calculating the correct phase and modulation, and deriving an instrument phase offset and instrument modulation factor. The measured phase will be the difference in the apparent phase and the instrument phase offset. Similarly, the measured modulation will be the product of the apparent modulation and the instrument modulation factor. If the phase bins overlap, Equations 77-79 will include additional normalization constants (for example, overall multiplication factor of 1/2 for the DC equation). These deviations from the above equations will be connected with the instrument calibration (modulation factor), so that the additional constants are not strictly required.

The remainder of this section is divided into four sections: (1) count distributor, (2) photon discriminator, (3) applications to high-throughput screening. and (4) miscellaneous comments. Apparatus implementing these features further may include light sources, optics, sample handling systems, and/or detectors, as described above. In addition, the apparatus may be under computer or processor control to direct sample handling and/or data collection, among others.

B.1 Count Distributor

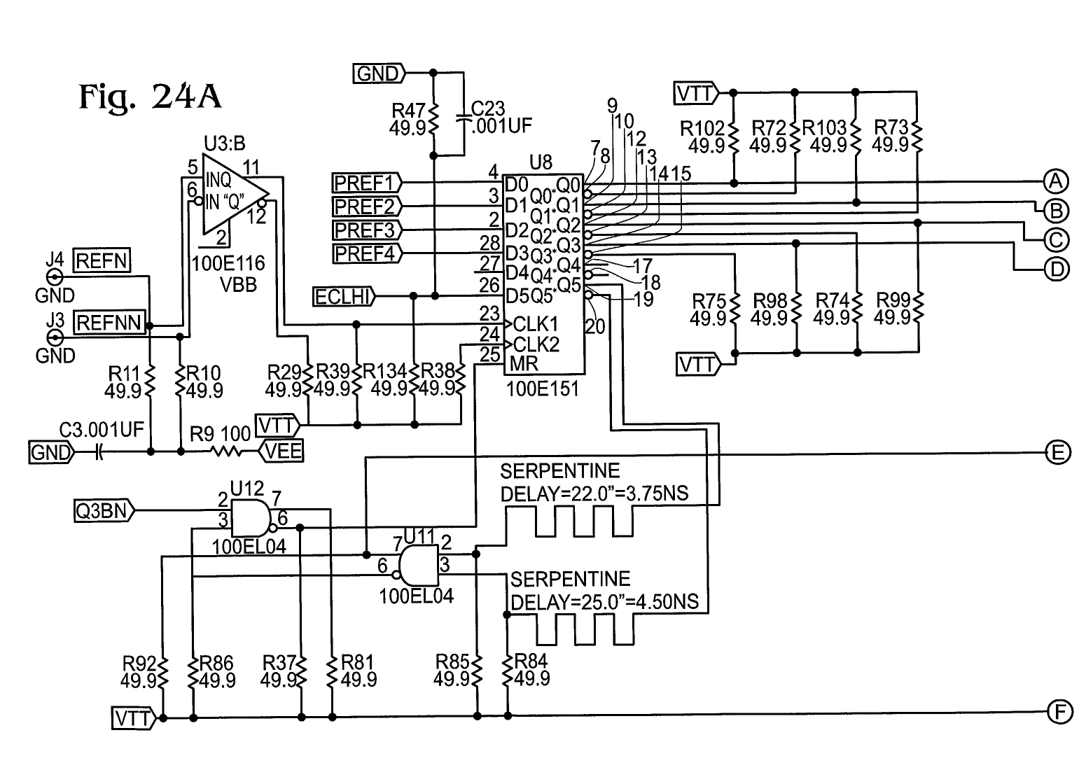

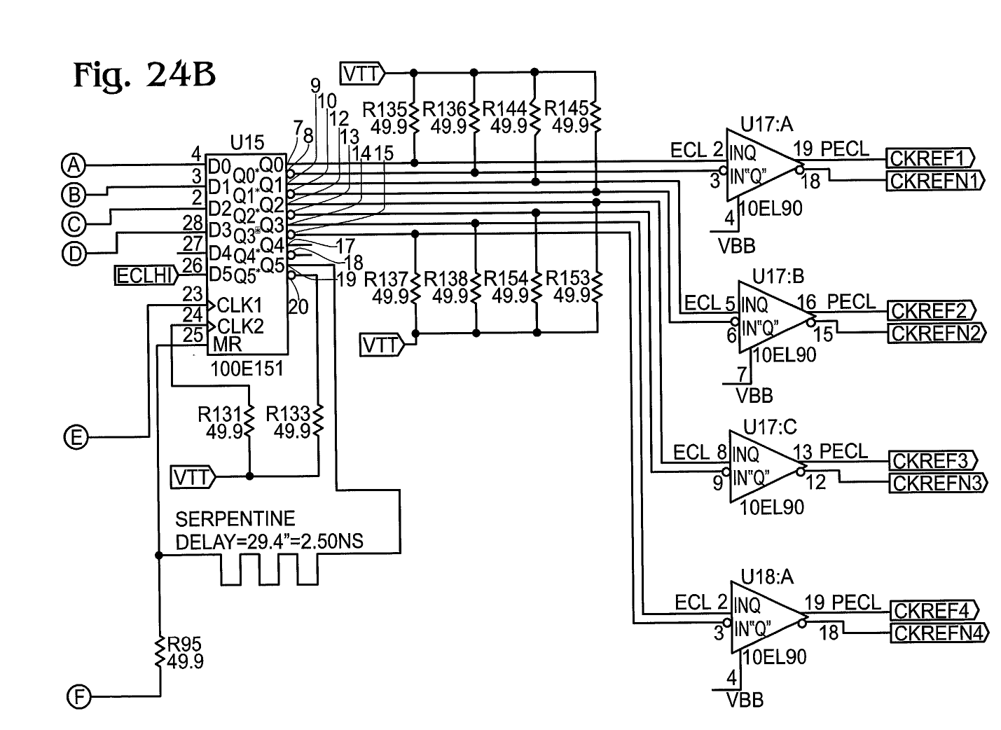

FIG. 24 shows a count distribution circuit for use in the apparatus of FIG. 22. Here, REFIN/FEFINN is the differential signal from he discriminator (i.e., the photon pulse), PREF1-PREF4 are the counter enable signals for the four independent counters/phase bins, and CKREF1-CKREF4 are the differential outputs that go to the four counters. Generally. the count distribution circuit directs photon pulses to one or more counters according to the phase of the incoming pulse. The maximum measurable flux rate and the phase resolution of the circuit are determined by its implementation. In the embodiment in FIG. 24, maximum measurable flux rate is determined by the rate at which the circuit processes pulses, and phase resolution is determined by the jitter in the circuit's high-frequency electronics. These and other issues, relating to the count distribution circuit are described below.

B.1.a Maximum Average Flux Rate

In the CLIP technique, individual photon pulses and the clock that determines phase are asynchronous. Statistically, the distribution of photons will follow the excitation profile, but individual photons will have no predictable correlation with the excitation. A problem in processing asynchronous signals such as these is metastability of the associated digital electronics. For example, if the two signals arrive at a component without obeying its setup and/or hold times, the component will not output a valid level within the specified propagation delay. To avoid this problem, the two signals can be synchronized using a synchronization circuit. In this way, metastability issues may be handled by the synchronization circuit so that other circuit elements will not be affected by metastability (i.e., so that all setup and hold times will be obeyed).

The synchronization circuit includes two cascaded flip-flops. The second flip-flop is wired to accept the output of the first flip-flop after a preset delay. This delay is long enough for the first flip-flop to settle to a valid state even when the setup or hold times are not met. The embodiment in FIG. 24 includes a 4 nanosecond metastable delay (wait time) so that the associated Motorola™ 100E151 flip-flop will have a mean time between failures of about 130 years (according to the associated Motorola application note AN1504). Generally, the rate of flip-flop failure increases exponentially with decreasing delay. For example, reducing the metastable delay from 4 nanoseconds to 3.8 nanoseconds will decrease the mean time between failures from about 130 years to about 11 years.

The metastability delay sets the pulse pair resolution (PPR) of the count distinction circuit. In particular, while the synchronization circuit is active. no photons can be counted. Ultimately, the PPR limit will be the metastability delay plus a small amount of time to complete a full transition cycle. In the count distribution circuit in FIG. 24, the PPR is limited to about 5 nanoseconds. The preferred embodiment directs the photon pulses into the clock input of the synchronization flip-flop rather than to the data input. In this way, the circuit is atone to count multiple photons it) during a long on-cycle of a phase bin (high photon flux and low modulation frequency). The number of photons that can be collected during a single on-cycle of a phase bin is only limited by the dead time, and not by the modulation frequency.

B.1.b Phase Resolution

The phase resolution of typical phase and modulation fluorometers is about 0.1 degrees. Analog detection in these fluorometers normally does not permit measurements based on few photons, so that measurements normally are limited by the electronics. The CLIP technique, however, has a phase resolution that is limited primarily by the number of photons and secondarily by the electronic jitter of the phase bins. The number of phase bins does not limit the phase resolution; however, it does contribute to harmonic aliasing.

When the number of photons is small, the statistical uncertainty in the number of counts measured in each phase bin will determine the uncertainty in the Fourier transformed quantities. For example, if the intensities each have an uncertainty of 0.1% (10⁶ photons collected), the phase uncertainty will be about 0.2% (two times greater than the intensity) or 0.1 degrees (0.002 radians). If the target maximum average flux rate is 10 million counts per second and the target integration time is 100 milliseconds, the maximum expected number of photons measured for a single ample will be about 10⁶. Therefore, the limiting phase resolution will be about 0.1 degrees for high-throughput applications. Higher phase resolutions are achievable by increasing the integration time.

The phase resolution also will be limited by the electronic jitter of the phase bins—the uncertainty in the bin width. In the count distribution circuit in FIG. 24, the expected timing error is about 10 picoseconds. This uncertainty is equivalent to about 1 degree at 300 MHz. At high frequencies, the electronic jitter is expected to be the dominant determinant of the phase resolution of the CLIP technique.

B.2 Photon Discriminator

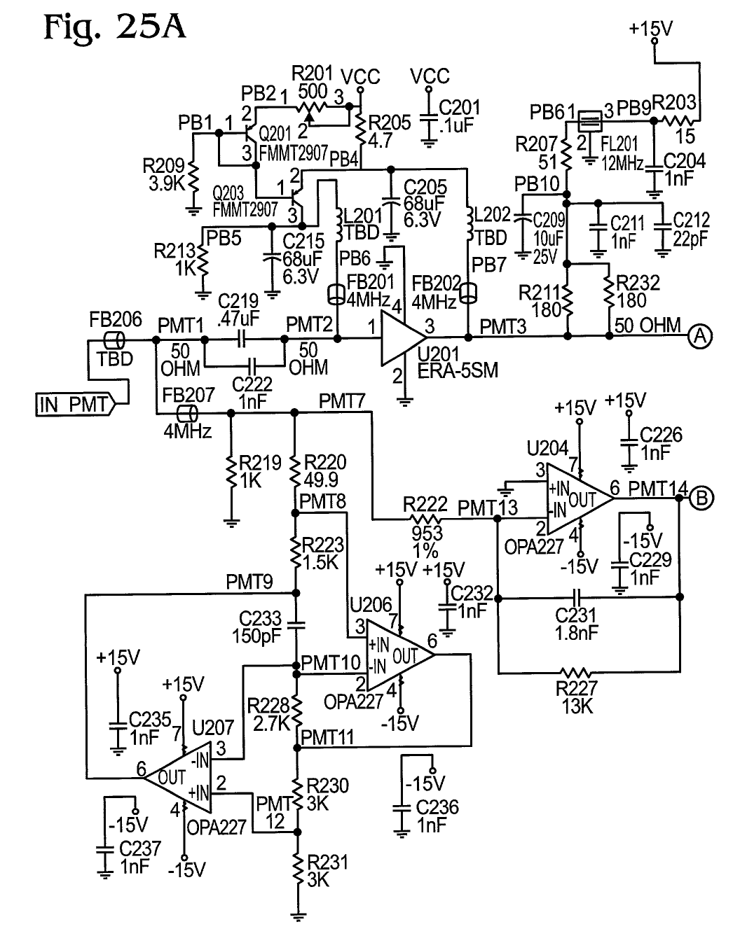

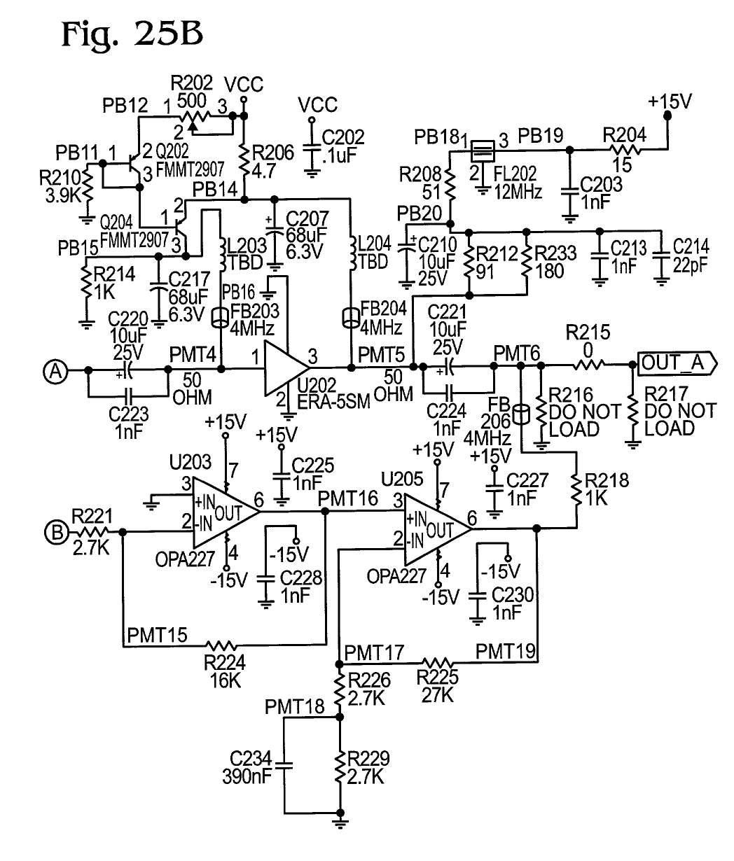

FIGS. 25-28 show components of a photon discriminator for use in the apparatus of FIG. 22. Generally, the discriminator converts the output of the photodetector into an output representative of individual detected photons. the performance of the discriminator may be characterized, by phase error, dead time, and jitter, which are largely determined by implementation. This section describes a preferred discriminator, which may be termed a high-speed, wide-bandwidth, low-jitter, low-dead-time constant-fraction discriminator.

Phase error is error in assigning a photon to a proper phase bin. To reduce phase error in the measurements, the timing of the pulses from the discriminator should accurately represent the time of arrival of the emitted photons at the photodetector, which (in this embodiment) is a photomultiplier tube (PMT). Two alternative characteristics that reduce phase error are low jitter (high temporal precision) and random timing error (which reduces error by integrating many photons). The simplest approach to timing the photons would be to signal the time when the output amplitude of the photodetector passes a certain threshold (i.e., constant-threshold detection). However, due to variations in the electronic gain of the detector with the wavelength of the photon and the arrival position of the photon on the photoactive area, (e.g., the photocathode) of the detector, among other factors, the height of the electrical pulses from the PMT can vary by more than a factor of 5. The peak of the single photon pulse is the most accurate measure of the arrival time of the photon. However, timing the photon pulses with a constant-threshold discriminator will lead to timing jitter just due to the variability ill pulse height. A preferred mechanism for maintaining a fixed relationship between the trigger point and the time-of-arrival of the photon that caused the pulse is to use a constant-fraction discriminator. This device measures the arrival time of a photon pulse at a constant fraction of the pulse height.

Dead time is the time after receiving a first photon pulse during which the discriminator is unable to receive a second photon pulse. To reduce dead time, the discriminator should recover from a pulse and be ready for a subsequent pulse as quickly as practical. If successive pulses are not to overlap, the pulses should be very short, which means in turn that the PMT and circuit should be very fast (or, equivalently, have fast rise and fall times).

Jitter is instability of a signal in terms of phase, amplitude, or both. To reduce jitter, signals should have low electrical noise and high edge rates, since the root-mean-squared (rms) jitter=(rms noise)/(edge slope), where the edge slope is dv/dt. High edge rates again imply fast circuits.

The discriminator preferably should be able to handle both high and low frequency inputs. Because detected emission light may be modulated at frequencies of up to or over about 250 MHz. and because the pulse width from, the PMT can be is low as 1.6 nanoseconds, the circuit frequency response should extend up to approximately 1 GHz. Moreover, because the incoming photons may arrive at fewer than 1000 photons/second, the low frequency response should extend down to below about 100 Hz to keep the signal decay of one pulse from overlapping with and changing the trigger location of a following pulse. In the chosen implementation, the constant-fraction discriminator is preceded by a constant-level discriminator, which is sensitive to DC shifts. Additionally, if the circuit has response down to DC, it is possible to determine overload conditions (excessive pulse rate) much more easily. It was therefore decided to extend the low frequency response down to DC.

FIG. 25 shows a preamplifier circuit for use in the discriminator. Here, microwave gain blocks (U201, U202) are used to achieve high bandwidth. These gain blocks have a low-frequency cutoff determined by the chosen blocking capacitors. To provide response down to DC, a second circuit path is provided, and the signal is split between tee two paths at the input and recombined at the output. To split and recombine the signal while maintaining the pulse shapes, both amplitude and phase response should be uniform across the split. Several features of the circuit maintain this uniformity.

a. The splitter should be first-order so that there are no phase anomalies when the signals are recombined.

b. A split frequency of approximately 10 kHz was chosen. This is low enough that the additional phase shift in the op-amps in the low frequency path (due to finite gain-bandwidth) is small.

C. The interstage and output capacitors in the high-frequency path (C220 and C221) are 20 times the value of the capacitor in the splitter (C219), so that they contribute small amounts of additional phase shift.

d. A gyrator composed of R223, C233, R228, R230, R231, U206 and U207 simulates a 0.6 mH inductor. A real inductor could have multiple self-resonances that would cause serious phase and amplitude disturbances. This simulated inductor combined with R220, C219, C222, and the 50-ohm input impedance of U201 form a first order splitter.

e. The low-frequency path does not receive input from the splitter (because the simulated inductor should be grounded), but rather has a high impedance input (through R222) and a single pole roll-off using C231 and R227.

f. The combining is done after the blocking capacitor of the last gain block, at the input to the next stage junction of C221, R218, and R215). Since the voltage divider is formed by R218 the output impedance of U202, and the input impedance of the following stage (50 ohms) includes C221, the voltage divider ratio is approximately 40:1 at higher frequencies and 20:1 at lower frequencies (where C221 acts like an open circuit). The network of R226, R229, and C234 compensates for this effect.

g. The gain in both paths is matched. The overall gain is approximately 100.

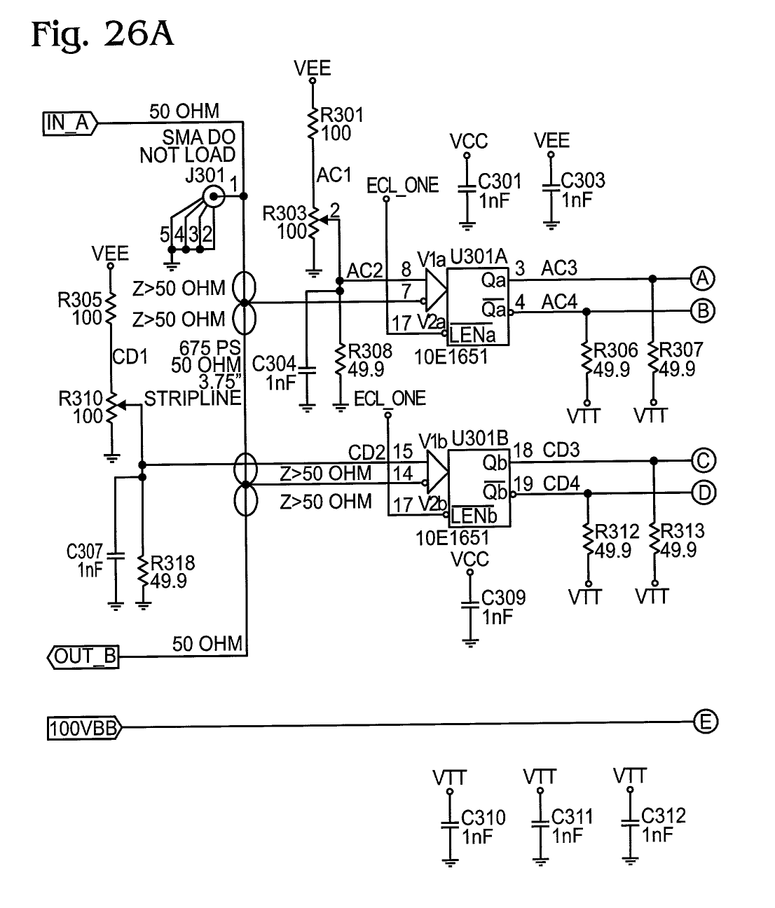

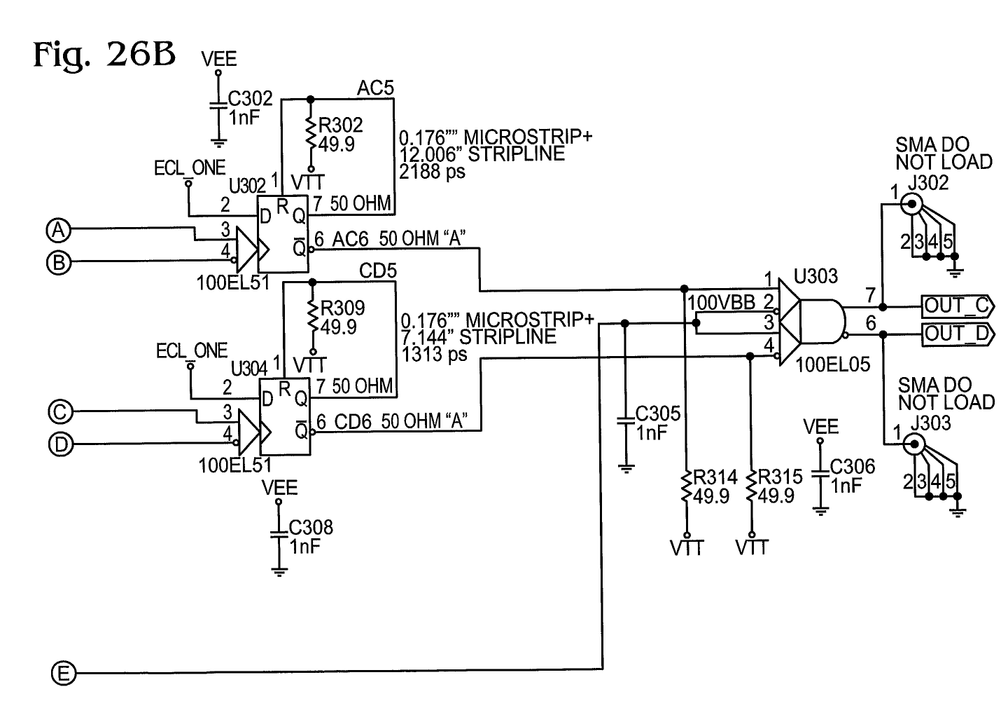

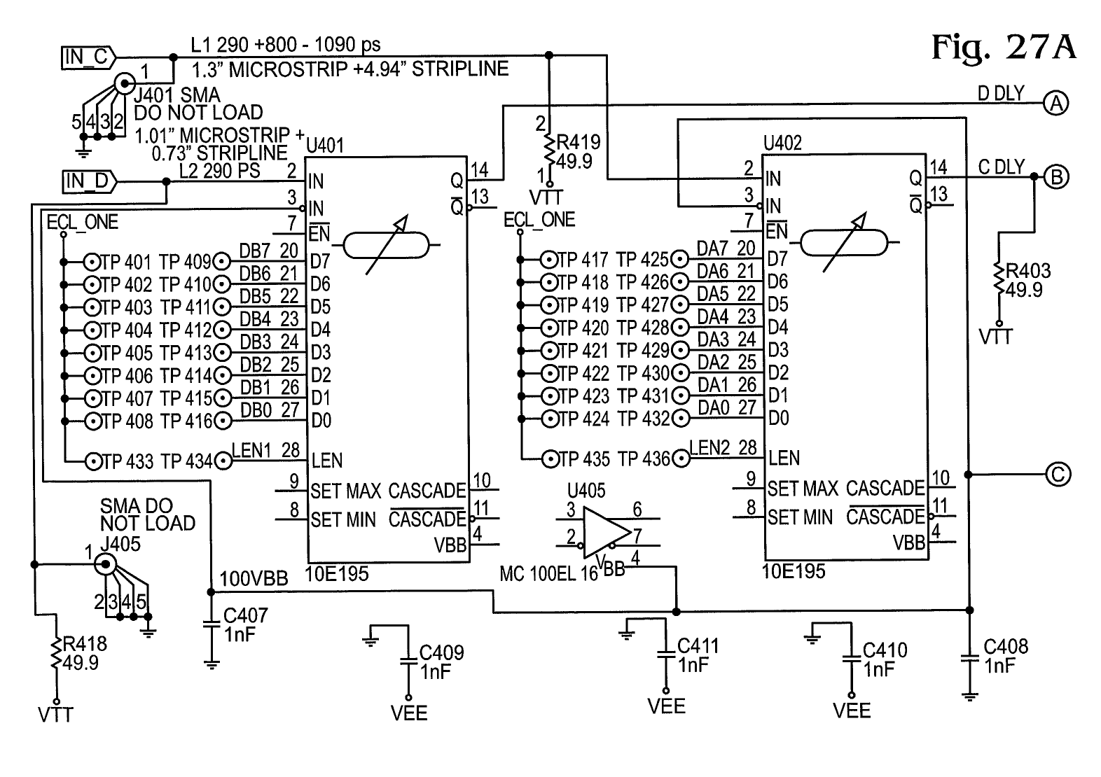

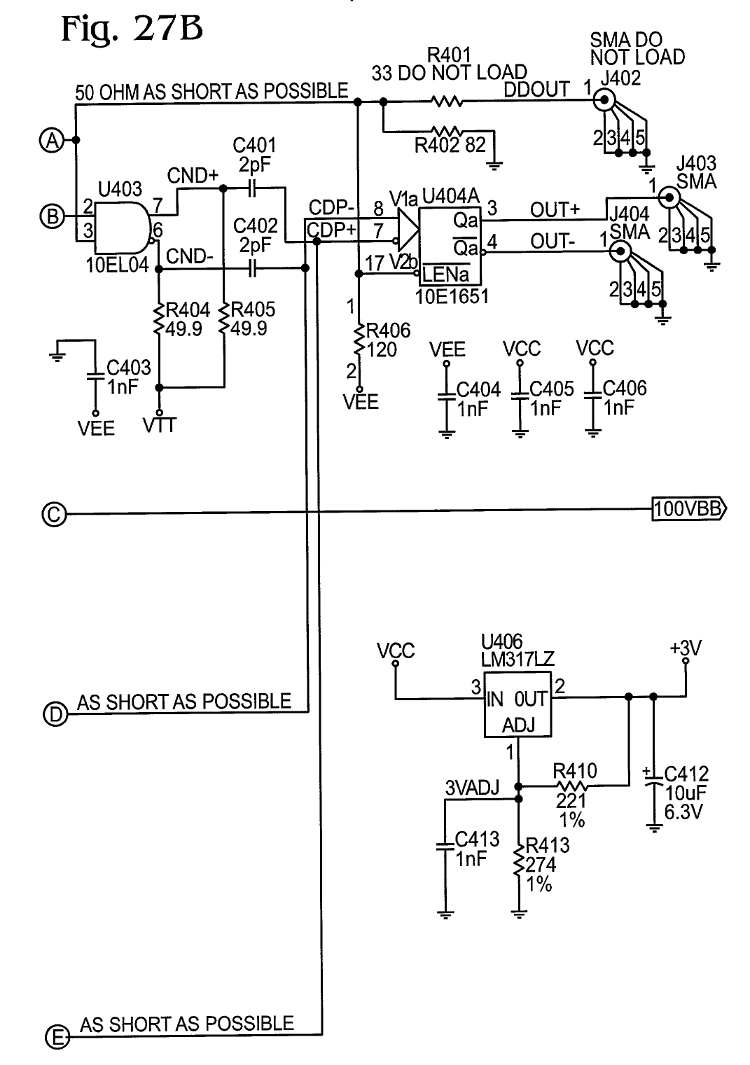

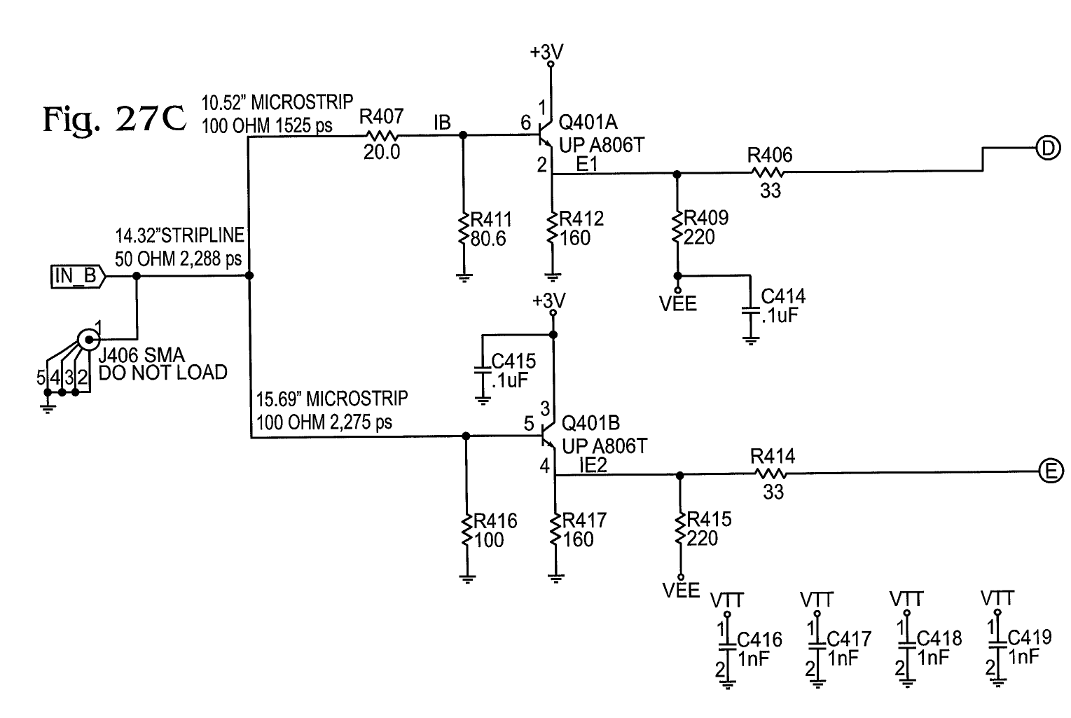

FIG. 26 shows a constant-level discriminator for use in the discriminator. This circuit provides the timing signals for the constant-fraction discriminator (shown in FIG. 27) and eliminates pulses whose amplitude is too high. The basic signal flow is:

a. The pre-amplified pulses (nominal amplitude 500 mV) come in at IN_A on a 50-ohm transmission line. They pass by the (−) input of comparator U301A, continue on past the (−) input of comparator U301B, and then exit to FIG. 27 at OUT_B.

b. When a pulse exceeds the threshold set by R310, U301B sends a differential pulse whose length depends on the pulse amplitude to the clock input of U304. U304 is configured to then create an output pulse whose length is determined by the sum of its gate delay and the length of line CD5. This creates a nominal 1.6 nanosecond pulse, which is sent to U303.

c. When a pulse exceeds the threshold set by R303, U301A sends a differential pulse whose length depends on the pulse amplitude to the clock input of U302. U302 is configured to then create an output pulse whose length is determined by the sum of is gate delay and the length of line AC5. This creates a nominal 2.5 nanosecond pulse, which is sent to U303. The threshold set by R303 is set higher than R310, so that U301A only triggers on “double” pulses (when two pulses have landed on top of each other), which are undesirable because they cannot be accurately timed.

d. Because U301A is triggered before U301B (since the input signal arrives at it 675 picoseconds sooner), and it is longer, if it is triggered, it will produce a pulse that will completely overlap the pulse from U301A. The inputs of U303 are arranged so that if this happens, no pulse will be output from U303, thus eliminating “double height” pulses.

e. Finally, OUT_C and OUT_D form a differential pulse signal of approximately 1.6 nanosecond length, and with a fixed delay from the preamplified PMT output.

FIG. 27 shows a constant-fraction discriminator (CFD) for use in the discriminator. The output signals from the constant-level discriminator are used as gating pulses to the actual constant-fraction discriminator (CFD), determining a window when it is “armed.” There are several interesting features of the CFD design:

a. Both signals go through selectable delays (U401 and U402) for fine-tuning of the exact delay relative to the analog signal (OUT_B), as well as the differential delay between C_DLY and D_DLY. In addition, D_DLY is inverted.

b. D_DLY is used to enable the constant-fraction discriminator, U404A.

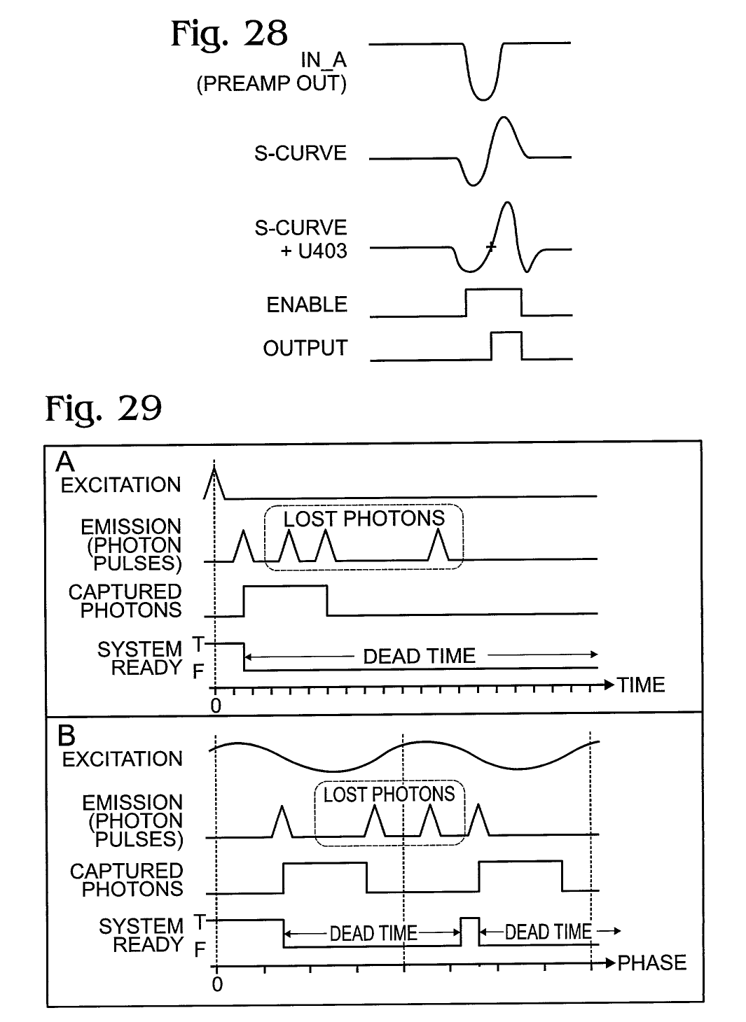

c. The negative-going analog signal (now called IN_B) is split through two different delays, individually attenuated, and buffered by Q401A and Q401B. The difference between these buffered signals is taken by the first stage of the comparator U404A. Because of the relative amplitude and delay, as shown in FIG. 28, an S-curve results, with the zero-crossing at a constant fraction of the input signal.

The comparator trips at the zero-crossing, so this circuit can form a CFD if the comparator is enabled and disabled at the correct times, and the signal state is guaranteed at these times. In other words, the following sequence should occur:

a. The output of the comparator starts low.

b. The negative input of the comparator is above the positive input.

c. The comparator is enabled (no change of state will occur).

d. The positive input of the comparator rises above the negative input. As mentioned in c. above, this is the zero-crossing we seek to detect. This will cause the comparator output to go high.

e. The positive input of the comparator drops below the negative input, causing the comparator output to go low.

f. The comparator is disabled, and we are prepared for step one again.

Conditions 2 and 3 are assured by adjusting the timing such that the D_DLY signal enables the comparator during the initial, negative portion of the S-curve. Condition 4 comes directly from the S-curve. Condition 5 is met by U403 and C401 and 402, which create edges that are timed to drive the comparator inputs in the desired direction. Small capacitors are used to couple the signals in for two reasons: (1) to eliminate any DC effects that could shift the threshold, and (2) to make sire any DC effects die away quickly enough that they do not affect the next pulse to be counted. Condition 6 is assured by correct adjustment of the timing of the U403-C401-C402 edges and the trailing edge of the D_DLY signal. The gate delays and transmission line lengths are comparable to the desired delays and pulse widths, so they should be taken into account in design.

B.3 Applications to High-Throughput Screening

High-throughput screening (HTS) is used to search large libraries of compounds for compounds that will interact effectively with a target. These few compounds may then be used as leads for further analysis on the road to drug discovery. Recently, the number of library compounds and targets for screening has increased dramatically. In particular, the number of library compounds is now in the hundreds of thousands. This increase in number and the concomitant need to improve screening throughput have led to a need for industrial-strength analytical methods with a low cost per assay. In particular, HTS assays should satisfy three primary criteria, as follows.

First, HTS measurements should be rapid. To screen libraries containing hundreds of thousands of compounds, the measurement time per sample should be small (less than 100 milliseconds), and the number of replicates, controls, and background samples should be a minimum.

Second, HTS measurements should be inexpensive, because the cost of each assay must be multiplied by the typically significant number of such assays that must be performed. To reduce reagent costs, required amounts of library compounds should be lo kept to a minimum. Thus, 14TS apparatus and methods should be capable of detecting low concentrations of compound. For example, in HTS binding assays, a low label concentration is about 0.5 nanomolar, which is primarily determined by binding affinity.

Third, HTS measurements should be precise (low error), accurate (small deviations from correct values), and robust (insensitive to common interferences). Robustness is particularly important, especially as assay volume is reduced, because interferences can cause a high false hit rate. Typical hit rates for well-designed assays may be less than about 1% of the compounds tested, whereas false hit rates may be several percent. All hits (true or false) must be sent on to secondary screening to determine which are actual leads.

The apparatus and methods provided by the invention may satisfy some or all of these HTS criteria. For example, photon-counting frequency-domain measurements can be used at low light levels due to their enhanced sensitivity, which may reduce reagent requirements. Moreover, photon-counting frequency-domain measurements can be relatively insensitive to dark noise, background luminescence, scattering, absorption, and/or quenching, which may improve precision, accuracy, and robustness.

The apparatus and methods provided by the invention can be used with apparatus, methods, and compositions described in the above-identified patent applications. which are incorporated herein by reference. For example, the apparatus and methods can be used with high-sensitivity luminescence apparatus and methods, including those described above and/or in U.S. patent application Ser. No. 09/062,472, filed Apr. 17, 1998, U.S. patent application Ser. No. 09/160,533, filed Sep. 24, 1998, and U.S. patent application Ser. No. 09/349,733, filed Jul. 8, 1999. The apparatus and methods also can be used with sample holders, designed for performance with the above-identified high-sensitivity luminescence apparatus and methods, including those described in U.S. patent application Ser. No. 09/478,819, filed Jan. 5, 2000. These sample holders may reduce the required amount of reagent (or library compound) per assay by using a smaller volume. A well in a typical 96-well HTS plate can hold 300 microliters, with typical assay volumes lying between 100 and 200 microliters. In contrast, a well in a 1536-well high-density HTS plate can hold up to 10 microliters, with low-volume assays using 5 microliters or less. Consequently, apparatus and methods that permit screening with low-volume samples may lead to 95% or greater reductions in reagent cost.

B.4 Miscellaneous Comments

The apparatus and methods provided by the invention may have several advantages over standard frequency-domain methods, reflecting in part (1) photon-counting detection, (2) enhanced detection duty cycle, and/or (3) intrinsic measurement of phase and modulation.

Photon counting is the digital tabulation of the number of detected photons, in contrast to the analog integration of a current resulting from the detection of photons. Photon counting may reduce dark noise by counting higher-level pulses corresponding to individual photons but ignoring lower-level signals corresponding to dark current that would otherwise contribute to an integrated analog signal. The use of photon counting in the invention may improve sensitivity by a factor of two or more, relative to standard (i.e., analog) frequency-domain methods.

Detection duty cycle is the fraction of time that the detector can process a photon. A high detection duty cycle may improve speed and resolution, because the detector will be available to detect a higher fraction of the transmitted light. The use of ungated i.e., always on) detection in the invention increases the detection duty cycle to about 100%, in contrast to the use of gated detection in the standard heterodyne method, which reduces the detection duty cycle to less than about 50%.

The intrinsic measurement of phase and modulation provides a more robust signal than provided by standard frequency-domain methods, which rely on intermediate measurements of intensities. Such intrinsic measurement may be accomplished rising a direct single-frequency lock-in. A single frequency may be used for both excitation and detection. The use of a single oscillator is a significant practical improvement, because it is easier to implement than the two phase-locked frequency sources required for heterodyne fluorometry. The CLIP method measures phase and modulation without heterodyning or traditional homodyning. Moreover, the outputs may be digital and therefore not subject to the DC noise and drift that can accompany homodyne fluorometry.

The apparatus and methods provided by the invention also may share the advantages of standard frequency-domain methods over time-domain methods, reflecting in part enhanced excitation duty cycle. The excitation duty cycle is the fraction of time that the system is illuminated. The use of sinusoidal excitation as described here increases the excitation duty cycle to about 50%, in contrast to the pulse excitation in time-domain methods that reduces the excitation duty cycle to less than about 0.1%.

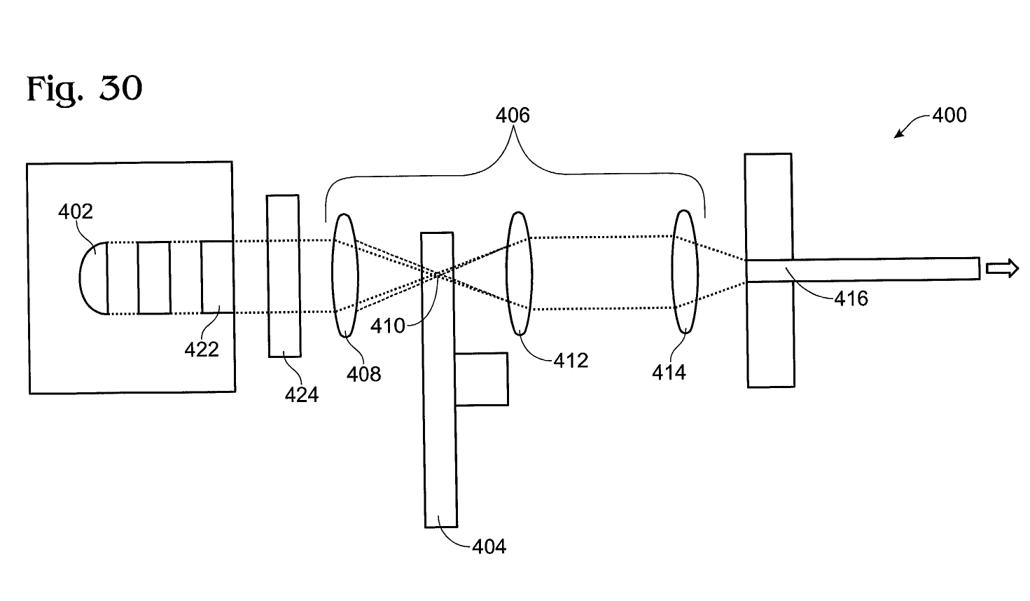

The apparatus and methods provided by the invention also have one primary disadvantage: a limited maximum flux rate. The maximum flux rate is the maximum number of photons that can be detected per unit fi me. The maximum flux rate is determined by the electronic pulse-pair resolution (PPR) and the probabilities of receiving a second photon within the detector dead time. The PPR is the minimum time between impinging photons required for the signal from the photons to be just resolvable by the apparatus as arising from two photons. The detector dead time is a period after detection of a photons during which the detector cannot detect a second photon. The maximums flux rate provided by the invention appears to be at least about 10 millions counts per second. in contrast to about 100 thousand counts per second for time-domain techniques. This 100-fold improvement may reflect a decreased PPR and a decreased sensitivity to lost photons. The PPR is reduced to less than about 10 nanoseconds, in contrast to greater than about 100 nanoseconds for the best time-domain apparats. In addition, the CLIP technique is less sensitive to lost photons because they do not appear to change the measured distribution. FIG. 29 shows a possible exploitations for this increased sensitivity. In the time domain (Panel A), photons lost in the dead time will always have a greater delay than the measured photon. The lost photons therefore skew the lifetime measurement to shorter values. To avoid this error, the maximum (average) flux rate should be less than one one-hundredth of the peak flux rate (the inverse of the PPR), or about 100 thousand counts per second. In contrast, in the frequency-domain technique provided by the invention (Panel B), photons with long delays that are preferentially lost can correspond to a phase delay shorter or longer than the first photon. For example, a lost long-delay photon could have arrived in the next period with a lesser phase delay.

The CLIP apparatus and method may be distinguished from synchronous photon. counting (or the digital lock-in technique), which is typified by the Stanford Research Systems SR400 dual channel gated photon counted. Synchronous photon counting is used to subtract dark counts automatically from a photon-counted signal. In particular, the luminescent system is excited with a pulse of light at a low repetition rate (typically from an optical chopper). The photon counter sums all counts that arrive while the system is illuminated and subtracts all counts while it is not. If the duration of summation is equal to the duration of subtraction. the dark counts of the photodetector will be properly subtracted from the emission signal. The output is the dark-subtracted intensity of the luminescent system. The synchronous photon counting technique is not used to measure luminescence lifetime, even for extremely long lifetimes. Apparatus for synchronous photon counting systems could be converted in a limited way to CLIP only by adding key CLIP components.

C. Examples

Additional and/or alternative aspects of the invention are described without limitation in the following numbered paragraphs:

1. A method for measuring a temporal property of a luminescent. sample, the method comprising (A) illuminating the sample with intensity-modulated incident light, where the modulation is characterized by a characteristic time; (B) detecting luminescence emitted from the sample in response to the illumination with incident light; (C) counting the number of photons in the detected luminescence during a preselected portion of the characteristic time; (D) computing a frequency-domain quantity base(d on the number of counted photons; and (E) determining the temporal property based on the frequency-domain quantity.

2. The method of paragraph 1, where the temporal property is a luminescence lifetime or a reorientational correlation time.

3. The method of paragraph 1, where the intensity of the incident light is modulated periodically with time, and where the characteristic time is the period of the modulation.

4. The method of paragraph 3, where the incident light is modulated sinusoidally.

5. The method of paragraph 3, where the period is less than about 10 milliseconds.

6. The method of paragraph 1, where the detected luminescence is detected substantially exclusively from a sensed volume of the sample.

7. The method of paragraph 1, where the detected luminescence is detected throughout the characteristic time.

8. The method of paragraph 1, where the steps of illuminating and detecting are performed simultaneously.

9. The method of paragraph 1, where the preselected portion is at least one-eighth of the characteristic time.

10. The method of paragraph 1, the preselected portion being a first preselected portion, further comprising counting the number of photons in the detected luminescence during a second preselected portion of the characteristic time. where the first and second portions correspond to at least partially different portions of the characteristic time.

11. The method of paragraph 10, where the first and second portions overlap.

12. The method of paragraph 10, where the first and second portions do not overlap.

13. The method of paragraph 1, further comprising counting the number of photons in the detected luminescence during additional preselected portions of the characteristic time, where the total number of portions is an integer power of two.

14. The method of paragraph 1, where the step of counting the number of photons includes the steps of converting the detected luminescence to a signal, and discriminating photons from noise based on their relative contributions to the signal.

15. The method of paragraph 1, where the frequency-domain quantity is a phase shift and/or a demodulation of the detected luminescence relative to the incident light.

16. The method of paragraph 1, where the step of determining the temporal property includes the step of correcting for intensity variations in the light source.

17. The method of paragraph 1, where the step of determining the temporal property includes the step of correcting for instrumental factors.

18. The method of paragraph 1, further comprising repeating the steps of illuminating, detecting, and counting with the same sample before determining the temporal property, where the number of counted photons used to compute the frequency-domain quantity is the sum of the number of photons counted in each repetition of illuminating and detecting.

19. The method of paragraph 1, further comprising automatically repeating the steps of illuminating, detecting, counting, and determining the temporal property with a series of samples.

20. An apparatus for measuring a temporal property of a luminescent sample, the apparatus comprising (A) a light source for producing intensity-modulated excitation light; (B) an excitation optical relay structure that directs the intensity-modulated excitation light toward the sample, so that the sample may be induced to emit intensity-modulated emission light; (C) a detector for detecting light; (D) an emission optical relay structure that directs light from the sample toward the detector, so that intensity-modulated emission light from the sample may be detected; and (E) a discrete analyzer operatively connected to the detector, where the analyzer includes a counter that determines the number of photons in the detected emission light, and where the analyzer determines the temporal property based on a frequency-domain quantity computed from the number of photons.

21. The apparatus of paragraph 20, where the temporal property is a luminescence lifetime or a reorientational correlation time.

22. The apparatus of paragraph 20, where the excitation light is modulated sinusoidally.

23. The apparatus of paragraph 20, where the frequency-domain quantity is a phase shift and/or a demodulation of the detected luminescent relative to the incident light.

24. The apparatus of paragraph 20, where the discrete analyzer is configured to. correct for at least one of the following: intensity variations in the light source, and instrumental factors.

25. The apparatus of paragraph 20, where the emission optical relay structures is capable of transmitting light substantially exclusively from a sensed volume of the sample.

26. A method for measuring a temporal property of a luminescent sample, the method comprising (A) illuminating the sample with intensity-modulated incident light capable of exciting luminescence in the sample, where the modulation of the intensity-modulated light is characterized by a characteristic time; (B) measuring luminescence emitted from the sample during first and second preselected portions of the characteristic time, where the first and second portions overlap; and (C) determining the temporal property based on the measured luminescence during the first and second portions.

27. The method of paragraph 26, where the temporal property is a luminescence lifetime or a reorientational correlation time.

28. The method of paragraph 26, where the step of measuring luminescence includes tee step of counting the number of photons in the detected luminescence.

29. The method of paragraph 26, where the step of measuring luminescence includes the step of performing an analog integration of a signal proportional to tale number of photons in the detected luminescence.

30. The method of paragraph 26, where the step of determining the temporal property includes the step of computing a frequency-domain quantity.

The method of paragraph 30, where the frequency-domain quantity is a phase shift. and/or a demodulation of the detected luminescence relative to the incident light.

32. The method of paragraph 26, further comprising measuring luminescence emitted from the sample during additional preselected portions of the characteristic time, where the total number of portions is an integer power of two.

33. An apparatus for measuring a temporal property of a luminescent sample, the apparatus comprising (A) a light source for producing intensity-modulated excitation light; (B) an excitation optical relay structure that directs the intensity-modulated excitation light toward the sample, so that the sample may be induced to emit intensity-modulated emission light, (C) a detector for detecting light; (D) an emission optical relay structure that directs light from the sample toward the detector, so that intensity-modulated emission light from the sample may be detected; and (E) a discrete analyzer operatively connected to the detector, where the analyzer is configured to measure light emitted from the sample during overlapping intervals and to determine the temporal property based on the measured light.

34. The apparatus of paragraph 33, where the temporal property is a luminescence lifetime or a reorientational correlation time.

35. The apparatus of paragraph 33, where the discrete analyzer is configured to determine the temporal property based on a frequency-domain quantity computed using the measured light.

36. the apparatus of paragraph 33, where the frequency-domain quantity is a phase shift, and/or a demodulation of the detected luminescence relative to the incident light.

### VI, Frequency-modulation Systems

This section describes apparatus and methods for producing and/or using time-modulated excitation light in accordance with aspects of the invention. The apparatus may include one or more mechanical choppers, among others. The methods may include frequency-domain time-resolved spectroscopic measurements of luminescence lifetimes and/or reorientational correlation times, among others.

These and other aspects of the invention are described ill detail below, including (A) background, (B) description of apparatus, (C) description of methods, and (D) examples. This disclosure is supplemented by the patents, patent applications, and publications identified above under Cross-References, particularly U.S. Provisional Patent Application Serial No. 60/094,276, filed Jul. 27, 1998; and U.S. patent application Ser. No. 09/765,874, filed Jan. 19, 2001. These supplemental materials are incorporated herein by reference in their entirety for all purposes.

A. Background

Time-resolved luminescence assays generally use time-modulated excitation light, as described above. Some light sources inherently produce time-modulated light, so that they may be used without an optical modulator for time-resolved assays; examples include flash lamps and pulsed lasers. However, these sources have a number of shortcomings, including typically low repetition rates, meaning that they are off most of the time. Measurement times in time-resolved luminescence assays employing these sources can exceed 1 second, particularly if high sensitivity is required. Measurement times can be even longer if more information is extracted from the time decay signal, for example, by using multiple integration windows and/or more complex signal processing algorithms and strategies. Conventional flash lamps have pulse widths of about 1 microsecond, and so can only be, used with difficulty to measure lifetimes less than about 1 microsecond. Pulsed nitrogen lasers are expensive and have a limited spectral output.

Other. light sources do not inherently produce time-modulated light, so that they gene rally must be used with an extrinsic optical modulator for time-resolved assays; examples include continuous arc lamps and incandescent lamps. Continuous light sources, especially continuous xenon arc light sources, may provide a higher signal-to-noise ratio in a given measurement time than flash lamps or at least some pulsed lasers. A preferred continuous light source is a continuous high color temperature xenon arc lamp. The xenon lamp has a broad spectrum output, which may be filtered as described above to generate substantially monochromatic light. A continuous xenon arc lamp produces a 10-100 fold higher photon flux than a xenon flash lamp, even with short (e.g., millisecond) integration times. (Xenon flash lamps have a higher peak photon flux than continuous arc lamps; however, their low repetition rate results in a lower average photon flux delivered to the sample.). Because the signal-to-noise ratio is proportional to the square root of the number of photons delivered, the signal-to-noise ratio obtained with continuous arc lamps is 3-10 times higher than the signal-to-noise ratio obtained with flash lamps. Thus, measurement times using an arc source can be as low as 100 milliseconds or lower.

B. Description of Apparatus

FIG. 30 shows a portion 400 of an apparatus for producing time-modulated excitation light in accordance with aspects of the invention, including a light source 402, an optical modulator 404, and for using optics 406.

Light source 402 generally includes any light source configured to produce light for optical spectroscopy. The light source may be continuous, pulsed, or modulated, among others. Suitable light sources, include arc lamps, incandescent lamps, fluorescent lamps, light-emitting diodes, electroluminescent devices, lasers, and laser diodes, among others.

Optical modulator 404 generally includes any device configured to modulate incident light. The optical modulator may be acousto-optical, electro-optical, or mechanical, among others. Suitable modulators include acousto-optical modulators, Pockels cells, Kerr cells, liquid crystal devices (LCDs), chopper wheels, tuning fork choppers, and rotating mirrors, among others. Mechanical modulators may be termed “choppers,” and include chopper wheels, tuning fork choppers, and rotating mirrors.

Some optical modulators may be configured to produce multi-frequency modulation, with up to 100% modulation and no attenuation in the on state; examples include choppers. The net attenuation of a mechanical modulator is determined by the fraction of time that its aperture is clear. The net attenuation of a chopper outputting light having a square-wave modulation varying abruptly between zero and maximum intensity levels is 50%. Mechanical modulators, such as chopping wheels and tuning forks, may have small clear apertures (several millimeters), permitting them to operate at high frequencies. Indeed, conventional mechanical choppers may be used to obtain chopping speeds up to about 10-20 kilohertz or more, allowing accurate lifetime measurements down to about 5-10 microseconds (τₘᵢₙ=tan(30°)/(2πf)) Of less. Special mechanical is choppers, such as dual rotating wheel choppers, may be used to obtain even higher frequencies, up to about 100 kilohertz or more. Alternatively, mechanical choppers may be used at lower chopping speeds, especially for measurements of longer decay times.

A chopper also may be used in steady-state spectroscopic assays, including steady-state intensity and polarization assays. for synchronous detection in conjunction with a lock-en amplifier to reduce background components of the signal. Such background may include ac or dc ambient light and white noise or 60-cycle noise inherent in electronic circuitry.

Focusing optics 406 generally includes any mechanism configured to arrange at least a portion of the light (dashed lines) produced by light source 402 so that it may pass through the modulator for modulation. The focusing optics may include one or more lenses. in portion 400, the focusing optics includes three lenses. A first lens 408 collects substantially collimated light from the light source and focuses it so that it narrows to a waist 410 at a focal point in a focal plane of the lens and then diverges. A second lens 412 collects and collimates the diverging light. A third lens 414 focuses the collimated light from the second lens so that it impinges on a fiber optic cable 416 or other optical component for relay to an examination or measurement site. In other embodiments, the focusing optics may include other lenses and/or optical components, as required or preferred. For instance, if the chopper is relocated adjacent the fiber optic cable, i.e. to the right in FIG. 30, lenses 412 and 414 may be eliminated. In this case, the chopper would be positioned adjacent the focal point, which is positioned at the input of the fiber optic cable. As a result of not being located at the focal point, however, it may be necessary to provide larger apertures on the chopper.

The optical modulator generally may be positioned in any location along the light path in which it may modulate the beam. In portion 400, optical modulator 404 is positioned at or near focal point 410 of focusing optics 406. Light passing through the focal point is narrower, so that the optical modulator can be smaller and still occlude the beam to effect modulation. A smaller modulator uses less space, so that the associated optical device may be smaller. A smaller modulator also may be faster, cheaper, and/or less prone to vibration. In some embodiments, it may be preferable to use a larger modulators in which case the focusing optics may be omitted.

Portion 400 may include other components, such as a UV hot mirror 422 and/or one or more filters 424, such as spectral, intensity, and/or polarization filters.

Remaining portions of the apparatus may include additional light sources, optical modulators, focusing optics, optical relay structures, examination (or measurement) sites, and/or detectors for example, as described above. In particular, the combination of a continuous arc lamp with a UV hot mirror, fluorescence interference filter, mechanical chopper, and appropriate lenses in an analyzer such as a high-throughput analyzer provides new apparatus and methods for measuring signals front long-lived reporter groups with decreased measurement times, increased signal-to-noise ratios, and improved rejection of background signals and quality control.

C. Description of Methods

The invention provides apparatus and methods for performing time-resolved luminescence assays.

In one aspect, the invention provides a system for measuring the temporal response properties of a luminescent sample. In this aspect, a light source outputs a light beam having relatively constant intensity, and the outputted light beam is modulated to create modulated incident light that may be used to excite luminescence from a luminescent sample. The modulated light ranges in intensity from a maximum that is substantially equal to the relatively constant intensity of the light beam originally outputted from the light source to a minimum that is less than one-quarter of the maximum intensity. Suitable optical modulators for producing such modulation ranges include choppers, which may be configured to produce light having a minimum intensity substantially equal to zero.

In another aspect, the invention provides a time-resolved spectroscopic assay. In this aspect, a light source having a broad spectrum output is used. and a substantially monochromatic component of the output is extracted and passed through a chopper to create periodically modulated incident light.

In each aspect, the modulated light is used to illuminate a sample, so that a luminescence output is generated, and the phase and/or modulation of the luminescence output is determined. In turn, the phase and/or modulation may be used to compute a temporal response characteristic of the sample, including or)e or more luminescence lifetimes and/or one or more rotational correlation times. Mechanisms for computing lifetimes and/or correlation times are described herein, particularly in other sections.

In some aspects, the apparatus may use high duty cycle, high frequency-content excitation (roughly a square or rectangular wave) to detect or measure luminescence lifetimes and/or rotational correlation times, instead of using pulsed or sine wave excitation. High duty cycle, high frequency content excitation may be produced by a chopper. Tile apparatus also may use a continuous arc lamp reducing integration time or increasing signal to noise ratio.

Generally. The relationship between time-domain data-and frequency-domain data is given by a Fourier transform. If the time-domain data are periodic, they may be expressed using the simpler Fourier series, which decomposes the data in terms of sines and cosines. Specifically, the Fourier series decomposition of a piecewise regular function f(t), defined on an interval T₀≦t≦T₀+T, may be expressed as follows:

$$\begin{matrix}f ( t ) = \frac{{a}_{0}}{2} + {\sum }_{n = 1}^{∞} [ {a}_{n} cos ( n ω t ) + {b}_{n} sin ( n ω t ) ] & \text{(80a)} \\ \{ \begin{matrix}{a}_{n} = \frac{ω}{π} {\int }_{{T}_{0}}^{{T}_{0} + T} f ( t ) cos ( n ω t ) ⅆ t \\ {b}_{n} = \frac{ω}{π} {\int }_{{T}_{0}}^{{T}_{0} + T} f ( t ) sin ( n ω t ) ⅆ t\end{matrix} & \text{(80b)}\end{matrix}$$

Here, c and T>0 are constants.

The excitation light produced by a mechanical chopper generally will approximate a square or rectangular wave, with relatively sharp transitions between light and dark, although other illumination patterns are possible. A square-wave having a period T=2π/ωₛ produced by a chopper having a 50% duty cycle may be written as follows:

$${f}_{E X} ( t ) = \{ \begin{matrix}H & 0 \leq t \leq π / {ω}_{s} \\ 0 & π / {ω}_{s} < t \leq 2 π / {ω}_{s}\end{matrix} \qquad ( 81 )$$

This functional is piecewise regular, and may be re-expressed using the Fourier series as a sum of sines, where each sine is associated with a different frequency.

$${f}_{EX} ( t ) = \frac{H}{2} + {\sum }_{n = 1.3 , 5 , …} \frac{2 H}{n π} sin ( n {ω}_{s} t ) \qquad ( 82 )$$

Equation 82 shows that the square wave may be decomposed using Fourier components having angular frequencies ωₛ, 3ωₛ, 5ωₛ, 7ωₛ, . . . . The amplitudes of these components are inversely proportional to frequency, so that the amplitudes decrease as the frequencies increase. Here, ωₛ is the fundamental frequency, ωₛ, 3ωₛ, 5ωₛ, and 7ωₛ, are the first, third, fifth, and seventh harmonics, and 3ωₛ, 5ωₛ, and 7ωs, are the second, fourth, and sixth overtones.

Fourier analysis also may be applied to other excitation wave forms, including rounded or smeared square waves. Generally, the mixture of harmonics may be varied by varying the duty cycle of the wave form. For example, if the duty cycle is decreased. corresponding to decreasing the on (f(t)=H) time and increasing the off (f(t)=0) time, the amplitude of the higher harmonics will increase. Consequently, for a fixed chopper frequency, varying the duty cycle can vary tile modulation frequencies.

Luminescence assays used to calculate can be a decay time or a temporal response characteristic of a sample, such as luminescence lifetimes and/or a rotational correlation times. In frequency-domain measurements, for rectangular waves, the on time may be larger, smaller, or the same as the decay time. In contrast, in time-resolved measurements, the on time should be less than the decay time, typically several times less.

Periodic excitation will produce periodic luminescence, which also can be characterized using Fourier series. As described above, a signal processing system can be used to track the phase and/or modulation, of the luminescence relative to the phase arid/or modulation of the excitation light. This analysis may be performed for each frequency present in the excitation and emission signals, although it becomes progressively more difficult as frequency increases because the associated amplitudes decrease. For this reason, signal detection and/or data analysis may focus on such lower frequency terms, particularly the fundamental.

Higher-frequency components of the output signal can be used with appropriate detection systems to extend the effective frequency of the mechanical chopper 3-fold, 5-fold. 7-fold, or more, as long as a sufficient signal-to-noise ratio exists. This extends the minimum lifetime that can be analyzed to proportionately lower values, without requiring an increase in the fundamental frequency of the chopper.

Decay times corresponding to luminescence lifetimes and/or rotational correlation times, among others, can be determined by fitting these phase arid modulation data to an appropriate model. For example, if there ,s a single luminescence lifetime. the data may be fit to Equations 1 and/or 2, as presented above. If there is more than one luminescence lifetime, or if there is molecular reorientation during a polarization experiment)t, then a more complicated model may be required,. such as a two-lifetime and/or two-rotational-correlation-time model.

More complex models may use phase and/or modulation information at two or more frequencies. Multi-frequency information can be measured using one or more mechanical choppers in various ways.

In systems containing a single chopper, multi-frequency information can be obtained by changing the frequency of the chopper or by using different harmonics of the modulated light. The frequency of the chopper can be changed during analysis of each sample, or it may be changed after analysis of a series of samples for reanalysis of the series of samples at a second frequency. Unfortunately, the frequency of some choppers, such as resonant tuning fork choppers, may be difficult to change. The different harmonics of the modulated light may be used through Fourier analysis, or by changing frequency on a lock-in amplifier or other frequency-dependent detection system. For instance, one or more filters may be connected to the output of the detector to extract selected harmonic frequencies from the detector. Typically, filters. such as a Bessel filter would be chosen to impart the least perturbation on the passed frequency components.

In systems containing multiple choppers. multi-frequency information can be obtained by switching combinations of choppers and/or light paths. Choppers may be switched by moving choppers in and out of the light path, for example, by using a solenoid. Light paths may be switched optically, or otherwise by routing light first through one chopper and then through a second chopper.

If the optical modulator has sufficient frequency and UV response, phase or phase and modulation techniques can be used to measure signal from long-lived luminophores, such as metal-ligand complexes containing ruthenium, osmium, etc. (τ=50 ns−5 μs), and lanthanide chelates containing europium, terbium, etc. (τ=50 μs−5 ms). In addition, the intensity of light from long-lived luminophores can be measured in the presence of relative large amounts (100×) of background from typically shorter-lifetime luminophores associated with the sample container, assay components, and compounds being screened. Generally, time-resolved luminescence assays can be preformed in Combination with methods for reducing or eliminating background, identifying quenching, and more rapidly collecting signals, as described herein in other sections.

D. Examples

Additional and/or alternative aspects of the invention are described without limitation in the following numbered paragraphs:

1. A system for measuring the temporal response properties of a luminescent sample, comprising (A) outputting a light beam from a light source, the light beam having a relatively constant intensity; (B) modulating the light beam to create a modulated incident light, the modulated incident light having a maximum intensity that is substantially equal to the intensity of the light beam from the light source and a minimum intensity that is less than one-quarter of the maximum intensity; (C) illuminating the sample with the modulated incident light, where the modulated incident light generates a modulated luminescence in the sample; (D) measuring at least one of an amplitude and a phase of the modulated luminescence relative to the modulated incident light; and (E) computing a temporal response characteristic of the sample based on the measured amplitude,the and/or phase.

2. Tile system of paragraph 1, where the step of measuring includes measuring both of an amplitude and a phase of the modulated luminescence relative to the modulated incident light.

3. The system of paragraph 1, where the step of computing includes calculating v temporal response characteristic of the sample based on the measured amplitude and phase.

4. The system of paragraph 1, where the temp(oral response characteristic is a luminescence lifetime or a rotational correlation time.

5. The system of paragraph 1, where the step of modulating is carried out at a fundamental frequency.

6. The system of paragraph 5, where the modulating generates a square wave.

7. The system of paragraph 6, where the modulated incident light has approximately zero minimum intensity.

8. The system of paragraph 5, where the step of measuring is carried out at the fundamental frequency and a harmonic thereof.

9. The system of paragraph 5, where the fundamental frequency is less than twenty kilohertz.

10. The system of paragraph 5, where the step of modulating is divided into a first part carried out at one fundamental frequency and a second part carried out at a second fundamental frequency.

11. The system of paragraph 1 further comprising the step of focusing the light beam into a focal plane during the step of modulating.

12. The system of paragraph 11, where the modulation is carried out with an optical modulator positioned proximal to the focal plane

13. The system of paragraph 1, where the light source is a continuous are lamp.

14. The system of paragraph 13, where the continuous arc lamp is a continuous high color temperature xenon arc lamp.

15. The system of paragraph 1, where the light source has a broad spectrum output.

16. The system of paragraph 1 further including the step of filtering the light beam to generate substantially monochromatic light.

17. A time-resolved spectroscopic assay, comprising (A) providing a light source with a broad spectrum output; (B) extracting a substantially monochromatic component from the output of the light source; (C) passing the monochromatic component through a chopper to create a periodically modulated incident light with a fundamental frequency; (D) generating luminescence in a sample by illuminating the sample with the modulated incident light; and (E) detecting at least one of the phase and modulation of the luminescence relative to the modulated incident light.

18. The assay of paragraph 17, where the step of detecting includes detecting both of the phase and modulation of the luminescence relative to the phase and modulation of the modulated incident light.

19. The assay of paragraph 17 further comprising choosing a chopper modulation frequency that is comparable to a selected time constant of the sample.

20. The assay of paragraph 19, where the selected time constant is greater than fifty microseconds.

21. The assay of paragraph 17 further comprising choosing a chopper duty cycle that produces a harmonic comparable to a selected time constant of the sample.

22. The assay of paragraph 17, where light source is a continuous arc lamp.

23. The system of paragraph 22, where the continuous arc lamp is a continuous high color temperature xenon arc lamp.

24. The assay of paragraph 17 further comprising the step of monitoring output intensity variations of the light source.

25. The assay of paragraph 24 further comprising the step of correcting the measured amplitude of the modulated luminescence to compensate for intensity variations in the light source.

26. The assay of paragraph 17, where the modulation of the incident light has the general form of a square wave.

27. The assay of paragraph 17, where the step of detecting includes detecting the phase and/or modulation of the luminescence relative to the modulated incident light at a harmonic of the fundamental frequency.

28. The assay of paragraph 17 further comprising the step of focusing the monochromatic component into a focal plane adjacent the chopper.

29. The assay of paragraph 17, where the light source has a substantially continuous output.

30. The assay of paragraph 17, where the chopper is selected from the group consisting of chopper wheels and tuning fork choppers.

31. The assay of paragraph 17 further comprising passing the monochromatic component through a second chopper to create a periodically modulated incident light with second fundamental frequency;

32. An automated apparatus for conducting time-resolved spectroscopy, comprising (A) a light source; (B) a system for directing light from the light source to a measurement region, the system including a light modulator configured to periodically modulate the intensity of light delivered to the measurement region; (C) a stage configured to hold a plate containing a plurality of sample wells adapted to hold samples, the stage further being configured to place a selected one of the samples in the sample wells into the measurement region; (D) a detector configured to receive luminescence light from a sample in the measurement region and generate a signal based on the amount of light received; and (E) a signal processing system configured to track at least one of the phase and modulation of the signal relative to the phase and modulation of the modulated light delivered to the measurement region.

33. The apparatus of paragraph 32, where the signal processing system is configured to track both of the phase and modulation of the signal relative to the phase and modulation of the modulated light delivered to the measurement region.

34. The apparats of paragraph 32, where the signal processing system includes a phase-locked loop coupled to the signal of the detector.

35. The apparatus of paragraph 34, where the light modulator has a fundamental frequency, and where the phase-locked loop is matched to the fundamental frequency.

36. The apparatus of paragraph 34, where the light modulator creates a square wave modulation of a fundamental frequency, and where the, phase-locked loop is configured Lo track a harmonic of the fundamental frequency.

37. The apparatus of paragraph 32, where the light modulator is a chopper.

38. The apparatus of paragraph 37, where the system for directing light includes a mechanism focus light from the light source into a focal plane proximal to the shopper.

39. The apparatus of paragraph 38, where the focal plane is aligned with the chopper.

40. The apparatus of paragraph 37, where the chopper is selected from the group consisting of chopper wheels and tuning fork choppers.

41. The apparatus of paragraph 37, where the light modulator includes two choppers with different modulation frequencies.

42. The apparatus of paragraph 32, where the signal processing system includes a filter configured to receive the detector signal and extract a selected frequency component.

43. The apparatus of paragraph 42, where the signal processing system includes a second filter configured to receive the detector signal and extract a second selected frequency component.

44. The apparatus of paragraph 42, where the filter is a Bessel filter.

### VII. Conclusions

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority frown this or a related application. Such claims, whether directed to a different invention or to the same invention, and whether broader, narrower, equal, or different in scope to the original claims, also are regarded as included within the subject matter of the inventions of the present disclosure.

We claim:

1. A method for determining the rotational mobility of an analyte in a composition, the method comprising:
providing a composition that includes the analyte and a reference compound, the analyte and the reference compound being luminescent, the luminescence lifetimes of the analyte and reference compound being resolvable by lifetime-resolved methods;
illuminating the composition, so that light is emitted by the analyte and reference compound;
detecting the light emitted by the analyte and reference compound;
calculating the rotational mobility of the light emitted by the analyte and the rotational mobility of the light emitted by the reference compound, based on the light that they emit and their luminescence lifetimes; and
constructing a function that expresses the rotational mobility of the analyte relative to the rotational mobility of the reference compound.

2. The method of claim 1 further comprising calculating an amount of target substance in the composition based on the rotational mobility of the analyte.

3. A composition of matter comprising first and second luminophores, where the emission spectra of the first and second luminophores overlap significantly, and where light emitted by the first luminophore is resolvable from light emitted by the second luminophore using lifetime-resolved methods.

4. The composition of claim 3, where the lifetime-resolved methods include frequency-domain methods.

5. The composition of claim 4, where the light emitted by the second luminophore is indicative of light absorbing or scattering effects.

6. The composition of claim 3, where the first luminophore is an analyte, and the second luminophore is a reference compound.

7. The composition of claim 3 further comprising reagents, where the first luminophore reacts to indicate the amount of a target substance, and the second luminophore is indicative of light absorbing or scattering effects independent of how much target substance is present.
